(19) United States
(12) Patent Application Publication
(10) Pub. No.: US 2025/0026881 A1
(43) Pub. Date: Jan. 23, 2025

(54) CROSSLINKABLE FUNCTIONALIZED OLIGOESTERS AND POLYESTERS, METHODS OF MAKING SAME, AND USES THEREOF

(71) Applicant: Cornell University, Ithaca, NY (US)

(72) Inventors: Yifan Ma, Ithaca, NY (US); Xiaochu Ding, Ithaca, NY (US); Yadong Wang, Ithaca, NY (US)

(21) Appl. No.: 18/713,464

(22) PCT Filed: Nov. 23, 2022
(86) PCT No.: PCT/US2022/050907

§ 371 Date: May 24, 2024

Related U.S. Application Data
(60) Provisional application No. 63/282,773, filed on Nov. 24, 2021.

(51) Int. Cl. C08G 63/20; C08G 63/78; C08J 3/28

(52) U.S. Cl. CPC C08G 63/20; C08G 63/78; C08J 3/28; C08J 2367/02

(57) ABSTRACT

Oligoesters and polyesters comprising one or more (e.g., a plurality) of crosslinkable and/or crosslinked clickable groups (e.g., capable of or formed by click reactions, respectively). methods of making same. and uses of same. In various examples, a method forms objects by irradiating compositions comprising crosslinkable oligoesters and polyesters and, optionally, solvent (e.g., crosslink-able solvent), crosslinking reagent, and/or crosslinking initiator, with electromagnetic radiation and/or by heating the compositions. In various examples, a method forms films, fibers, and other 3D objects. In various examples, biodegradable and/or elastomeric materials comprising crosslinked oligoesters and polyesters are useful in devices (e.g., microfluidic devices, lab on a chip, drug delivery devices, and the like), scaffolds, tissue grafts, skin patches, and the like. In various examples, methods are additive manufacturing methods, (e.g., 3D printing methods, such as, for example, digital light processing (DLP)).

### CROSS-REFERENCE TO RELATED APPLICATIONS

This application claims the benefit of U.S. Provisional Patent Application No. 63/282,773, filed Nov. 24, 2021, the contents of the above-identified application are hereby fully incorporated herein by reference in their entirety.

### BACKGROUND OF THE DISCLOSURE

Currently, light-based 3D printing for biomedical applications commonly uses methacrylic and acrylic (here grouped together and termed MAA) based resins due to their high reactivity and availability. This photo-crosslinking chemistry has enabled novel additive manufacturing such as digital light processing (DLP). Nevertheless, MAA often cannot reach complete conversion, because of partially crosslinked network's limited diffusion coefficient and radical's sensitivity to atmospheric oxygen. In vivo, unreacted MAA in crosslinked MAA-based resins can hydrolyze and yield free methacrylic and acrylic acids, which are sensitizing, irritating, toxic and potentially carcinogenic.

Previously, photo-polymerizable resins derived from alkyne generated highly crosslinked network via DLP. Compared to free radical crosslinking of MAA-based resins, thiol-yne crosslinking is more tolerant to oxygen and unconjugated alkynes are less susceptible to nucleophilic addition. In literature, alkyne-functionalized UV crosslinkable resins mostly comprise of small molecule bifunctional alkyne monomers, which are used with multifunctional thiols to generate highly crosslinked network. Because the crosslinking density correlates to degree of conversion and a high conversion is required to minimize the amount of leachable oligomers/monomers, such materials typically possess high Young's modulus, rendering them unsuitable for soft material applications.

Sebacate-derived polyesters (SPE) have many biomedical applications but are often synthesized by melt condensation, which results in low number-averaged molecular weights (Mₙ), broad molecular weights distributions (MWD), and undesired branching/crosslinking. The most successful SPE, poly(glycerol sebacate) (PGS), has Mₙ as low as 2 kD and MWD as high as 10; its complicated polymerization kinetics make it impossible to precisely control degree of polymerization by controlling reaction time. The resultant batch-to-batch inconsistency hindered PGS's developments. Although other SPE synthesized from sebacic acid and diols have more defined structures due to the lack of secondary OH as a branching point, melt condensation's harsh conditions (120-200° C., high vacuum) trigger transesterification, degradation of thermally or chemically unstable functional groups, dehydration of diols, B-scission ester bonds to form acid and alkene end groups, and evaporation of monomers/oligomers. Alternatively, enzyme-catalyzed melt condensation of sebacic acid and diols/polyols, ring-opening condensation of diglycidyl sebacate and diols, and boronic acid-catalyzed condensation of sebacoyl chloride and diols have produced SPE with improved molecular weights and better-defined structures, but their narrow substrate scope is incompatible with reactive functional groups. Because all these methods have narrow substrate scope and are unlikely to be compatible with reactive functional groups, SPE are still commonly functionalized by reacting their side chains (OH or COOH) react with acyl chlorides, anhydrides, or carbodiimides to produce esters and amides. Such post-polymerization modifications use coupling reagents, amines, or potentially toxic solvents, therefore requiring purifications like precipitation and extraction which potentially lower SPE's scalability and biocompatibility.

### SUMMARY OF THE DISCLOSURE

In an aspect, the present disclosure provides oligoesters and polyesters. In various examples, an oligoester or polyester comprises: dicarboxylic acid repeat units; and diol repeat units, polyol repeat units, or any combination thereof, where at least about 0.5 mol % to about 100 mol % of the dicarboxylic acid repeat units, the diol repeat units, if present, and/or the polyol repeat units, if present, independently comprise one or more clickable group(s), based on the total moles of the dicarboxylic acid repeat units, the diol repeat units, if present, and the polyol repeat units, if present. In various examples, the oligoester or polyester comprises the following structure:

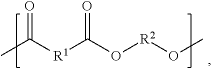

where R¹ and R² are each, independently at each occurrence, an aliphatic group, an aromatic group, a polyether group, or a polyol group, and where R¹ and R² each, independently at each occurrence, optionally comprises one or more clickable group(s). In various examples, about 0.5 mol % to about 100 mol % of the R¹ groups, the R² groups, or the R¹ groups and the R² groups, comprise the clickable group(s). In various examples, one or more or all of the clickable group(s) is/are independently covalently bound via a linking group to one of the dicarboxylic acid repeat units comprising the clickable group(s), one of the diol repeat units comprising the clickable group(s), or one of the polyol repeat units comprising the clickable group(s), and where the linking group(s) each, independently at each occurrence, comprise one or more functional group(s) chosen from alkyl group(s), amide group(s), ester group(s), ether group(s), ketone group(s), and any combination thereof. In various examples, the oligoester or polyester comprises a molecular weight (M_{w} and/or Mₙ) of about 400 g/mol to about 50,000 g/mol; and/or comprising a polydispersity index of from about 1.05 to about 7.0. In various examples, the oligoester or polyester exhibits a glass transition temperature (T_{g}) of from about −30° C. to about 60° C.

In an aspect, the present disclosure provides methods of making oligoesters and polyesters. In various examples, a method of making an oligoester or polyester (e.g., an oligoester or polyester of the present disclosure) comprises: forming a first reaction mixture comprising: one or more dicarboxylic acid(s) each comprising one or more clickable groups(s); one or more diol(s) each comprising one or more clickable group(s); one or more polyol(s) each comprising one or more clickable group(s); one or more dicarboxylic acid(s); one or more diol(s), one or more polyol(s), or any combination thereof (collectively referred to as “first mixture reagents”), where an oligoester or polyester, optionally, comprising a plurality of repeat units each comprising one or more of the clickable group(s), is formed; and/or forming a second reaction mixture comprising: one or more cyclic anhydride(s) each, optionally, comprising one or more clickable group(s); one or more cyclic ether(s) each, optionally, comprising one or more clickable group(s); and one or more oligoester(s) and/or polyester(s) each comprising one or more protic end group(s) and, optionally, a plurality of repeat units each comprising one or more clickable group(s), optionally, where the oligoester(s) and/or polyester(s) is/are the formed oligoester(s) and/or polyester(s) of one or more of the first reaction mixture(s); optionally, one or more cyclic anhydride(s); optionally, one or more cyclic ether(s), or any combination thereof; and optionally, one or more ring opening copolymerization catalyst(s) (collectively referred to as “second mixture reagents”), where an oligoester or a polyester comprising a plurality of repeat units each comprising one or more of the clickable group(s) is formed. In various examples, the first mixture components do not comprise clickable group(s) and one or more of the second mixture components each comprise clickable groups. In various examples, forming the first reaction mixture comprises: adding a first portion of the first mixture reagents, where the first portion comprises at least some of or all of the first mixture reagents comprising the clickable group(s); holding the first reaction mixture until a desired degree of conversion is achieved; and optionally. adding a second portion of the first mixture reagents, where the second portion comprises at least some of or all of the first mixture reagents not comprising the clickable group(s); or forming the first reaction mixture comprises: adding a first portion of the first mixture reagents to the first reaction mixture, where the first portion comprises at least some of or all of the first mixture reagents not comprising the clickable group(s); holding the first reaction mixture until a desired degree of conversion is achieved; and optionally, adding a second portion of the first mixture reagents to the first reaction mixture, where the second portion comprises at least some of or all of the first mixture reagents comprising the clickable group(s). In various examples, the formed oligoester or polyester of the first reaction mixture and/or the oligoester(s) or polyester(s) each comprising the protic end group(s) of the second reaction mixture each comprise(s) at least about 0.5 mol % to about 100 mol % of repeat units comprising one or more of the clickable group(s), based on the total moles of repeat units. In various examples, the first mixture reagents comprise from about 0.5 mol % to about 100 mol % of the clickable group-functionalized dicarboxylic acid(s), diol(s), and/or polyol(s), based on the total molar amounts of the first mixture reagents; and/or the second mixture reagents, excluding the oligoester(s) and/or polyester(s) each comprising the protic end group(s) and the ring-opening copolymerization catalyst(s), comprise from about 0.5 mol % to about 100 mol % of the clickable group-functionalized cyclic anhydride(s) and/or cyclic ether(s), based on the total amounts of the second mixture reagents, excluding the oligoester(s) and/or polyester(s) and the ring-opening copolymerization catalyst(s). In various examples, the second mixture reagents comprises: from about 0.1 mol % to about 5 mol % of the ring opening copolymerization catalyst(s), based on the total molar amounts of the second mixture reagents; and/or from about 40 wt. % to about 90 wt. % of the oligoester(s) or polyester(s), based on the total weight of the second mixture reagents. In various examples, the dicarboxylic acid(s) is/are chosen from aliphatic dicarboxylic acid(s), aromatic dicarboxylic acid(s), polyether dicarboxylic acid(s), and any combination thereof; the dicarboxylic acid(s) comprising one or more clickable group(s) is/are chosen from clickable group-functionalized aliphatic dicarboxylic acid(s), clickable group-functionalized aromatic dicarboxylic acid(s), clickable group-functionalized polyether dicarboxylic acid(s), and any combination thereof; the diol(s) is/are chosen from aliphatic diol(s), aromatic diol(s), polyether diol(s), and any combination thereof; the diol(s) comprising one or more clickable group(s) is/are chosen from clickable group-functionalized aliphatic diol(s), clickable group-functionalized aromatic diol(s), clickable group-functionalized polyether diol(s), and any combination thereof, the polyol(s) is/are chosen from aliphatic polyol(s), aromatic polyol(s), polyether polyol(s), and any combination thereof; the polyol(s) comprising one or more clickable group(s) is/are chosen from clickable group-functionalized aliphatic polyol(s), clickable group-functionalized aromatic polyol(s), clickable group-functionalized polyether polyol(s), and any combination thereof; the cyclic anhydride(s) is/are chosen from aliphatic cyclic anhydride(s), aromatic cyclic anhydride(s), polyether cyclic anhydride(s), and any combination thereof; the cyclic anhydride(s) comprising one or more clickable group(s) is/are chosen from clickable group-functionalized aliphatic cyclic anhydride(s), clickable group-functionalized aromatic cyclic anhydride(s), clickable group-functionalized polyether cyclic anhydride(s), and any combination thereof; the cyclic ether(s) is/are chosen from aliphatic cyclic ether(s), aromatic cyclic ether(s), polyether cyclic ether(s), and any combination thereof, the cyclic ether(s) comprising one or more clickable group(s) is/are chosen from clickable group-functionalized aliphatic cyclic ether(s), clickable group-functionalized aromatic cyclic ether(s), clickable-group polyether cyclic ether(s), and any combination thereof; the ring opening copolymerization catalyst(s) is/are chosen from Lewis acid-Lewis base catalyst pair(s), covalently-tethered Lewis acid-Lewis base catalyst(s), and any combination thereof; or any combination thereof. In various examples, the dicarboxylic acid(s) is/are chosen from succinic acid, diglycolic acid, glutaric acid, adipic acid, tartaric acid, sebacic acid, pimelic acid, suberic acid, azelaic acid, malic acid, ketoglutaric acid, phthalic acid, terephthalic acid, analog(s) and derivative(s) thereof, and any combination thereof, the dicarboxylic acid(s) comprising one or more clickable group(s) is/are chosen from clickable-group functionalized analog(s) and derivative(s) of succinic acid, diglycolic acid, glutaric acid, pimelic acid, suberic acid, azelaic acid, adipic acid, tartaric acid, pimelic acid, suberic acid, azelaic acid, sebacic acid, malic acid, ketoglutaric acid, phthalic acid, terephthalic acid, and any combination thereof, norbornene-endo-2,3-dicarboxylic acid, cis-4-cyclohexene-1,2-dicarboxylic acid, itaconic acid, maleic acid, fumaric acid, clickable group-functionalized analog(s) and derivative(s) thereof, and any combination thereof; the diol(s) is/are chosen from propanediol, propylene glycol, 1,4-butanediol, 1,6-hexanediol, 1,8-octanediol, 1,10-decanediol, catechol, hydroquinone, analog(s) and derivative(s) thereof, and any combination thereof; the diol(s) comprising one or more clickable group(s) is/are chosen from clickable-group functionalized analog(s) and derivative(s) of propanediol, propylene glycol, 1,4-butanediol, 1,6-hexanediol, 1,8-octanediol, 1,10-decanediol, catechol, hydroquinone, analog(s) and derivative(s) thereof, and any combination thereof; the polyol(s) is/are chosen from glycerol, serinol, polyether diol, pentaerythritol, oligovinyl alcohol, polyvinyl alcohol, xylitol, analog(s) and derivative(s) thereof, and any combination thereof; the polyol(s) comprising one or more clickable group(s) is/are chosen from clickable-group functionalized analog(s) and derivative(s) of glycerol, serinol, polyether diol, analog(s) and derivative(s) thereof, and any combination thereof; the cyclic anhydride(s) is/are chosen from succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, analog(s) and derivative(s) thereof, and any combination thereof; the cyclic anhydride(s) comprising one or more clickable group(s) is/are chosen from clickable-group functionalized analog(s) and derivative(s) of succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, and any combination thereof, cis-5-norbornene-endo-2,3-dicarboxylic anhydride, cis-4-cyclohexene-1,2-dicarboxylic anhydride, maleic anhydride, itaconic anhydride, fumaric anhydride, clickable group-functionalized analog(s) and derivative(s) thereof, and any combination thereof; the cyclic ether(s) is/are chosen from propylene oxide, butylene oxide, epichlorohydrin, glycidyl ether, analog(s) and derivative(s) thereof, and any combination thereof; the cyclic ether(s) comprising one or more clickable group(s) is/are chosen from clickable group-functionalized analog(s) and derivative(s) of propylene oxide, butylene oxide, epichlorohydrin, glycidyl ether, and any combination thereof, allyl glycidyl ether, clickable group-functionalized analog(s) and derivative(s) thereof, and any combination thereof; the ring opening copolymerization catalyst(s) is/are boron-based Lewis acid-Lewis base catalyst pair(s); or any combination thereof.

In an aspect, the present disclosure provides compositions. In various examples, a composition comprises one or more oligoester(s) and/or one or more polyester(s) of the present disclosure and one or more crosslinker(s), multifunctional crosslinker(s), or any combination thereof. In various examples, the oligoester(s) and/or the polyester(s) is/are present in the composition at from about 40 wt. % to about 80 wt. %, based on the total weight of the oligoester(s), if present, the polyester(s), if present, the crosslinker(s) (e.g., diothiol(s) or the like), if present, and the multifunctional crosslinker(s) (e.g., multifunctional thiols(s) or the like), if present. In various examples, the crosslinker(s) (e.g., diothiol(s) or the like) and/or the multifunctional crosslinker(s) (e.g., multifunctional thiols(s) or the like) each independently comprise one or more C₃ to C₇ alkyl group(s). In various examples, in the composition further comprises one or more radical initiator(s). In various examples, the radical initiator(s) is/are present in the composition at from about 0.1 wt. % to about 2 wt. %, based on the total weight of the oligoester(s), if present, the polyester(s), if present, the crosslinker(s) (e.g., diothiol(s) or the like), if present, and the multifunctional crosslinker(s) (e.g., multifunctional thiols(s) or the like), if present. In various examples, the composition further comprises one or more solvent(s) and/or one or more additive(s).

In an aspect, the present disclosure provides materials. In various examples, a material comprises one or more composition(s) of the present disclosure, where the composition(s) is/are crosslinked, where the crosslinked composition(s) comprise(s) one or more crosslinked oligoester(s) and/or polyester(s), and where the crosslinked oligoester(s) and/or polyester(s) comprise(s) a plurality of crosslinking groups (e.g., crosslinking thioether groups or the like). In various examples, the crosslinking groups (e.g., crosslinking thioether groups or the like) of the crosslinked composition(s) replace (or are formed from) about 10% to about 100% of the clickable groups of corresponding non-crosslinked composition(s). In various examples, the material exhibits a Young's modulus of about 0.01 MPa to about 200 MPa. In various examples, the material is biocompatible and/or biodegradable.

In an aspect, the present disclosure provides articles of manufacture. In various examples, an article of manufacture comprises one or more material(s) of the present disclosure, where the material(s) is/are elastomer(s) (which may have desirable Young's modulus (e.g., a soft elastomer). In various examples, the article of manufacture is chosen from a device, a scaffold, a tissue graft, and a skin patch. In various examples, the device is chosen from a microfluidic device, a lab on a chip, and a drug delivery device.

In an aspect, the present disclosure provides methods of forming an object. In various examples, a method of forming an object comprises heating and/or irradiating with electromagnetic radiation one or more composition(s) of the present disclosure, where a plurality of crosslinking groups (e.g., thioether groups or the like) are formed, and where each crosslinking group (e.g., thioether group or the like) is formed by a reaction of two of the clickable groups with a crosslinker (e.g., a dithiol or the like) or a multifunctional crosslinker (e.g., a multifunctional thiol or the like). In various examples, the composition(s) comprise one or more solvent(s) each capable of crosslinking during the heating and/or the irradiating with electromagnetic radiation of the composition(s). In various examples, from about 10% to about 100% of the clickable groups are reacted to form the plurality of crosslinking groups (e.g., thioether groups or the like). In various examples, the method further comprises forming a film or fiber from the composition(s). In various examples, the film or the fiber is formed prior to and/or during the irradiating with electromagnetic radiation of the composition(s). In various examples, the method is an additive manufacturing method. In various examples, the additive manufacturing method is a 3-D printing method, UV-assisted electrospinning, UV-assisted electrowriting, or any combination thereof. In various examples, the 3-D printing method is digital light processing (DLP).

### BRIEF DESCRIPTION OF THE FIGURES

For a fuller understanding of the nature and objects of the disclosure, reference should be made to the following detailed description taken in conjunction with the accompanying figures herein.

FIGS. 1A-1B show a synthesis and a characterization of a poly (alkyne-serinol)-ran-propanediol-co-sebacate (PAPS). (FIG. 1A) Synthesis of a N-(5-hexynoamido)-1,3-propanediol and a PAPS. (FIG. 1B) proton nuclear magnetic resonance (¹H-NMR) spectra in deuterated acetone (acetone-d6) and gel permeation chromatography (GPC) characterization of a PAPS; residual solvent signal is at 2.05 parts per million (ppm). *Extending the vacuum polycondensation step to 48 hours increased the molecular weight and polydispersity index (PDI).

FIGS. 2A-2D show mechanical properties of a cured PAPS. (FIG. 2A) Photorheology of a 20 mol % PAPS (number average molecular weight (Mn)=6458 Da, PDI=2.75) resin with or without thiol crosslinkers. (FIG. 2B) Tensile testing of a cured 20 mol % PAPS. 0.5×, 1× and 2× signifies a molar excess of thiols over alkynes. (FIGS. 2C-2D) Cyclic testing of 20 mol % PAPS cured with a 2X thiol.

FIGS. 3A-3B show a diffusion NMR study of a crosslinking reaction. (FIG. 3A) Exponential decay of NMR signal intensity. Note the signal of small molecules (acetone) decayed to baseline level after the first iteration. (FIG. 3B) The signal decay was fitted with biexponent functions and linearized by taking the natural log; diffusion coefficient equals to the absolute value of the slope.

FIG. 4 shows degradation behavior of a PAPS crosslinked with different crosslinker concentrations. Two-way analysis of variance (ANOVA) showed statistically significant effects of crosslinker concentration (p<0.05) and degradation time (p<0.001) on the degradation kinetics.

FIGS. 5A-5B show a mechanism of a thiol-yne photocrosslinking of a PAPS. (FIG. 5A) Alkynes react with either one or two equivalents (equiv) of thiols to form vinyl sulfides or alkyl disulfides. (FIG. 5B) NMR study of alkyne-serinol monomers reacting with different amounts of 2,2-(ethylenedioxy) diethanethiol. Signal intensity decreased overall as polymeric species formed but alkyl disulfides appeared as a broad doublet at 4.01 ppm.

FIGS. 6A-6B show a biocompatibility study of a crosslinked PAPS using human umbilical artery endothelial cells (HUAECs). (FIG. 6A) MTT (3-(4,5-dimethylthiazol-2-yl)-2,5-diphenyltetrazolium bromide) assay of HUAECs treated with a PAPS extract (treated group) or fresh endothelial cell media (untreated group), n=4. (FIG. 6B) Cell morphology at Day 3.

FIGS. 7A-7B show a (FIG. 7A) ^{H}-NMR spectrum and a (FIG. 7B) carbon-13 NMR (13C-NMR) spectrum of an alkyne-serinol monomer.

FIG. 8 shows a thermogravimetric analysis (TGA) of an alkyne-serinol monomer (Universal V3.9A TA Instruments).

FIG. 9 shows a ¹H-¹H correlation spectroscopy (COSY) spectrum of a 20 mol % PAPS in acetone-d6. Proton a can be confidently assigned to the peak at 1.6 ppm based on the coupling pattern. Low intensity peak of propanediol end group OH can also be assigned in this manner.

FIG. 10 shows a differential scanning calorimetry (DSC) spectrum of a 20 mole (mol) % PAPS crosslinked with 2 mol equivalents of thiol crosslinkers. The endothermic peak around glass transition temperature (T_{g}) is due to enthalpic recovery (Exo Up; Universal V4.5 TA Instruments).

FIG. 11 shows a DSC of a 20 mol % PAPS crosslinked with 1 mol equivalents of thiol crosslinkers. The endothermic peak around T_{g} is due to enthalpic recovery (Exo Up; Universal V4.5 TA Instruments).

FIG. 12 shows a DSC of a 20 mol % PAPS crosslinked with 0.5 mol equivalents of thiol crosslinkers. The endothermic peak around T_{g} is due to enthalpic recovery (Exo Up; Universal V4.5 TA Instruments)

FIG. 13 shows an infrared (IR) spectrum of alkyne serinol monomers, a 20 mol % PAPS, and a crosslinked PAPS. Crosslinking did not give any observable change in the IR spectrum.

FIG. 14 shows a schematic of a synthesis of poly(propanediol sebacate) (PPS) macroinitiator and ABA triblock polyester, poly(NB-alt-PO)-PPS-poly(NB-alt-PO), where NB is cis-5-norbornene-endo-2,3-dicarboxylic anhydride and PO is propylene oxide (abbreviated as NBPO_{PPSx}, where x is the PPS wt. % relative to ring-opened NB and PO).

FIGS. 15A-15D show a change of molecular weights and molecular weight distributions during a ring-opening copolymerization (ROCOP) of NBPO_{PPS18}. Progression of (FIG. 15A) conversion and (FIG. 15B) PDI (Ð) (triangles) and Mₙ (circles) during the reaction. (FIGS. 15C-15D) GPC traces of aliquots throughout the synthesis showing (FIG. 15C) narrowing of molecular weight distributions and increasing of molecular weights with time and (FIG. 15D) narrowing of molecular weight distributions and decreasing of molecular weights with increasing PPS concentrations (NBPO_{PPS18}, NBPO_{PPS31}, NBPO_{PPS37}, NBPO_{PPS50}), and NBPO_{PPS61}).

FIGS. 16A-16C show an NMR and a GPC analysis of a NBPO_{PPSx}. (FIG. 16A) ¹H-NMR of a NBPO_{PPSx} synthesized on a 30-gram scale.; (FIG. 16B) Diffusion NMR showing all proton signals had the same diffusion coefficient; (FIG. 16C) Stereochemistry analysis of a NBPO_{PPSx}.

FIGS. 17A-17B show a matrix-assisted laser desorption/ionization-time of flight/mass spectrometry (MALDI-TOF-MS) spectrum of a NBPO_{PPS50}. (FIG. 17A) A full scale spectrum (linear mode) showing different degrees of polymerizations in clusters; (FIG. 17B) A closeup view of a single cluster showing 20 mass-to-charge ratio (m/z) increments, shown are the two most likely structures identified for m/z=2417.312 and only K+ adducts of ABA triblock copolyester were observed.

FIGS. 18A-18F show mechanical testing of a cured NBPO_{PPSx}. (FIG. 18A) Photocuring kinetics of polymers cured by pentaerythritol tetrakis (3-mercaptopropionate) (PETMP) with diphenyl (2,4,6-trimethylbenzoyl) phosphine oxide (TPO) as the initiator; shaded box represents onset of ultraviolet (UV) exposure (385 nm, 3 W). (FIG. 18B) Cyclic tensile testing of cured NBPO_{PPS18} showing traces of cycle 1, cycle 25, and cycle 50. (FIGS. 18C-18E) Tensile testing of various polymer samples (n=3). (FIG. 18F) Comparison of Young's modulus derived from tensile testing. *p<0.05***p<0.001.

FIGS. 19A-19G show a three-dimensional (3D) Printing of a NBPO_{PPS31}. (FIG. 19A) Components of digital light processing (DLP) resins. Not shown: 0.75 wt. % of butylated hydroxytoluene (BHT) and 0.75 wt. % of TPO. (FIG. 19B) Printed dogbone sample undergoing mechanical distortion. (FIG. 19C) A printed tree showing bifurcations and fine resolution at the base (concentric ring structures). (FIG. 19D) Printed jigsaw puzzle pieces attached to printing stage. (FIG. 19E) Comparison between PDMS, NBPO_{PPS31} thiol-ene resin, and commercial resin (Whip Mix VeriGuide OS). (FIG. 19F) Mechanical testing of printed dogbone samples (sample number (n)=3) (FIG. 19G) In vitro cytocompatibility testing of NBPO_{PPS31} cured with PETMP (n=4) with human umbilical vein endothelial cells (HUVECs).

FIG. 20 shows a¹H spectra of NBPO_{PPS18}.

FIG. 21 shows a¹H spectra of NBPO_{PPS30}.

FIG. 22 shows a¹H spectra of NBPO_{PPS37}.

FIG. 23 shows a¹H spectra of NBPO_{PPS50}.

FIG. 24 shows a¹H spectra of NBPO_{PPS61}.

FIG. 25 shows a purification of a polymer sample by one round of precipitation in 1:1 ethanol/water mixture. The crude trace represents a crude polymerization mixture and the purified trace represents a purified polymer sample of NBPO_{PPS31}; peaks at 7.4 ppm and 7.6 ppm arise from phenyl groups of bis(triphenylphosphine) iminium chloride ([PPN]Cl).

FIGS. 26A-26B show a MALDI-TOF-MS spectrum of a PPS macromolecular chain transfer agent (macroCTA). (FIG. 26A) A full-scale spectrum showing various degrees of polymerization. (FIG. 26B) A zoomed-in portion showing PPS with different end groups.

FIGS. 27A-27B show a MALDI-TOF-MS spectrum of NBPO_{PPS61}. (FIG. 27A) A full-scale spectrum showing various degrees of polymerization; each cluster is separated by 222 m/z. (FIG. 27B) A zoomed-in portion showing 20 m/z increments between two adjacent peaks.

FIG. 28 shows a calculation of end group correction for MALDI-TOF-MS analysis. Molar massed are derived from summing up highlighted atoms.

FIG. 29 shows DSC traces of PPS macroCTA.

FIG. 30 shows DSC Traces of NBPO_{PPS18}.

FIG. 31 shows DSC Traces of NBPO_{PPS30}.

FIG. 32 shows DSC Traces of NBPO_{PPS37}.

FIG. 33 shows DSC Traces of NBPO_{PPS50}.

FIG. 34 shows DSC Traces of NBPO_{PPS61}.

FIG. 35 shows TGA of PPS macroCTA.

FIG. 36 shows TGA of PPS NBPO_{PPS50}.

FIG. 37 shows TGA of PPS NBPO_{PPS61}.

### DETAILED DESCRIPTION OF THE DISCLOSURE

The present disclosure provides crosslinkable and/or crosslinked oligoesters and polyesters. The present disclosure also provides methods of making crosslinkable and/or crosslinked oligoesters and polyesters and uses of crosslinkable and/or crosslinked oligoesters and polyesters.

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise stated, “about,” “approximately,” “substantially,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of ±10% or less, ±5% or less, ±1% or less, and ±0.1% or less of and from the specified value), insofar such variations are appropriate to perform in the context of the disclosure. As used herein, the terms “about,” “approximate,” “at or about,” and “substantially” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further disclosure. For example, if the value “about 10” is disclosed, then “10” is also disclosed.

As used herein, unless otherwise stated, the term “group” refers to a chemical entity that is monovalent (i.e., comprises one terminus that can be covalently bonded to other chemical species), divalent, or polyvalent (i.e., comprises two or more termini that can be covalently bonded to other chemical species). The term “group” also includes radicals (e.g., monovalent and multivalent, such as, for example, divalent radicals, trivalent radicals, and the like). Illustrative, non-limiting examples of groups include:

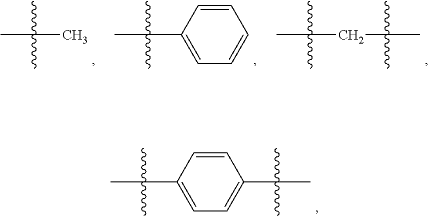

and the like.

As used herein, unless otherwise indicated, the term “aliphatic group” refers to branched or unbranched hydrocarbon groups that, optionally, contain one or more degree(s) of unsaturation. Degrees of unsaturation include, but are not limited to, carbon-carbon double bonds and carbon-carbon triple bonds. Non-limiting examples, of aliphatic groups with one or more degree(s) of unsaturation include alkenyl groups, alkynyl groups, and aliphatic cyclic groups, and the like. In various examples, an aliphatic group is an alkyl group. In various examples, an aliphatic group is a C₁ to C₂₀ aliphatic group, including all integer numbers of carbons and ranges of numbers of carbons therebetween (e.g., a C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ aliphatic group). In various examples, an aliphatic group is unsubstituted or substituted with one or more substituent(s). Examples of substituents include, but are not limited to, various substituents, such as, for example, halide groups (—F,—Cl,—Br, and —I), aliphatic groups (e.g., alkyl groups, alkenyl groups, alkynyl groups, cycloaliphatic groups, and the like), halogenated aliphatic groups (e.g., trifluoromethyl group and the like), aryl groups, halogenated aryl groups, hydroxyl groups (e.g., aliphatic alcohol groups, aliphatic diol groups, aliphatic polyol groups, and the like), amine groups, nitro groups, cyano groups, isocyano groups, silyl groups, alkoxide groups, ether groups, ketone groups, carboxylate groups, carboxylic acid groups, ester groups, amide groups, ether groups, thioether groups, and the like, and any combination thereof. In various examples, an aliphatic group comprises one or more heteroatom(s), such as, for example, oxygen, nitrogen, sulfur, and the like, and any combination thereof.

As used herein, unless otherwise indicated, the term “alkyl group” refers to branched or unbranched hydrocarbon groups that include only single bonds between carbon atoms. In various examples, an alkyl group is a C₁ to C₂₀ alkyl group, including all integer numbers of carbons and ranges of numbers of carbons therebetween (e.g., a C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉ or C₂₀ alkyl group). In various examples, an alkyl group is a saturated group. In various examples, an alkyl group is a cyclic alkyl group, a polycyclic alkyl group., or the like. In various examples, an alkyl group is unsubstituted or substituted with one or more substituent(s). Examples of substituents include, but are not limited to, various substituents, such as, for example, halide groups (—F, —Cl, —Br, and —I), aliphatic groups (e.g., alkyl groups, alkenyl groups, alkynyl groups, cycloaliphatic groups, and the like), halogenated aliphatic groups (e.g., trifluoromethyl group and the like), aryl groups, halogenated aryl groups, hydroxyl groups (e.g., alkyl alcohol groups, alkyl diol groups, alkyl polyol groups, and the like), amine groups, nitro groups, cyano groups, isocyano groups, silyl groups, alkoxide groups, ether groups, ketone groups, carboxylate groups, carboxylic acid groups (e.g., alkyl dicarboxylic acid groups and the like), ester groups, amide groups, ether groups, thioether groups, and the like, and any combination thereof. In various examples, alkyl groups contain one or more heteroatom(s), such as, for example, oxygen(s), nitrogen(s), sulfur(s), and the like, and any combination thereof. Examples of alkyl groups include, but are not limited to, methyl groups, ethyl groups, propyl groups, butyl groups, isopropyl groups, tert-butyl groups, octyl groups, analog(s) and derivative(s) thereof, and the like.

As used herein, unless otherwise indicated, the term “alkenyl group” refers to branched or unbranched hydrocarbon groups comprising one or more carbon-carbon (C—C) double bond(s). In various examples, an alkenyl group is a terminal alkenyl group (the C—C double bond is at an end of the hydrocarbon group) or an internal alkenyl group (the C—C double bond is not at an end of the hydrocarbon group). In various examples, an alkenyl group is a C₂ to C₂₀ alkyenyl group, including all integer numbers of carbons and ranges of numbers of carbons therebetween (e.g., a C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀ alkenyl group). In various examples, an alkenyl group ise a cyclic alkenyl group, a polycyclic aliphatic group (e.g., an aliphatic group comprising a strained ring and/or bridging group), or the like (e.g., an exocyclic alkenyl group or a nendocyclic alkenyl group). An alkenyl group can be conjugated or non-conjugated. In various examples, an alkenyl group is unsubstituted or substituted with one or more substituent(s). Examples of substituents include, but are not limited to, halide groups (—F, —Cl, —Br, and —I), aliphatic groups (e.g., alkyl groups, alkenyl groups, alkynyl groups, cycloaliphatic groups, and the like), halogenated aliphatic groups (e.g., trifluoromethyl group and the like), aryl groups, halogenated aryl groups, hydroxyl groups, (e.g., aliphatic alcohol groups, aliphatic diol groups, aliphatic polyol groups, and the like), amine groups, nitro groups, cyano groups, isocyano groups, silyl groups, alkoxide groups, ether groups, ketone groups, carboxylate groups, carboxylic acid groups, ester groups, amide groups, ether groups, thioether groups, and the like, and any combination thereof. In various examples, aryl groups contain one or more heteroatom(s), such as, for example, oxygen, nitrogen, sulfur, and the like, and any combination thereof. Examples of alkenyl groups include, but are not limited to, an ethenyl (vinyl) group, 1-propenyl groups, 2-propenyl (allyl) groups, 1-, 2-, and 3-butenyl groups, isopropenyl groups, norbornenyl groups, cyclohexenyl groups, analog(s) and derivative(s) thereof, and the like.

As used herein, unless otherwise indicated, the term “alkynyl group” refers to

branched or unbranched hydrocarbon groups comprising one or more C—C triple bond(s). In various examples, an alkynyl group is a terminal alkynyl group (the C—C triple bond is at an end of the hydrocarbon group) or an internal alkynyl group (the C—C triple bond is not at an end of the hydrocarbon group). In various examples, an alkynyl group is a C₂ to C₂₀ alkynyl group, including all integer numbers of carbons and ranges of numbers of carbons therebetween (e.g., a C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀ alkynyl group). An alkynyl group may be unsubstituted or substituted with one or more substituent(s). Examples of substituents include, but are not limited to, halide groups (—F, —Cl, —Br, and —I), aliphatic groups (e.g., alkyl groups, alkenyl groups, alkynyl groups, cycloaliphatic groups, and the like), halogenated aliphatic groups (e.g., trifluoromethyl group and the like), aryl groups, halogenated aryl groups, hydroxyl groups, (e.g., aliphatic alcohol groups, aliphatic diol groups, aliphatic polyol groups, and the like), amine groups, nitro groups, cyano groups, isocyano groups, silyl groups, alkoxide groups, ether groups, ketone groups, carboxylate groups, carboxylic acid groups, ester groups, amide groups, ether groups, thioether groups, and the like, and any combination thereof. In various examples, alkenyl groups contain one or more heteroatom(s), such as, for example, oxygen, nitrogen, sulfur, and the like, and any combination thereof. Examples of alkynyl groups include, but are not limited to an ethyne group, 1- and 2-propyne groups, 1-, 2-, and 3-butyne groups, analog(s) and derivative(s) thereof, and the like.

As used herein, unless otherwise indicated, the term “aryl group” refers to an aromatic or partially aromatic carbocyclic group. In various examples, an aryl group is a C₅ to C₃₀ aryl group, including all integer numbers of carbons and ranges of numbers of carbons therebetween (e.g., a C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, or C₃₀ group). In various examples, an aryl group is also referred to as an aromatic group. In various examples, aryl groups comprise polyaryl groups such as, for example, fused ring groups, biaryl groups, or a combination thereof. In various examples, the aryl group is unsubstituted or substituted with one or more substituent(s). Examples of substituents include, but are not limited to, various substituents such as, for example, halide groups (—F, —Cl, —Br, and —I), aliphatic groups (e.g., alkyl groups, alkenyl groups, alkynyl groups, cycloaliphatic groups, and the like), halogenated aliphatic groups (e.g., trifluoromethyl group and the like), aryl groups, halogenated aryl groups, hydroxyl groups, (e.g., aliphatic alcohol groups, aliphatic diol groups, aliphatic polyol groups, and the like), amine groups, nitro groups, cyano groups, isocyano groups, silyl groups, alkoxide groups, ether groups, ketone groups, carboxylate groups, carboxylic acid groups, ester groups, amide groups, ether groups, thioether groups, and the like, and any combination thereof. In various examples, aryl groups contain one or more heteroatom(s), such as, for example, oxygen, nitrogen (e.g., pyridinyl groups and the like), sulfur, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, analog(s) and derivative(s) thereof, and the like.

As used herein, unless otherwise indicated, the term “analog” refers to a compound or group that can be envisioned to arise from another compound or group, respectively, if one atom or group of atoms, functional groups, or substructures is replaced with another atom or group of atoms, functional groups, or substructures.

As used herein, unless otherwise indicated, the term “derivative” refers to a compound or group that is envisioned to or is derived from a similar compound or group, respectively, by a chemical reaction, where the compound or group is modified or partially substituted such that at least one structural feature of the original compound or group is retained.

In an aspect, the present disclosure provides crosslinkable and/or crosslinked oligoesters and polyesters. In various examples, crosslinkable and/or crosslinked oligoesters and polyesters are made by methods of the present disclosure. Non-limiting examples of crosslinkable and/or crosslinked oligoesters and polyesters are disclosed herein.

As used herein, unless otherwise indicated, a clickable group is a functional group that can react in a click reaction (such as, for example, a thiol-ene reaction, a thiol-yne reaction (which may also be referred to, in the alternative, as an alkene hydrothiolation reaction), or the like) (e.g., a radical-initiated click-reaction, such as, for example, a photo-initiated reaction, a thermal-initiated click-reaction, or the like, or any combination thereof). In various examples, a clickable group is a first click reagent of a click reagent pair. In various examples, a clickable group-functionalized oligoester or polyester can be crosslinked via a plurality of click reactions (e.g., radical-initiated click-reaction, such as, for example, photo-initiated click reaction, thermal-initiated click-reaction, or the like, or any combination thereof) of the clickable groups.

A crosslinkable oligoester or polyester can comprise a plurality of various crosslinkable functional groups (which may be the same or different (e.g., structurally different or the like)). In various examples, a crosslinkable oligoester or polyester is a clickable group-functionalized oligoester or polyester (e.g., an oligoester or polyester comprising a plurality of clickable groups, which may be the same or different (e.g., structurally different or the like)).

In various examples, a crosslinked oligoester or polyester (e.g., a crosslinked clickable group-functionalized oligoester or polyester) is at least partially or fully crosslinked (e.g., interchain crosslinked and/or intrachain crosslinked) (e.g., via radical-initiated crosslinking, such as, for example, photo-initiated crosslinking, thermal-initiated crosslinking, or the like, or any combination thereof) via at least a portion of (e.g., a plurality of) or all of the crosslinkable groups (e.g., clickable groups). In various examples, a crosslinked oligoester or polyester (e.g., a crosslinked clickable group-functionalized oligoester or polyester) is at least partially or fully crosslinked via a plurality of crosslinks. In various examples, each crosslink is between two crosslinkable functional groups (e.g., two clickable groups) (which may be the same or different (e.g., structurally different or the like)) and/or is between two or more crosslinkable groups (e.g., two or more clickable groups) (which may be the same or different, (e.g., structurally different or the like)) and a polyfunctional reagent (e.g., a polyfunctional crosslinking reagent comprising two or more crosslinking groups) (e.g., a polyfunctional click reagent, e.g., a difunctional click reagent comprising two functional groups and/or a multifunctional click reagent comprising three or more functional groups (e.g., a trifunctional click reagent, a tetrafunctional click reagent, or the like)).

In various examples, a click reaction of a clickable group-functionalized oligoester or polyester occurs between a first clickable group comprising a first click reagent of a click reagent pair (e.g., a first clickable group) and a second click reagent of the pair. In various examples, the second click reagent is a second clickable group. In various examples, the second click reagent is a functional group of a polyfunctional click reagent (e.g., a difunctional click reagent or a multifunctional click reagent).

A clickable group-functionalized oligoester or polyester can be crosslinked by various click reagent pairs. In various examples, a clickable group-functionalized oligoester or polyester can be crosslinked by one or more click reaction(s) (which may be the same or different) between one or more clickable group(s) (e.g., first clickable reagent(s)) (which may be the same or different (e.g., structurally different or the like)) and one or more second clickable reagent(s) (which may be the same or different (e.g., structurally different or the like) of one or more click reagent pair(s) (which may be the same or different (e.g., structurally different or the like). In various examples, the clickable group(s) (e.g., the first clickable reagent(s)) is/are on the same oligoester or polyester chain and/or on two different oligoester and/or polyester chains.

In various examples, click reaction(s) is/are thiol-ene reaction(s), thiol-yne reaction(s), or the like, or any combination thereof. In various examples, one or more clickable group(s) each comprising an -ene group, an -yne group, or the like (e.g., first click reagent(s)) react with one or more thiol functional second click reagent(s) of thiol-ene reaction pair(s), thiol-yne reaction pair(s), or the like, or any combination thereof. In various examples, the thiol functional second click reagent(s) is/are thiol functional second clickable group(s). In various examples, the thiol functional second click reagent(s) is/are polythiol click reagent(s). In various examples, polythiol click reagent(s) is/are chosen from dithiol(s) (e.g., alkyl dithiol(s), and the like) each comprising two thiol groups or multifunctional thiol(s) each comprising three or more thiol groups, or the like, or any combination thereof. In various examples, each thiolene click reaction, thiol-yne reaction, or the like, produces a thioether crosslinking group. Non-limiting examples of clickable groups (e.g., first click reagents) each comprising an -ene group, an -yne group, or the like, which is capable of reacting with a polythiol click reagent (e.g., a second click reagent) or the like, include alkenyl groups (which may or may not be terminal alkenyl groups, or the like), alkynyl groups (which may be terminal alkenyl groups, and the like (e.g., 1, 2, or 3 clickable group(s)) (which may be independently covalently bound to a dicarboxylic acid repeat unit, a diol repeat unit (if present), or a polyol repeat unit (if present), via (or directly through) a linking group), and the like, and any combination thereof. In various examples, the crosslinking thioether groups are each formed via a photoinitiated reaction of two clickable groups with a polythiol click reagent.

In various examples, an alkenyl group comprises a cyclic or polycyclic hydrocarbon group that comprises one or more alkenyl group(s) (e.g., exocyclic alkenyl group(s), endocyclic alkenyl group(s), and the like, and any combination thereof). In various examples, a clickable group comprises a cyclic or polycyclic hydrocarbon group, which may comprise a strained ring and/or bridging group, that comprises at least one alkenyl group. In various examples, a clickable group comprises a norbornenyl group or the like. In various examples, one or more or all of the alkenyl groups (which, independently, may be terminal alkenyl groups, or the like) and/or one or more or all of the alkynyl groups (which, independently, may be terminal alkynyl groups, or the like) are unconjugated alkenyl group(s) (e.g., unconjugated terminal alkenyl group(s)) or unconjugated alkynyl group(s) (e.g., unconjugated terminal alkynyl group(s)), respectively. In various examples, all of the clickable groups are the same. In various examples, two or more of the clickable groups are different (e.g., structurally different or the like).

A clickable group-functionalized oligoester or polyester can comprise various repeat units. In various examples, a clickable group-functionalized oligoester or polyester comprises a plurality of ester repeat units, each ester repeat unit comprising a dicarboxylic acid repeat unit and either a diol repeat unit or a polyol repeat unit. In various examples, a clickable group-functionalized oligoester or polyester comprises a plurality of dicarboxylic acid repeat units and a plurality of diol repeat units, polyol repeat units, or any combination thereof.

In various examples, a dicarboxylic acid repeat unit (which may be referred to in the alternative as a dicarboxylic acid group) is formed (e.g., by a method of the present disclosure) from a dicarboxylic acid, a dicarboxylic acid comprising one or more clickable group(s), a dianhydride, or a dianhydride comprising one or more clickable group(s) (e.g., of the present disclosure). In various examples, a diol repeat unit (which may be referred to in the alternative as a diol group) is formed (e.g., by a method of the present disclosure) from a diol, a diol comprising one or more clickable group(s), a cyclic ether, or a cyclic ether comprising one or more clickable group(s) (e.g., of the present disclosure). In various examples, a polyol repeat unit (which may be referred to in the alternative as a polyol group) is formed (e.g., by a method of the present disclosure) from a polyol or a polyol comprising one or more clickable group(s) (e.g., of the present disclosure).

In various examples, at least a portion of or all of the repeat units of the clickable group-functionalized oligoester or polyester independently comprise one or more clickable group(s) (e.g., of the present disclosure). In various examples, at least about 0.5 mol % to about 100 mol % of the repeat units of the clickable group-functionalized oligoester or polyester (e.g., the ester repeat units or the dicarboxylic acid repeat units, the diol repeat units, if present, and/or the polyol repeat units, if present), including all 0.01 mol % values and ranges therebetween (e.g., at least about 2 mol % to about 20 mol %), independently comprise one or more clickable group(s) (e.g., alkenyl group(s), alkynyl group(s), such as, for example, terminal or non-terminal alkynyl groups, and the like) (e.g., 1, 2, or 3 clickable group(s)), based on the total moles of the repeat units (e.g., the ester repeat units or the dicarboxylic acid repeat units, the diol repeat units, if present, and the polyol repeat units, if present).

In various examples, the clickable group-functionalized oligoester or polyester comprises (or has) (e.g., a plurality of) the following repeat unit (e.g., an ester repeat unit) structure:

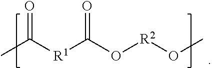

In various examples, R¹ is independently at each occurrence an aliphatic group (e.g., a C₁ to C₂₀, including all integer carbon number and ranges therebetween (e.g., C₃ to C₂₀, or C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), aliphatic group (e.g., an alkyl group, an alkenyl group, or an alkynyl group)), an aromatic group (e.g., a C6 aromatic group (e.g., a phenyl group, such as, for example, a 1,4-phenyl group, a 1,6-phenyl group, analog(s) and derivative(s) thereof, and the like, analog(s) and derivative(s) thereof, and the like)), a polyether group, an aliphatic group (e.g., a C₁ to C₂₀, including all integer carbon number and ranges therebetween (e.g., C₃ to C₂₀, or C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), aliphatic group) (e.g., an alkyl group, an alkenyl group, or an alkynyl group)) comprising one or more clickable group(s), an aromatic group (e.g., a C₆ aromatic group (e.g., a phenyl group, such as, for example, a 1,4-phenyl group, a 1,6-phenyl group, analog(s) and derivative(s) thereof, and the like, analog(s) and derivative(s) thereof, and the like)) comprising one or more clickable group(s), or a polyether group comprising one or more clickable group(s), or the like.

In various examples, R² is independently at each occurrence an aliphatic group (e.g., a C₁ to C₂₀, including all integer carbon number and ranges therebetween (e.g., C₃ to C₂₀, or C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), aliphatic group (e.g., an alkyl group, an alkenyl group, or an alkynyl group)), an aromatic group (e.g., a C₆ aromatic group (e.g., a phenyl group, such as, for example, a 1,4-phenyl group, a 1,6-phenyl group, analog(s) and derivative(s) thereof, and the like), a polyether group, an aliphatic group (e.g., a C₁ to C₂₀, including all integer carbon number and ranges therebetween (e.g., C₃ to C₂₀, or C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), a aliphatic group) (e.g., an alkyl group, an alkenyl group, or an alkynyl group)) comprising one or more clickable group(s), an aromatic group (e.g., a C₆ aromatic group (e.g., a phenyl group, such as, for example, a 1,4-phenyl group, a 1,6-phenyl group, analog(s) and derivative(s) thereof, and the like, analog(s) and derivative(s) thereof, and the like)) comprising one or more clickable group(s), or a polyether group comprising one or more clickable group(s). In various examples, one or more or all R¹ and/or one or more or all R² is/are independently further functionalized (e.g., functionalized with a hydroxyl group, an amine group, or the like, or any combination thereof). In various examples, R² is a glycerol group, which may be formed from glycerol, a serinol group, which may be formed from serinol, or the like.

In various examples, a polyether group comprises (or has) the following structure:

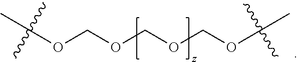

In various examples, z is 1 to 200, including all integer values and ranges therebetween.

In various examples, a plurality of the R¹ groups and/or the R² groups each comprise one or more clickable group(s). In various examples, about 0.5 to about 100 mol % (e.g., about 2 mol % to about 20 mol %), including all 0.01 mol % values and ranges therebetween, of the R¹ groups and/or the R² groups, comprise one or more clickable group(s).

A clickable group-functionalized oligoester or polyester can comprise clickable groups at various positions. In various examples, clickable group(s) is/are chosen from backbone clickable group(s) and/or pendant clickable group(s). As used herein, unless otherwise indicated, backbone clickable group(s) is/are incorporated within the backbone of the clickable group-functionalized oligoester or polyester, while pendant clickable group(s) is/are attached to the backbone (e.g., via a linking group) of the clickable group-functionalized oligoester or polyester.

Pendant clickable group(s) can comprise various direct or indirect connection(s) to the backbone of the clickable group-functionalized oligoester or polyester. In various examples, one or more or all of the pendant clickable group(s) is/are independently directly covalently bound to one of the dicarboxylic acid repeat units comprising the clickable group(s), the diol repeat units comprising the clickable group(s), if present, or the polyol repeat units comprising the clickable group(s), if present.

In various examples, one or more or all of the pendant clickable group(s) is/are independently covalently bound via (or directly through) a linking group to one of the dicarboxylic acid repeat units comprising the clickable group(s), the diol repeat units comprising the clickable group(s), if present, or the polyol repeat units comprising the clickable group(s), if present. In various examples, each linking group independently comprises one or more functional group(s) chosen from alkyl groups, amide groups (e.g., alkyl amide groups and the like), ester (e.g., alkyl ester groups and the like) groups, ether groups (e.g., alkyl ether groups and the like), ketone groups, and the like, and any combination thereof. In various examples, each linking group independently comprises (or has) the following structure:

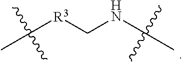

In various examples, R₃ is independently at each occurrence a C₁ to C₁₀ alkyl group, including all integer carbon number values or ranges in between (e.g., C₁, C₂, C₃, C₄, C₅, C₆, C₇, C₈, C₉, or C₁₀), or the like.

A clickable group-functionalized oligoester or polyester can comprise various arrangements of repeat units. In various examples, the clickable group-functionalized oligoester or polyester is a random clickable group-functionalized oligoester or polyester (e.g., comprising a random distribution of unfunctionalized or clickable group functionalized dicarboxylic acid repeat units and/or diol repeat units and/or polyol repeat units) or block polyester (e.g., comprising one or more block(s) of clickable group functionalized dicarboxylic acid repeat units and/or clickable group functionalized diol repeat units and/or clickable group functionalized polyol repeat units and, optionally, one or more block(s) of dicarboxylic acid repeat units and/or diol repeat units and/or polyol repeat units that are not clickable group functionalized).

In various examples, a crosslinkable oligoester or polyester or crosslinked oligoester or polyester comprises two or more domains. In various examples, each domain comprises the same polymeric backbone. In various examples, two or more of the domains have different (e.g., structurally different, such as, different polymeric backbone, different amounts and/or different clickable groups, or the like, or any combination thereof). Each domain independently comprises a clickable group or clickable groups or does not comprise a clickable group or clickable groups. In various examples, a crosslinkable oligoester or polyester or crosslinked oligoester or polyester comprises an A-B-A or an A-B-A′ structure, where the A and the A′ groups have different structure and independently comprise a clickable group or clickable groups (or crosslinked clickable group(s)) and the B group does not comprise a clickable group or clickable groups (or crosslinked clickable group(s)).

A clickable group-functionalized oligoester or polyester can comprise various chain end groups. In various examples, an oligoester or polyester comprises chain ends chosen independently at each occurrence from carboxylic acid group (—CO₂H) and hydroxyl group (—OH) (e.g., α-OH-ω-OH, a-OH-ω-CO₂H and a-CO₂H-ω-CO₂H). In various examples, all chain ends of an oligoester or polyester are hydroxyl groups (—OH) (e.g., all a-OH-ω-OH).

A clickable group-functionalized oligoester or polyester can comprise various number-average molecular weight (Mₙ) and/or weight-average molecular weight (M_{w}) values. In various examples, a clickable group-functionalized oligoester or polyester has a molecular weight (e.g., a M_{w} and/or Mₙ in the case of a polyester) of about 300 g/mol to about 50,000 g/mol, including all 0.1 g/mol values and ranges therebetween (e.g., about 300 g/mol to about 10,000 g/mol, about 300 g/mol to about 15,000 g/mol, or about 400 g/mol to about 50,000 g/mol). In various examples, a clickable group-functionalized oligoester or a polyester has 3 to 50 repeat units (e.g., ester repeat units), including all integer numbers and ranges therebetween.

A clickable group-functionalized oligoester or polyester can comprise various polydispersity (PDI or Ð) values. In various examples, a clickable group-functionalized oligoester or polyester has a polydispersity index (e.g., PDI=M_{w}/Mₙ) of about 1.05 to about 7,including all 0.1 values and ranges therebetween (e.g., from about 1.05 to about 2).

A clickable group-functionalized oligoester or polyester can comprise various thermal properties. In various examples, a clickable group-functionalized oligoester or polyester exhibits a glass transition temperature (T_{g}) of from about −30° C. to about +60° C., including all 0.1° C. values and ranges therebetween (e.g., from about −30° C. to less than about 37° C.).

In an aspect, the present disclosure provides methods of making crosslinkable and/or crosslinked oligoesters and polyesters. In various examples, methods of making crosslinkable and/or crosslinked oligoesters and polyesters produce crosslinkable and/or crosslinked oligoesters and polyesters of the present disclosure. Non-limiting examples of methods of making crosslinkable and/or crosslinked oligoesters and polyesters are disclosed herein.

In various examples, a method of making a crosslinkable oligoester or polyester (e.g., of the present disclosure) comprises one or more polymerization reaction(s) (e.g., a polycondensation reaction, a ring-opening polymerization reaction, or the like, or any combination thereof). A polymerization reaction can be performed under various reaction conditions (such as, for example, temperature, pressure, presence and/or efficiency of a catalyst, presence and/or intensity of an applied energy source, stirring, grinding, or the like, or a combination thereof) and reaction times, which can depend upon the reaction conditions. A polymerization reaction can comprise one or more steps and each step can be performed under the same or different polymerization reaction conditions as other steps.

In various examples, a method is a method of making a clickable group-functionalized oligoester or polyester (e.g., of the present disclosure). In various examples, a method of making a clickable group-functionalized oligoester or polyester (e.g., of the present disclosure) comprises forming a first reaction mixture and/or a second reaction mixture.

In various examples, forming the first reaction mixture results in a polycondensation reaction and formation of an oligoester or a polyester. A polycondensation reaction can be carried out at various temperatures. In various examples, a polycondensation reaction is carried out at room temperature (e.g., from about 20° C. to about 22° C., including all 0.1° C. values and ranges therebetween), below room temperature (e.g., at about 0° C. or below, such as for example, from about −200° C. to about 0° C., including all 0.1° C. values and ranges therebetween) (e.g., about −10° C., about −50° C., about −100° C., about −150° C., or about −200° C.), above room temperature (e.g., at about 100° C. or greater, e.g., from about 100° C. to about 400° C., including all 0.1° C. values and ranges therebetween) (e.g., from about 100° C. to about 200° C., e.g., about 100° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C.), or any combination thereof (e.g., where each step is performed at a different temperature as other steps). In various examples, a polycondensation reaction is carried out at a temperature up to or about a boiling point of one or more reaction solvent(s), if present. In various examples, a polycondensation reaction is carried out at a temperature of at least or greater than the melting point of one or more reaction monomer(s). In various examples, a polycondensation reaction is carried out at a temperature of at least or greater than the boiling point of one or more reaction byproduct(s), if present.

A polycondensation reaction can be carried out at various pressures. In various examples, a polycondensation reaction is carried out at atmospheric pressure (e.g., 1 standard atmosphere (atm) at sea level), at greater than atmospheric pressure (e.g. heating in a sealed pressurized reaction vessel and the like), at below atmospheric pressure (e.g., under vacuum) (e.g., from about 1 mTorr or less to about 100 mTorr or less, including all 0.1 mTorr values and ranges therebetween) (e.g., about 100 mTorr or less, about 50 mTorr or less, about 10mTorr or less, or about 1 mTorr or less) and the like), or any combination thereof (e.g., where each step is performed at a different pressure as other steps).

In various examples, a polycondensation reaction is carried out for a time range from about seconds (e.g., two seconds) to greater than about 200 hours, including all integer second values and ranges therebetween (e.g., from about 1 minute to about 150 hours, including all integer second values and ranges therebetween) (e.g., about 10 minutes, about 1 hour, about 12 hours, about 24 hours, about 120 hours, or about 150 hours), or any combination thereof (e.g., where each step is performed at a different time as other steps).

In various examples, the polycondensation reaction is a catalyzed polycondensation reaction (e.g., via various Lewis acid catalysts, acid catalysts, lipase catalysts, or the like, or any combination thereof). In various examples, the polycondensation reaction is a melt polycondensation reaction (e.g., performed above the melting temperature of the reactants). In various examples, for at least a portion of the reaction time, the polycondensation reaction is performed under conditions (e.g., temperature and/or pressure) sufficient to remove at least a portion of or all of any solvent and/or byproduct, if present, from the formed oligoester or polyester.

In various examples, the first reaction mixture comprises (collectively referred

to as “first mixture reagents”): one or more dicarboxylic acid(s) each, optionally, comprising one or more clickable groups(s); and/or one or more diol(s) each, optionally comprising one or more clickable group(s) and/or one or more polyol(s) each, optionally comprising one or more clickable group(s), where an oligoester or polyester (e.g., a clickable or non-clickable group-functionalized oligoester or polyester) is formed. In various examples, the first reaction mixture further comprises one or more dicarboxylic acid(s), one or more diol(s), one or more polyol(s), or any combination thereof. In various examples, the formed oligoester or polyester of the first reaction mixture comprises a plurality of repeat units each comprising one or more of the clickable group(s). In various examples, the first reaction mixture forms a clickable group-functionalized oligoester or polyester. In various examples, the first reaction mixture forms a random copolymer or a block copolyester (e.g., an ABA-type block copolyster or the like) (e.g., of the present disclosure). In various examples, the “first mixture reagents” each do not comprise a clickable group and the oligoester or polyester does not comprise a clickable group. In various examples, the oligoester or polyester not comprising a clickable group is used as an initiator in a subsequent ring opening polymerization where an oligoester or a polyester comprising clickable groups is formed.

A first reaction mixture can comprise various first mixture reagents. In various examples, the dicarboxylic acid(s) is/are chosen from aliphatic dicarboxylic acid(s) (e.g., saturated aliphatic dicarboxylic acid(s), unsaturated aliphatic dicarboxylic acid(s), and the like, and any combination thereof), aromatic dicarboxylic acid(s), polyether dicarboxylic acid(s), and the like, and any combination thereof. In various examples, the dicarboxylic acid(s) is/are chosen from succinic acid, diglycolic acid, glutaric acid, pimelic acid, suberic acid, azelaic acid, adipic acid, tartaric acid, pimelic acid, suberic acid, azelaic acid, sebacic acid, malic acid, ketoglutaric acid, phthalic acid, terephthalic acid, analog(s) and derivative(s) thereof, and the like, and any combination thereof. In various examples, the dicarboxylic acid(s) comprising one or more clickable group(s) is/are chosen from clickable group-functionalized aliphatic dicarboxylic acid(s), clickable group-functionalized aromatic dicarboxylic acid(s), clickable group-functionalized polyether dicarboxylic acid(s), and the like, and any combination thereof. In various examples, the dicarboxylic acid(s) comprising one or more clickable group(s) is/are chosen from clickable-group functionalized analog(s) and derivative(s) of succinic acid, diglycolic acid, glutaric acid, adipic acid, tartaric acid, pimelic acid, suberic acid, azelaic acid, sebacic acid, malic acid, ketoglutaric acid, phthalic acid, terephthalic acid, or any combination thereof, norbornene-endo-2,3-dicarboxylic acid, cis-4-cyclohexene-1,2-dicarboxylic acid, itaconic acid, maleic acid, fumaric acid, clickable group-functionalized analog(s) and derivative(s) thereof, and the like, and any combination thereof.

In various examples, the diol(s) is/are chosen from aliphatic diol(s), aromatic diol(s), polyether diol(s), and the like, and any combination thereof. In various examples, the diol(s) is/are chosen from propanediol, propylene glycol, 1,4-butanediol, 1,6-hexanediol, 1,8-octanediol, 1,10-decanediol, catechol, hydroquinone, analog(s) and derivative(s) thereof, and the like, and any combination thereof. In various examples, the diol(s) comprising one or more clickable group(s) is/are chosen from clickable group-functionalized aliphatic diol(s), clickable group-functionalized aromatic diol(s), clickable group-functionalized polyether diol(s), and the like, and any combination thereof. In various examples, the diol(s) comprising one or more clickable group(s) is/are chosen from clickable-group functionalized analog(s) and derivative(s) of propanediol, propylene glycol, 1,4-butanediol, 1,6-hexanediol, 1,8-octanediol, 1,10-decanediol, catechol, hydroquinone,, pentaerythritol, oligo-and polyvinyl alcohol, carbohydrates (such as, for example, xylitol and the like), and the like, analog(s) and derivative(s) thereof, and any combination thereof.

In various examples, the polyol(s) is/are chosen from aliphatic polyol(s), aromatic polyol(s), polyether polyol(s), and the like, and any combination thereof. In various examples, the polyol(s) is/are chosen from glycerol, serinol, polyether diol, pentaerythritol, oligo-and polyvinyl alcohol, carbohydrates (such as, for example, xylitol and the like), and the like, analog(s) and derivative(s) thereof, and any combination thereof. In various examples, the polyol(s) comprising one or more clickable group(s) is/are chosen from clickable group-functionalized aliphatic polyol(s), clickable group-functionalized aromatic polyol(s), clickable group-functionalized polyether polyol(s), and the like, and any combination thereof. In various examples, the polyol(s) comprising one or more clickable group(s) is/are chosen from clickable-group functionalized analog(s) and derivative(s) of glycerol, serinol, polyether diol, pentaerythritol, oligo-and polyvinyl alcohol, carbohydrates (such as, for example, xylitol and the like), and the like, analog(s) and derivative(s) thereof, and any combination thereof.

A first reaction mixture can comprise various first mixture reagent concentrations. In various examples, the first reaction mixture comprises at least about 0.5 mol % to about 100 mol %, including all 0.01 mol % values and ranges therebetween (e.g., from about 2 to about 20 mol %), of the first mixture reagent(s) each comprising the clickable group(s), based on the total molar amounts of the first mixture reagents. In various examples, the formed clickable group-functionalized oligoester or polyester of the first reaction mixture comprises at least about 0.5 mol % to about 100 mol %, including all 0.01 mol % values and ranges therebetween (e.g., from about 2 to about 20 mol %), of repeat units each comprising the clickable group(s), based on the total molar amounts of repeat units.

Forming a first reaction mixture can comprise various steps (e.g., multiple reagent addition steps, multiple holding steps between each addition step, or the like). In various examples, forming a first reaction mixture comprises: adding a first portion of the first mixture reagents to the first reaction mixture, where the first portion comprises at least some of or all of the first mixture reagents, optionally, comprising the clickable group(s) and holding the first reaction mixture until a desired degree of conversion is achieved. In various examples, forming a first reaction mixture further comprises adding a second portion of the first mixture reagents to the first reaction mixture, where the second portion, optionally, comprises at least some of or all of the first mixture reagents not comprising the clickable group(s). In various examples, forming a first reaction mixture comprises: adding a first portion of the first mixture reagents to the first reaction mixture, where the first portion comprises at least some of or all of the first mixture reagents not comprising the clickable group(s) and holding the first reaction mixture until a desired degree of conversion is achieved. In various examples, forming a first reaction mixture further comprises adding a second portion of the first mixture reagents to the first reaction mixture, where the second portion comprises at least some of or all of the first mixture reagents comprising the clickable group(s).

In various examples, forming the second reaction mixture results in a ring opening polymerization reaction and formation of an oligoester or a polyester. A ring-opening polymerization reaction can be carried out at various temperatures. In various examples, a ring-opening polymerization reaction is carried out at room temperature (e.g., from about 20° C. to about 22° C., including all 0.1° C. values and ranges therebetween), below room temperature (e.g., at about 0° C. or below, such as for example, from about −200° C. to about 0° C., including all 0.1° C. values and ranges therebetween) (e.g., about −10° C., about −50° C., about −100° C., about −50° C., or about −200° C.), above room temperature (e.g., at about 100° C. or greater, e.g., from about 100° C. to about 400° C., including all 0.1° C. values and ranges therebetween) (e.g., from about 100° C. to about 200° C., e.g., about 100° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C.), or any combination thereof (e.g., where each step is performed at a different temperature as other steps). In various examples, a ring-opening polymerization reaction is carried out at a temperature up to or about a boiling point of one or more reaction solvent(s), if present. In various examples, a ring-opening polymerization reaction is carried out at a temperature of at least or greater than the melting point of one or more reaction monomer(s).

In various examples, a ring-opening polymerization reaction is carried out at atmospheric pressure (e.g., 1 standard atmosphere (atm) at sea level), at greater than atmospheric pressure (e.g. heating in a sealed pressurized reaction vessel and the like), at below atmospheric pressure (e.g., under vacuum (e.g., from about 1 mTorr or less to about 100 mTorr or less, including all 0.1 mTorr values and ranges therebetween) (e.g., about 100 mTorr or less, about 50 mTorr or less, about 10 mTorr or less, or about 1 mTorr or less) and the like), or any combination thereof (e.g., where each step is performed at a different pressure as other steps).

In various examples, a ring-opening polymerization reaction is carried out for a time range from about seconds (e.g., two seconds) to greater than about 200 hours, including all integer second values and ranges therebetween (e.g., from about 1 minute to about 150hours, including all integer second values and ranges therebetween) (e.g., about 10 minutes, about 1 hour, about 12 hours, about 24 hours, about 120 hours, or about 150 hours), or any combination thereof (e.g., where each step is performed at a different time as other steps).

In various examples, the second reaction mixture comprises (collectively referred to as “second mixture reagents”): one or more cyclic anhydride(s) each, optionally, comprising one or more clickable group(s); and/or one or more cyclic ether(s) each, optionally, comprising one or more clickable group(s); and one or more oligoester(s) and/or polyester(s) each comprising one or more protic end group(s), where a clickable group-functionalized oligoester or a polyester is formed. In various examples, the second reaction mixture further comprises one or more cyclic anhydride(s), one or more cyclic ether(s), and/or one or more ring opening copolymerization catalyst(s). In various examples, at least a portion of or all of the second mixture reagents comprises one or more clickable group(s). In various examples, the second reaction mixture further comprises one or more cyclic anhydride(s), one or more cyclic ether(s), and/or one or more ring opening copolymerization catalyst(s). In various examples, the formed clickable group-functionalized oligoester and/or polyester comprises a plurality of the repeat unit(s) each comprising one or more clickable group(s). In various examples, the one or more oligoester(s) and/or polyester(s) each comprising the protic end group(s) comprise(s) a plurality of repeat units each comprising one or more of the clickable group(s). In various examples, the oligoester(s) and/or polyester(s) each comprising the protic end group(s) is/are oligoester(s) and/or polyester(s) of the present disclosure. In various examples, the oligoester(s) and/or polyester(s) each comprising the protic end group(s) is/are the formed oligoester(s) and/or polyester(s) of one or more of the first reaction mixture(s). In various examples, the protic end group(s) is/are chosen from alcohol(s), amine(s), carboxylic acid(s), thiol(s), and the like, and any combination thereof.

A second reaction mixture can comprise various second mixture reagents. In various examples, the cyclic anhydride(s) is/are chosen from aliphatic cyclic anhydride(s), aromatic cyclic anhydride(s), polyether cyclic anhydride(s), and the like, and any combination thereof. In various examples, the cyclic anhydride(s) is/are chosen from succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, analog(s) and derivative(s) thereof, and the like, and any combination thereof. In various examples, the cyclic anhydride(s) comprising one or more clickable group(s) is/are chosen from clickable group-functionalized aliphatic cyclic anhydride(s), clickable group-functionalized aromatic cyclic anhydride(s), clickable group-functionalized polyether cyclic anhydride(s), and the like, and any combination thereof. In various examples, the cyclic anhydride(s) comprising one or more clickable group(s) is/are chosen from clickable-group functionalized analog(s) and derivative(s) of succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, and the like, and any combination thereof, cis-5-norbornene-endo-2,3-dicarboxylic anhydride, cis-4-cyclohexene-1,2-dicarboxylic anhydride, maleic anhydride, itaconic anhydride, fumaric anhydride, clickable group-functionalized analog(s) and derivative(s) thereof, and the like, and any combination thereof.

In various examples, the cyclic ether(s) is/are chosen from aliphatic cyclic ether(s), aromatic cyclic ether(s), polyether cyclic ether(s), and the like, and any combination thereof. In various examples, the cyclic ether(s) is/are chosen from propylene oxide, butylene oxide, epichlorohydrin, glycidyl ether, analog(s) and derivative(s) thereof, and the like, and any combination thereof. In various examples, the cyclic ether(s) comprising one or more clickable group(s) is/are chosen from clickable group-functionalized aliphatic cyclic ether(s), clickable group-functionalized aromatic cyclic ether(s), clickable-group polyether cyclic ether(s), and the like, and any combination thereof. In various examples, the cyclic ether(s) comprising one or more clickable group(s) is/are chosen from clickable group-functionalized analog(s) and derivative(s) of propylene oxide, butylene oxide, epichlorohydrin, glycidyl ether, or any combination thereof, allyl glycidyl ether, clickable group-functionalized analog(s) and derivative(s) thereof, and the like, and any combination thereof.

In various examples, the ring opening copolymerization catalyst(s) is/are chosen from Lewis acid-Lewis base catalyst pair(s), covalently-tethered Lewis acid-Lewis base catalyst(s), and the like, and any combination thereof. In various examples, the ring opening copolymerization catalyst(s) is/are, independently, biocompatible, optically transparent, provide controlled photocrosslinking, or the like, or any combination thereof. In various examples, the ring opening copolymerization catalyst(s) is/are chosen from metal-free or metal-containing Lewis acid-Lewis base catalyst pair(s), covalently-tethered Lewis acid-Lewis base catalyst(s), and the like, and any combination thereof. In various examples, the metal-free Lewis acid-Lewis base catalyst pair(s), covalently-tethered Lewis acid-Lewis base catalyst(s) are boron-based Lewis acid-Lewis base catalyst pair(s), other metal-free Lewis acid-Lewis base catalyst pair(s), covalently-tethered Lewis acid-Lewis base catalyst(s), and the like, and any combination thereof. In various examples, metal-free Lewis acid-Lewis base catalyst pair(s) is/are chosen from organoboranes (such as, for example, triethyl borane-bis(triphenylphosphine) iminium chloride (TEB-[PPN]Cl) catalyst pair and the like), quaternary onium salts catalysts, urea/thiol urea and quaternary onium salt catalysts, and the like, and any combination thereof. In various examples that do not benefit or require metal-free catalysts, various known organometallic catalysts comprising one or two metal centers (such as, for example, aluminum, cobalt, magnesium, tin, chromium, and the like, and any combination thereof) and ligand(s) (such as, for example, salen-type ligands, carboxylates, alkoxides, and more broadly, other types of Lewis acid like alkyl amines and aromatic heterocycles containing conjugated nitrogen atoms, analog(s) and derivative(s) thereof, or the like, or any combination thereof).

A second reaction mixture can comprise various second mixture reagent concentrations. In various examples, the formed clickable group-functionalized oligoester or polyester of the second reaction mixture comprises at least about 0.5 mol % to about 100 mol %, including all 0.01 mol % values and ranges therebetween (e.g., from about 2 to about 20 mol %), of repeat units each comprising the clickable group(s), based on the total molar amounts of repeat units. In various examples, the second reaction mixture comprises at least about 0.5 mol % to about 100 mol %, including all 0.01 mol % values and ranges therebetween (e.g., from about 2 to about 20 mol %) of the second mixture reagents each comprising the clickable group(s), minus the oligoester(s) and/or polyester(s) each comprising the protic end group(s) and the ring opening copolymerization catalyst(s), if present, based on the total molar amounts of the second mixture reagents, minus the oligoester(s) and/or polyester(s) each comprising the protic end group(s) and the ring opening copolymerization catalyst(s), if present. In various examples, the second reaction mixture forms a block copolyester (e.g., an ABA-type block copolyester). In various examples, the second reaction mixture forms a clickable group-functionalized oligoester or polyester of the present disclosure (e.g., a random copolymer or a block copolymer (e.g., an ABA-type block copolyester) of the present disclosure).

In various examples, the second mixture reagents comprise from about 0.1 mol % to about 5 mol % of the ring opening copolymerization catalyst(s), based on the total molar amounts of the second mixture reagents. In various examples, the second mixture reagents comprise from about 40 wt. % to about 90 wt. % of the oligoester(s) or polyester(s), based on the total weight of the second mixture reagents.

In various examples, the oligoester(s) or polyester(s) of the first and/or the second reaction mixture(s) is/are capable of being crosslinked (e.g., interchain, intrachain, or both) (e.g., via radical-initiated crosslinking, such as, for example, photo-initiated crosslinking, thermal-initiated crosslinking, or the like, or any combination thereof) via a plurality of click reactions (e.g., radical-initiated click-reaction, such as, for example, photo-initiated click reaction, thermal-initiated click-reaction, catalyst-initiated click-reaction, or the like, or any combination thereof). In various examples, the clickable group-functionalized oligoester(s) or polyester(s) of the first and/or the second reaction mixture(s) is/are is/are curable resin(s) (e.g., thermally curable resin(s), photo-curable resins(s), or the like, or any combination thereof.

In an aspect, the present disclosure provides compositions. In various examples, compositions comprise one or more crosslinkable oligoester(s) and/or polyester(s) (e.g., of the present disclosure or made by a method of the present disclosure) (e.g., clickable group-functionalized oligoester(s) and/or polyester(s)). Nonlimiting examples of compositions are provided herein.

In various examples, a composition further comprises one or more crosslinking reagent(s) (which may be referred to in that alternative as crosslinkers or multifunctional crosslinkers) capable of reacting with the crosslinkable oligoester(s) and/or polyester(s). In various examples, the clickable group(s) of the oligoester(s) and/or polyester(s) (e.g., first click reagents) form click reaction pair(s) with the crosslinking reagent(s) (second click reagent(s)) (e.g., polyfunctional click reagent(s)) (e.g., of the present disclosure). In various examples, the clickable group(s) is/are alkene-functionalized clickable group(s), alkyne-functionalized clickable group(s), or the like, or any combination thereof. In various examples, the crosslinking reagent(s) (e.g., polyfunctional click reagent(s)) comprise one or more nucleophilic groups(s) or the like. In various examples, a nucleophilic group can react in a click reaction (e.g., with an electrophile, such as, for example, an alkene, an alkyne, or the like). In various examples, the nucleophilic group(s) is/are independently chosen from amine groups, thiol groups, azide groups, and the like, and any combination thereof. In various examples, the crosslinking reagent(s) comprise(s) one or more dithiol(s), one or more multifunctional thiol(s), or the like, or any combination thereof. In various examples, the crosslinking reagent(s) (e.g., polyfunctional click reagent(s)) (e.g., the dithiol(s) and/or the multifunctional thiol(s), or the like) each independently comprise one or more C₃ to C₇ alkyl group(s).

A composition can further comprise various crosslinking initiators. In various examples, a composition further comprises one or more crosslinking initiator(s). In various examples, the crosslinking initiator(s) is/are click reaction initiator(s). In various examples, a composition further comprises one or more radical initiator(s) (e.g., thermal radical initiator(s), photo-initiator(s), or the like, or any combination thereof), or the like, or any combination thereof. Non-limiting examples of thermal radical initiators include azobisisobutyronitrile, tert-butyl hydroperoxide, meta-chloroperoxybenzoic acid, and the like, and any combination thereof. Non-limiting examples of photoinitiators include Darocure TPO, BAPO, benzophenone, Irgacure 1173, Irgacure 2959, VA-086, DMPA, LAP, and Lucirin TPO-L, and the like, and any combination thereof. In various examples, a photoinitiator is an ultraviolet initiator, a visible light initiator, or the like. In various examples, a photoinitiator absorbs one or more wavelength(s) from about 365 nm to about 405 nm, including all nm values and ranges therebetween. In various examples, the radical initiator(s) (e.g., thermal radical initiator(s), photoinitiator(s), or the like, or any combination thereof) is/are present (collectively, in the case where a composition comprises two or more radical initiators) at about 0.1 wt. % to about 2 wt. %, including all 0.01 wt. % values and ranges therebetween, based on the total weight of the composition, minus solvent(s), if present, and additiv(es) (e.g., based on the total weight of the oligoester(s), if present, the polyester(s), if present, the crosslinking reagent(s) (e.g., the diothiol(s), if present, and the multifunctional thiols(s), if present). In various examples, a composition is a resin (e.g., a radical-crosslinkable resin, such as, for example, a photo-crosslinkable resin, a thermally crosslinkable resin, or the like, or any combination thereof).

A composition can further comprise various solvents and/or additives. In various examples, a composition further comprises one or more solvent(s). Non-limiting examples of solvents include carbonates (such as, for example, propylene carbonate and the like), dimethyl sulfoxide, acetonitrile, diethyl fumarate, dimethyl itaconate, diethyl itaconate, and the like, and any combination thereof. In various examples, a solvent is incapable of photo-crosslinking. In various examples, a solvent is capable of crosslinking (e.g., radical-initiated crosslinking, such as, for example, thermally initiated crosslinking, photo-crosslinking, or the like, or any combination thereof). Non-limiting examples of crosslinkable solvents (e.g., reactive diluents) include limonene, diethyl fumarate and 1,3,5-triallyl-1,3,5-triazine-2,4,6 (1H,3H,5H)-trione, and the like, and any combination thereof. In various examples, a composition comprises the crosslinkable oligoester(s) and/or polyester(s), the crosslinkable solvent(s), and the crosslinking initiator(s), and the crosslinking initiator(s) is/are capable of crosslinking the crosslinkable oligoester(s) and/or polyester(s) and/or the crosslinkable solvent(s).

In various examples, a composition further comprises one or more additive(s). In various examples, an additive is a stabilizer. Non-limiting examples of stabilizers include pyrogallol, butylated hydroxytoluene, 4-methoxyphenol, 1,2-dihydroxybenzene, phosphonic acid species, acetic acid, benzoic acid, sulfonic acid, or the like, or any combination thereof.

The oligoester(s) and/or the polyester(s) can be present in various amounts. In various examples, the oligoester(s) and/or the polyester(s) is/are present in a composition at from about 40 wt. % to about 80 wt. %, including all 0.1 wt. % values and ranges therebetween, based on the total weight of the composition, minus solvent(s), if present, and additiv(es), if present (e.g., based on the total weight of the oligoester(s), if present, the polyester(s), if present, the crosslinking reagent(s).

In an aspect, the present disclosure provides materials. In various examples, a material comprises one or more crosslinked oligoester(s) and/or polyester(s), composition(s) thereof, or any combination thereof (e.g., of the present disclosure or made by a method of the present disclosure). In various examples, a material is made by a method of crosslinking (e.g., of the present disclosure) one or more crosslinkable oligoester(s) and/or polyester(s), composition(s) thereof, or any combination thereof (e.g., clickable group-functionalized oligoester(s) and/or polyester(s) and/or composition(s) thereof) (e.g., of the present disclosure or made by a method of the present disclosure). Non-limiting examples of materials are disclosed herein.

In various examples, the crosslinked oligoester(s) and/or polyester(s), composition(s) thereof, or any combination thereof, comprise(s) a plurality of crosslinking groups (e.g., interchain and/or intrachain bonds). In various examples, the crosslinking groups is/are interchain and/or intrachain crosslinking groups. In various examples, the crosslinking groups replace (e.g., are derived from) a plurality of the crosslinkable group(s). In various examples, a plurality of the crosslinkable groups of crosslinkable oligoester(s) and/or polyester(s), composition(s) thereof, or any combination thereof, are transformed into crosslinking groups via a crosslinking reaction. In various examples, the degree of conversion (e.g., the percentage of crosslinkable groups reacted to form crosslinking groups) is from about 10% to about 100%, including all 0.1% values and ranges therebetween, of the clickable groups of corresponding crosslinkable (e.g., non-crosslinked) oligoester(s) and/or polyester(s), composition(s) thereof, or any combination thereof. In various examples, the crosslinking groups are crosslinking groups formed

from a crosslinking reagent (such as, for example, thioether groups (e.g., interchain and/or intrachain crosslinking thioether groups) or the like), each formed by a click reaction of two or more clickable groups (e.g., thiol-reactive clickable group(s) (e.g., alkene-functional clickable group(s), alkyne clickable groups, or the like, or any combination thereof)) with second thiol-functional clickable groups and/or a crosslinking reagent (such as, for example, a polythiol reagent or the like). In various examples, a crosslinking reaction replaces a plurality of the clickable groups of clickable group-functionalized oligoester(s) and/or polyester(s), composition(s) thereof, or any combination thereof, with crosslinking thioether groups. In various examples, the degree of conversion (e.g., the percentage of thiol reactive-clickable groups reacted to form crosslinking thioether groups) is from about 10% to about 100%, including all 0.1% values and ranges therebetween, of the thiol reactive-clickable groups of the corresponding thiol-reactive clickable group-functionalized (e.g., non-crosslinked) oligoester(s) and/or polyester(s), composition(s) thereof, or any combination thereof.

A material can have various forms and/or shapes. In various examples, a material is in the form of a three-dimensional (3D) object. In various examples, a material is a biomedical material, a biological material, or the like. In various examples, a material is a particle, tube, sphere, strand, coiled strand, film, sheet, fiber, mesh, a monolith, or the like.

A composition or material can comprise various additional polymer(s). In various examples, one or more composition(s) and/or material(s) comprise(s) one or more other polymer(s) (e.g., other polymer(s) excluding oligoester(s) and/or polyester(s), e.g., of the present disclosure or made by a method of the present disclosure), composition(s) thereof, material(s) thereof, or any combination thereof, as blends, adducts, or the like with oligoester(s) and/or polyester(s) (, composition(s) thereof, material(s) thereof, or any combination thereof. Without intending to be bound by any particular theory, it is considered the additional polymer(s) may manipulate the degradation properties, mechanical properties, or the like, or any combination thereof, of the composition(s) and/or material(s).

A material can be an elastomer (e.g., a material that behaves like a rubber and/or can undergo multiple cycles of uniaxial tensile loading and unloading). In various examples, a material comprises elastomeric crosslinked oligoester(s) and/or polyester(s), composition(s) thereof, or any combination thereof. In various examples, a material further comprises (e.g., is a blend with) other elastomeric polymer(s) (e.g., other elastomeric polymer(s) excluding elastomeric crosslinked oligoester(s) and/or polyester(s), e.g., of the present disclosure), composition(s) thereof, material(s) thereof, or any combination thereof. It is expected that practically any other elastomeric polymer, composition thereof, material thereof, or combination thereof, can be combined with elastomeric crosslinked oligoester(s) and/or polyester(s) of the present disclosure or made by a method of the present disclosure, composition(s) thereof, material(s) thereof, or any combination thereof.

A material (e.g., an elastomeric material) can exhibit various desirable mechanical properties. In various examples, a material exhibits a Young's modulus of about 0.01 MPa to about 200 MPa, including all 0.1 MPa values and ranges therebetween (about 0.3 MPa to about 12 MPa). In various the material exhibits one or both of the following: a Young's modulus of about 100 kPa to about 500 kPa, including all 0.1 kPa values and ranges therebetween, or about 500 kPa or less; and/or a toughness of about 0.01 to about 50 KJ/m² (e.g., about 0.5 kJ/m²), including all 0.005 KJ/m² values and ranges therebetween.

A composition or material can be biocompatible and/or biodegradable. In various examples, a composition or a material comprises biocompatible and/or biodegradable oligoester(s) and/or polyester(s). In various examples, a composition or a material further comprises (is a blend with) other biocompatible and/or biodegradable polymer(s) (e.g., other biocompatible and/or biodegradable polymer(s) excluding biocompatible and/or biodegradable oligoester(s) and/or polyester(s), e.g., of the present disclosure or made by a method of the present disclosure) (e.g., crosslinkable and/or crosslinked other biocompatible polymer(s)). It is expected that practically any other biocompatible and/or biodegradable polymer, composition thereof, material thereof, or combination thereof can be combined with biocompatible and/or biodegradable oligoester(s) and/or polyester(s) of the present disclosure or made by a method of the present disclosure, composition(s) thereof, material(s) thereof, or any combination thereof.

Exemplary biodegradable other polymers include, but are not limited to, natural polymers and their synthetic analogs, including polysaccharides, proteoglycans, glycosaminoglycans, collagen-GAG, collagen, fibrin, and other extracellular matrix components, such as, for example, elastin, fibronectin, vitronectin, laminin, and the like. Hydrolytically degradable polymers known in the art include, for example, certain polyesters, polyanhydrides, polyorthoesters, polyphosphazenes, polyphosphoesters, and the like, and combinations thereof. Biodegradable polymers known in the art, include, for example, certain polyhydroxyacids, polypropylfumerates, polycaprolactones, polyhydroxyalkanoates, poly(amide-enamines), polyamides, poly(amino acids), polyacetals, polyethers, biodegradable polycyanoacrylates, biodegradable polyurethanes and polysaccharides, and the like, and combinations thereof. In various examples, specific biodegradable polymers that can be used include, but are not limited to, polylysine, poly(lactic acid) (PLA), poly(glycolic acid) (PGA), copolymers and mixtures of PLA and PGA, e.g., poly(lactide-co-glycolide) (PLG), poly(caprolactone) (PCL), poly(lactide-co-caprolactone) (PLC), and poly(glycolide-co-caprolactone) (PGC). Those skilled in the art will recognize that this is an exemplary, not comprehensive, list of biodegradable polymers. The properties of these and other polymers and methods for preparing them are further described in the art. See, for example, U.S. Pat. Nos. 6,123,727; 5,804,178; 5,770,417; 5,736,372; 5,716,404; 6,095,148; 5,837,752; 5,902,599; 5,696,175; 5,514,378; 5,512,600; 5,399,665 to Barrera; 5,019,379; 5,010,167; 4,806,621; 4,638,045; and 4,946,929; see also Wang et al., J. Am. Chem. Soc. 123:9480, 2001; Lim et al., J. Am. Chem. Soc. 123:2460, 2001; Langer, Acc. Chem. Res. 33:94, 2000; Langer, J. Control Release 62:7, 1999; and Uhrich et al., Chem. Rev. 99:3181, 1999.

In various examples, crosslinkable and/or crosslinked oligoester(s) and/or polyester(s), a composition thereof, a material thereof, or an article of manufacture thereof (e.g., a film thereof, a fiber thereof, a scaffold thereof, or the like) is/are impregnated with and/or a surface thereof is coated with one or more (such as, for example, two, three, four, five, etc.) suitable pharmaceutical agent(s). It is contemplated that suitable pharmaceutical agents can be organic or inorganic and may be in a solid, semisolid, liquid, or gas phase. In various examples, a pharmaceutical agent is a molecule. Molecules can be present in combinations or mixtures with other molecules, and can be in solution, suspension, or any other form. Examples of classes of molecules that can be used include, but are not limited to, human or veterinary therapeutics, cosmetics, nutraceuticals, agriculturals (such as, for example, herbicides, pesticides and fertilizers), vitamins, salts, electrolytes, amino acids, peptides, polypeptides, proteins, carbohydrates, lipids, nucleic acids, glycoproteins, lipoproteins, glycolipids, glycosaminoglycans, proteoglycans, growth factors, hormones, neurotransmitters, pheromones, chalones, prostaglandins, immunoglobulins, monokines and other cytokines, humectants, metals, gases, minerals, plasticizers, ions, electrically and magnetically reactive materials, light sensitive materials, anti-oxidants, molecules that may be metabolized as a source of cellular energy, antigens, any molecules that can cause a cellular or physiological response, and the like. Any combination of molecules can be used, as well as agonists or antagonists of these molecules.

Pharmaceutical agents include any therapeutic molecule including, but not limited to, any pharmaceutical substance or drug or the like. Examples of pharmaceuticals include, but are not limited to, anesthetics, hypnotics, sedatives and sleep inducers, antipsychotics, antidepressants, antiallergics, antianginals, antiarthritics, antiasthmatics, antidiabetics, antidiarrheal drugs, anticonvulsants, antihistamines, antipruritics, emetics, antiemetics, antispasmodics, appetite suppressants, neuroactive substances, neurotransmitter agonists, antagonists, receptor blockers and reuptake modulators, beta-adrenergic blockers, calcium channel blockers, disulfiram and disulfiram-like drugs, muscle relaxants, analgesics, antipyretics, stimulants, anticholinesterase agents, parasympathomimetic agents, hormones, anticoagulants, antithrombotics, thrombolytics, immunoglobulins, immunosuppressants, hormone agonists/antagonists, vitamins, antimicrobial agents, antineoplastics, antacids, digestants, laxatives, cathartics, antiseptics, diuretics, disinfectants, fungicides, ectoparasiticides, antiparasitics, heavy metals, heavy metal antagonists, chelating agents, gases and vapors, alkaloids, salts, ions, autacoids, digitalis, cardiac glycosides, antiarrhythmics, antihypertensives, vasodilators, vasoconstrictors, antimuscarinics, ganglionic stimulating agents, ganglionic blocking agents, neuromuscular blocking agents, adrenergic nerve inhibitors, anti-oxidants, vitamins, cosmetics, anti-inflammatoires, wound care products, antithrombogenic agents, antitumoral agents, antiangiogenic agents, anesthetics, antigenic agents, wound healing agents, plant extracts, growth factors, emollients, humectants, rejection/anti-rejection drugs, spermicides, conditioners, antibacterial agents, antifungal agents, antiviral agents, antibiotics, tranquilizers, cholesterol-reducing drugs, antitussives, histamine-blocking drugs, monoamine oxidase inhibitor. All pharmaceutical agents listed by the U.S. Pharmacopeia are also included within the pharmaceutical agents of the present disclosure.

In an aspect, the present disclosure provides fibers and films. In various examples, a fiber or a film comprises one or more crosslinkable and/or crosslinked oligoester(s) and/or polyester(s), composition(s) thereof, material(s) thereof, or any combination thereof (e.g., of the present disclosure or made by a method of the present disclosure). In various examples, a fiber or a film is made by a method of the present disclosure. Non-limiting examples of fibers and films are disclosed herein.

In various examples, a fiber or a film comprises a blend of one or more crosslinkable and/or crosslinked oligoester(s) and/or polyester(s), composition(s) thereof, material(s) thereof, or any combination thereof with one or more other polymer(s) (e.g., other polymer(s) excluding the oligoester(s) and/or polyester(s) of the present disclosure or prepared by a method of the present disclosure, composition(s) thereof, material(s) thereof, or any combination thereof). Various other polymers, compositions thereof, materials thereof, or combinations thereof can be used. In various examples, other polymer(s), other polymeric composition(s), and/or other polymeric material(s) comprise(s) (or is/are) polylactic acids (PLAs), polyglycolic acids (PGAs), PLGAs, poly(caprolactone)s (PCLs), polyethylene glycols (PEGs), polyethylene terephthalates (PETs), polypropylenes, polyethylenes, nylons, polystyrenes, poly(glycerol sebacate) (PGS), poly(methyl methacrylate) (PMMA), poly(acrylic acid) (PAA), or the like, or combinations thereof.

In various examples, a fiber is formed by, for example, electrospinning, wet spinning, melt spinning, or other processes that drive polymers through a small orifice, or the like. A fiber can comprise one or more other polymer(s) and/or one or more other polymer(s), other polymeric composition(s), other polymeric material(s), or any combination thereof.

In various examples, a material comprises a plurality of fibers. A material can comprise various forms. In various examples, a material is a fabric or the like. In various examples, a fabric is a weave or braid of fibers or the like. In various examples, a material comprises one or more fibers having crosslinked oligoester(s) and/or polyester(s) and further comprises one or more other fiber(s) (other fiber(s) not comprising crosslinked oligoester(s) and/or polyester(s)). Various other fiber(s) can be used. In various examples, other fiber(s) comprise(s) (or is/are) polylactic acid (PLA) fibers, (PCL) fibers, polyethylene glycol (PEG) fibers, PLGA, poly(lactide-co-caprolactone) (PLCL), poly(glycerol sebacate) (PGS), poly(methyl methacrylate) (PMMA), poly(acrylic acid) (PAA) fibers, or the like, or combinations thereof.

In an aspect, the present disclosure provides articles of manufacture. In various examples, an article of manufacture comprises one or more crosslinkable and/or crosslinked oligoester(s) and/or polyester(s) (e.g., of the present disclosure), one or more composition(s) thereof, one or more material(s) thereof, or any combination thereof. In various examples, an article of manufacture is a three-dimensional (3D) object. In various examples, an article of manufacture is made by a method of the present disclosure. Non-limiting examples of articles of manufacture are disclosed herein.

An article of manufacture can comprise one or more elastomer(s) of the present disclosure. In various examples, an article of manufacture is used in a biomedical application or a biological application. In various examples, an article of manufacture is a scaffold, a tissue graft, or the like. Non-limiting examples of scaffolds and tissue grafts are disclosed herein. In various examples, the article of manufacture is chosen from a device, a scaffold, a tissue graft, a skin patch, and the like. In various examples, the device is chosen from a microfluidic device, a lab on a chip, a drug delivery device, and the like.

In various examples, a crosslinked oligoester(s) and/or polyester(s) is an elastomeric biodegradable polyester. The elasticity of crosslinked oligoester(s) and/or polyester(s) is important for use of the crosslinked oligoester(s) and/or polyester(s) (and fibers, materials or the like comprising one or more of the crosslinked oligoester(s) and/or polyester(s)) for use in regenerating a variety of tissues. The crosslinked oligoester(s) and/or polyester(s) may be used to tissue engineer, for example, epithelial, connective, nerve, muscle, gland, and other tissues and organs. Exemplary tissues and organs that can benefit from the materials of the disclosure include, but are not limited to, blood and lymphatic vessels, ligament, skin, tendon, muscle, heart, lung, kidney, nerve, liver, pancreas, bladder, intestine, and others. Crosslinked oligoester(s) and/or polyester(s) can also be used as the template for, for example, mineralization and formation of bone, or the like. In various examples, crosslinked oligoester(s) and/or polyester(s) of the present are useful for regenerating tissues that are subject to repeated tensile, hydrostatic, or other stresses, such as, for example, lung, blood vessels, heart valve, bladder, cartilage, muscle, and the like.

In some examples, the generated tissue grafts are for the replacement and/or repair of damaged native tissues. For example, the disclosed grafts are contemplated to be implantable for tensile load bearing applications, such as, for example, being formed into tubular networks with a finite number of inlets and outlets. These structures can be either seeded with cells or implanted directly and relying on the host to serve as cell source and “bioreactor”. These structures can be implanted as artificial organs and the inlets and outlets will be connected to host tissues vasculature, and the like.

In various examples, a tissue graft comprises one or more crosslinked oligoester(s) and/or polyester(s). In various examples, a tissue graft comprises one or more crosslinked oligoester(s) and/or polyester(s) and/or one or more material(s) comprising crosslinked oligoester(s) and/or polyester(s) and/or one or more fiber(s) comprising one or more crosslinked oligoester(s) and/or polyester(s). A tissue graft may comprise (e.g., further comprise) a polymer component which is not a polyester component, such as, for example, PETE or the like. In various examples, such polymer components are non-biodegradable. In various examples, a tissue graft comprises one or more other fiber(s) (not comprising crosslinkable or crosslinked oligoester(s) and/or polyester(s), e.g., of the present disclosure or made by a method of the present disclosure), and some or all of which may degrade forming a scaffold comprising the remaining fibers.

The various dimensions of a scaffold or tissue graft may vary according to the desired use. The shape of the crosslinked oligoester(s) and/or polyester(s) may also be manipulated for specific tissue engineering applications. Exemplary shapes include, but are not limited to, particles, tubes, spheres, strands, coiled strands, films, sheets, fibers, meshes, and the like. In various examples, a scaffold or a tissue graft is porous.

A tissue graft can comprise various forms. In various examples, a tissue graft is a soft tissue graft or the like. In various examples, a tissue graft is a soft tissue graft (such as, for example, blood vessel grafts, muscle grafts, skin grafts, ligament grafts, internal organs (such as, for example, lungs, kidneys, hearts or the like), nervous system tissue grafts or the like), or the like.

One or more biomolecule(s), small molecule(s), bioactive agent(s) or the like may be encapsulated within a crosslinkable or crosslinked oligoester(s) and/or polyester(s), a fiber, a scaffold, or article of manufacture and may be linked to it using non-covalent interactions. Attachment of a biomolecule(s), small molecule(s), bioactive agent(s), or the like to a crosslinked oligoester(s) and/or polyester(s) may result in a slower release rate because a biomolecule/biomolecules, small molecule/molecules, bioactive agent/agents, or the like is/are released from the material as it degrades. In contrast, if a biomolecule/biomolecules, small molecule/molecules, bioactive agent/agents is/are encapsulated within crosslinked oligoester(s) and/or polyester(s), it may diffuse out of the crosslinked oligoester(s) and/or polyester(s) before the crosslinked oligoester(s) and/or polyester(s)) degrades (e.g., substantially degrades). In various examples, diffusion of the encapsulated molecules and degradation of the crosslinked oligoester(s) and/or polyester(s) occur at the same time.

The crosslinked oligoester(s) and/or polyester(s) may be electrospun to form scaffolds of any desired shape, such as, for example, sheets, tubes, meshes, pseudo 3-dimensional constructs, and the like. In various examples, the constructs may be of high porosity, low porosity, or a combination of different porosity. In some examples, the constructs are vascularized (micro-channeled) fibrous sheets, random meshes, aligned sheets, cylindrical tubes, or pseudo 3-dimensional constructs, such as, for example, shapes to mimic organs or the like. Electrospinning with a sacrificial template can be used to create highly porous scaffolds. Porous morphology can be varied. These structures are especially useful for applications in soft and elastomeric tissues.

In various examples, the article of manufacture is configured (e.g., in an array or the like) to contain one or more collection(s) of cells (e.g., cells, 3-D aggregate of cells (e.g., an organoid or the like), cell culture(s), biopsy sample(s), or the like, or a combination thereof) and, optionally, to contact the collection(s) individually with a host composition (e.g., cell culture medium or the like). The collection(s) and/or individual collection(s) may comprise all the same cell types or cells or one or more or all of the cell types or cells may be different than the other cell types or cells of the collection(s) or individual collection. The collection(s) of cells may be independently contained in a 3-D space (e.g., a void, chamber, or the like). The collection(s) of cells may be independently contacted (e.g., statically, dynamically, or both) with (e.g., perfused with or the like) one or more host composition(s) (e.g., cell culture medium(s) or the like). The contacting may be single channel or multichannel and/or laminar flow or the like and/or single direction flow or the like. In various examples, the article of manufacture does not comprise PDMS, a hydrogel, or both PDMS and a hydrogel. In various examples, an article of manufacture is formed using an additive manufacturing method (such as, for example, a 3-D printing method (e.g., DLP and the like), or the like).

In an aspect, the present disclosure provides methods of forming objects. In various examples, an object is a 3-D object (which may be a 3-D printed object, an article of manufacture, or the like, In various examples, objects comprise one or more material(s) (e.g., material(s) comprising one or more crosslinked oligoester(s) and/or polyester(s), composition(s) thereof, or any combination thereof (e.g., of the present disclosure or made by a method of the present disclosure). (e.g., of the present disclosure). In various examples, methods of forming objects comprise crosslinking one or more crosslinkable oligoester(s) and/or polyester(s) (e.g., clickable group-functionalized oligoester(s) and/or polyester(s) (e.g., of the present disclosure), composition(s) thereof, or any combination thereof. Nonlimiting examples of methods of forming objects are provided herein.

In various examples, a method of forming objects comprises one or more crosslinking reaction(s) (e.g., click reaction(s), or the like, or any combination thereof). A crosslinking reaction can be performed under various reaction conditions (such as, for example, temperature, pressure, presence and/or efficiency of a catalyst, presence and/or intensity of an applied energy source, stirring, grinding, or the like, or a combination thereof) and reaction times, which can depend upon the reaction conditions. A crosslinking reaction can comprise one or more step(s) and, in the case where the crosslinking reaction comprises a pluarality of steps, each step can be performed under the same or different crosslinking reaction conditions as other steps.

A crosslinking reaction can be performed under various reaction conditions. A crosslinking reaction can comprise one or more steps and each step can be performed under the same or different reaction conditions as other steps. A crosslinking reaction can be carried out at various temperatures. In various examples, a crosslinking reaction is carried out at room temperature (e.g., from about 20° C. to about 22° C., including all 0.1° C. values and ranges therebetween), below room temperature (e.g., at about 0° C. or below, such as for example, from about −200° C. to about 0° C., including all 0.1° C. values and ranges therebetween) (e.g., about-10° C., about −50° C., about −100° C., about −150° C., or about-200° C.), above room temperature (e.g., at a temperature up to or about a boiling point of the solvent(s), if present) (e.g., at about 100° C. or above, e.g. from about 100° C. to about 400° C., including all 0.1° C. values and ranges therebetween) (e.g., from about 100° C. to about 200° C., e.g., about 100° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C.), or any combination thereof (e.g., where each step is performed at a different temperature as other steps).

A crosslinking reaction can be carried out at various pressures. In various examples, a click reaction is carried out at atmospheric pressure (e.g., 1 standard atmosphere (atm) at sea level), at greater than atmospheric pressure (e.g. heating in a sealed pressurized reaction vessel and the like), at below atmospheric pressure (e.g., under vacuum (e.g., from about 1 mTorr or less to about 100 mTorr or less, including all 0.1 mTorr values and ranges therebetween) (e.g., about 100 mTorr or less, about 50 mTorr or less, about 10 mTorr or less, or about 1 mTorr or less) and the like), or any combination thereof (e.g., where each step is performed at a different pressure as other steps).

A crosslinking reaction can be carried out for various times. The reaction time can depend on factors such as, for example, temperature, pressure, presence and/or efficiency of a catalyst, presence and/or intensity of an applied energy source, stirring, grinding, or the like, or a combination thereof. In various examples, reaction times range from about seconds (e.g., two seconds) to greater than about 200 hours, including all integer second values and ranges therebetween (e.g., from about 1 minute to about 150 hours, including all integer second values and ranges therebetween) (e.g., about 10 minutes, about 1 hour, about 12 hours, about 24 hours, about 120 hours, or about 150 hours), or any combination thereof (e.g., where each step is performed at a different time as other steps).

In various examples, a crosslinking reaction is a click reaction (e.g., of the present disclosure) of at least a portion of or all of the clickable groups (e.g., first click reagents) of a clickable group-functionalized oligoester or polyester (e.g., of the present disclosure) with second click reagents of a click reaction (e.g., second clickable groups and/or polyfunctional groups). In various examples, a click reaction is an initiated click reaction. In various examples, crosslinking of a clickable group-functionalized oligoester or polyester can be initiated by electromagnetic radiation (e.g., light, UV, and the like), heat, or the like, or any combination thereof. In various examples, an oligoester or polyester is a radical-initiated (e.g., a radical-crosslinkable) clickable group functionalized oligoester or polyester that can be crosslinked by radical-initiation (e.g., photo-crosslinked or thermally crosslinked) via a click reaction (which may be a photo-click reaction, thermal-click reaction, or the like). In various examples, a click reaction is a catalyzed click reaction. In various examples crosslinking of a clickable group-functionalized oligoester or polyester is catalyzed by one or more radical imitator(s), or the like. In various examples, a method of forming an object comprises a crosslinking

reaction of one or more composition(s) comprising one or more crosslinkable oligoester(s) and/or polyester(s) (e.g., clickable group-functionalized oligoester(s) and/or polyester(s)) (e.g., of the present disclosure). In various examples, the composition(s) further comprise(s) one or more crosslinking reagent(s) (e.g., polyfunctional click reagent(s)) (e.g., of the present disclosure), one or more solvent(s) each capable of crosslinking during the crosslinking reaction of the composition(s) (e.g., of the present disclosure), and/or one or more crosslinking initiator(s) (e.g., click reaction initiator(s)) (e.g., of the present disclosure). In various examples, a method of forming an object comprises heating and/or irradiating with electromagnetic radiation the composition(s) (e.g., thiol-reactive clickable group-functionalized oligoester(s) and/or polyester(s)) (e.g., of the present disclosure), where a plurality of crosslinking groups are formed (e.g., crosslinking thioether groups, where each crosslinking thioether group is formed by a reaction of two of the clickable groups (which may be the same or different (e.g., structurally different or the like) and/or may be on the same chain of a polyester or on different polyester chains) with one or more crosslinking reagent(s) (e.g., a dithiol, a multifunctional thiol, or the like) (e.g., of the present disclosure). In various examples, the degree of conversion (e.g., the percentage of crosslinkable groups (e.g., clickable groups) reacted to form crosslinking groups (e.g., crosslinking thioether groups)) is from about 10% to about 100%, including all 0.1% values and ranges therebetween, of the crosslinkable groups (e.g., clickable groups) of corresponding crosslinkable (e.g., non-crosslinked) (clickable group-functionalized) oligoester(s) and/or polyester(s), composition(s) thereof, or any combination thereof.

In various examples, composition(s) are formed into a predetermined three-dimensional shape (which may approximate the desired final shape of the object) prior to irradiation and/or heating. In various examples, a method forms the composition(s) into a film or fiber of (or from) the composition(s) (e.g., during and/or prior to heating and/or irradiation). In various examples, objects are articles of manufacture (e.g., a device (e.g., a microfluidic device, a lab on a chip, a drug delivery device, or the like), a scaffold, a skin patch, or the like) (e.g., of the present disclosure). In various examples, a method is a point of care method comprising applying the composition(s), which comprise one or more photoinitiator(s), to an individual and subsequently irradiating the composition(s).

In various examples, a method of forming an object is an additive manufacturing method. In various examples, the additive manufacturing method is a 3-D printing method, UV-assisted electrospinning, UV-assisted electrowriting, or any combination thereof. In various examples, the 3-D printing method is digital light processing (DLP).

The following Statements describe various examples of methods, products and systems of the present disclosure and are not intended to be in any way limiting:

Statement 1. An oligoester or a polyester (e.g., a crosslinkable clickable group functionalized oligoester or polyester) comprising at least about 0.5 to about 100 mol % (e.g., about 2 to about 20 mol %) (based on the total moles of dicarboxylic acid repeat units and/or diol repeat units and/or polyol repeat units), including all 0.1 mol % values and ranges therebetween, dicarboxylic acid repeat units and/or diol repeat units repeat units (if present) and/or polyol repeat units (if present), independently comprising one or more clickable group(s) (e.g., alkenyl groups, such as, for example, terminal alkenyl groups and the like, alkynyl groups, such as for example, terminal alkynyl groups and the like) (e.g., 1, 2, or 3 clickable group(s)) (which may be independently covalently bound to the dicarboxylic acid repeat unit or the diol repeat unit (if present) or the polyol repeat unit (if present) via (or directly through) a linking group).
Statement 2. An oligoester or a polyester according to Statement 1, wherein the polyester comprises the following structure:

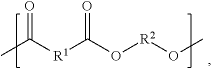

wherein R¹ is independently a C₁ to C₂₀ (e.g., C₃ to C₂₀), including all integer carbon number and ranges therebetween, an aliphatic group (e.g., an alkyl group, an alkenyl group, or an alkynyl group), a C₆ aromatic group (e.g., a phenyl group, such as, for example, a 1,4-phenyl group, a 1,6 phenyl group, and the like), a polyether group, a C₁ to C₂₀ (e.g., C₃ to C₂₀), including all integer carbon number and ranges therebetween, an aliphatic group (e.g., an alkyl group, an alkenyl group, or an alkynyl group) comprising one or more clickable group(s), a C₆ aromatic group (e.g., a phenyl group, such as, for example, a 1,4-phenyl group, a 1,6 phenyl group, and the like) comprising one or more clickable group(s), or a polyether group comprising one or more clickable group(s), and R² is independently a C₁ to C₂₀ (e.g., C₃ to C₂₀), including all integer carbon number and ranges therebetween, an aliphatic group (e.g., an alkyl group, an alkenyl group, or an alkynyl group), a C₆ aromatic group (e.g., a phenyl group, such as, for example, a 1,4-phenyl group, a 1,6 phenyl group, and the like), a polyether group, a C₁ to C₂₀ (e.g., C₃ to C₂₀), including all integer carbon number and ranges therebetween, an aliphatic group (e.g., an alkyl group, an alkenyl group, or an alkynyl group) comprising one or more clickable group(s), a C₆ aromatic group (e.g., a phenyl group, such as, for example, a 1,4-phenyl group, a 1,6 phenyl group, and the like) comprising one or more clickable group(s), or a polyol group comprising one or more clickable group(s).
Statement 3. An oligoester or a polyester according to Statement 2, wherein about 0.5 to about 100 mol % (e.g., about 2 to about 20 mol %), including all 0.01 mol % values and ranges therebetween, of the R¹ groups comprise one or more clickable group(s), or about 0.5 to about 100 mol % (e.g., about 2 to about 20 mol %), including all 0.01 mol % values and ranges therebetween, of the R² groups comprise one or more clickable group(s).
Statement 4. An oligoester or a polyester according to any of the preceding Statements, wherein the clickable group(s) is/are covalently bound to the dicarboxylic acid repeat unit(s) or the diol repeat unit(s) (if present) or the polyol repeat unit(s) (if present) independently via (or directly through) a linking group comprising (or the linking groups is) one or more functional groups chosen from alkyl groups, amide groups (e.g., alkyl amide groups and the like), ester (e.g., alkyl ester groups and the like) groups, ether groups (e.g., alkyl ether groups and the like), and the like, and any combination thereof.
Statement 5. A method of making an oligoester or a polyester of any one of Statements 1-4 comprising contacting: a diacid comprising one or more clickable groups(s) and/or a diol comprising one or more clickable group(s) and/or a polyol comprising one or more clickable group(s) and/or, and optionally, a diacid, and optionally, a diol, a polyol, or a combination thereof, wherein the oligoester or the polyester is formed.
Statement 6. A method according to Statement 5, wherein the diacid comprising a clickable group is chosen from clickable-group functionalized saturated diacids, clickable-group functionalized unsaturated diacids acids, clickable-group functionalized polyether diacids acids, clickable-group functionalized heterofunctionalized diacids, norbornene-endo-2,3-dicarboxylic acid, itaconic acid, and the like, and any combination thereof.
Statement 7. A method according to Statement 5 or 6, wherein the diol comprising a clickable group is chosen from clickable-group functionalized saturated diols, clickable-group functionalized polyether diols, clickable-group heterofunctionalized diols, and the like and any combination thereof.
Statement 8. A method according to any one of Statements 5-7, wherein the diacid is chosen from saturated diacids, unsaturated diacids acids, heterofunctionalized diacids, and the like, and any combination thereof.
Statement 9. A method according to any one of Statements 5-8, wherein the diol is chosen from saturated diols, polyether diols, heterofunctionalized diols, and the like and any combination thereof.
Statement 10. A composition comprising one or more oligoester(s) and/or one or more polyester(s) of any one of Statements 1-4, or 26 (and/or one or more oligoester(s) and/or one or more polyester(s) made by a method of any one of Statements 5-9 or 27-34) and one or more dithiol(s) (e.g., alkyl dithiol(s) or the like), one or more multifunctional thiol(s), or any combination thereof.
Statement 11. A composition according to Statement 10, wherein the oligoester(s) and/or polyester(s) is/are present at about 40 to about 80% by weight, including all 0.1% by weight values and ranges therebetween, based on the total weight of the composition (collectively, in the case where a composition comprises two or more oligoester(s) and/or polyester(s)) and/or one or more dithiol(s) (e.g., alkyl dithiol(s) or the like), one or more multifunctional thiol(s), or the like, or any combination thereof is/are present such that the clickable group: thiol group stoichiometry is about 1:1.2 to about 1.2:1 (e.g., about 1:1.1 to about 1.1:1, or about 1:1), including all 0.01 ratio values and ranges therebeteween.
Statement 12. A composition according to Statement 10 or 11, wherein the dithiol(s) (e.g., alkyl dithiol(s) or the like) and/or multifunctional thiol(s) independently comprise one or more C3 to C7 alkyl group(s), including all integer number of carbons and ranges therebeteween.

Statement 13. A composition according to any one of Statements 10-12, wherein in the composition further comprises one or more radical initiator (e.g., thermal radical initiator(s), photoinititator(s), or the like, or any combination thereof).

Statement 14. A composition according to Statement 13, wherein the radical initiator(s) (e.g., thermal radical initiator(s), photoinitiator(s), or the like, or any combination thereof) is/are present (collectively, in the case where a composition comprises two or more radical initiators) at about 0.1 wt % to about 2wt % (based on the total weight of the composition (not including solvent(s) or additiv(es)), including all 0.01 wt. % values and ranges therebetween.
Statement 15. A composition according to any one of Statements 10-14, wherein in the composition further comprises one or more solvent(s) or one or more additive(s).
Statement 16. A material comprising one or more crosslinked oligoester(s) and/or one or more crosslinked polyester(s) of any one of Statements 1-4, 26 (and/or one or more crosslinked oligoester(s) and/or one or more crosslinked polyester(s) made by a method of any one of Statements 5-9, 27-34) and/or one or more crosslinked oligoester(s) and/or one or more crosslinked polyester(s) made using a composition according to any one of Statements 10-15, wherein the crosslinked oligoester(s) and/or crosslinked polyester(s) comprise(s) a plurality of crosslinking thioether groups (e.g., interchain crosslinking groups, intrachain crosslinking groups, or both interchain crosslinking groups and intrachain crosslinking groups).

Statement 17. A material according to Statement 16, wherein the degree of conversion (the percentage of clickable groups reacted to form a crosslinking group) is about 10% to about 100%, including all 0.1% values and ranges therebetween.

Statement 18. A material according to Statement 16 or 17, wherein the material exhibits one or both of the following: a Young's modulus of about 100 kPa to about 500 kPa, including all 0.1kPa values and ranges therebetween, or about 500 kPa or less, or about 0.3 MPa to about 12 MPa, including all 0.1 MPa values and ranges therebetween; or a toughness of about 0.01 to about 50 KJ/m² (e.g., about 0.5 kJ/m²), including all 0.005 kJ/m² values and ranges therebetween.
Statement 19. An article of manufacture comprising one or more elastomer material(s) of any of Statements 16-18, or 35.
Statement 20. An article of manufacture according to Statement 19, wherein the article of manufacture is chosen from a device (such as, for example, a microfluidic device, a lab on a chip, a drug delivery device, and the like), a scaffold, a tissue graft, a skin patch, and the like). Statement 21. A method of forming an object (which may be a three-dimensional object) comprising irradiating a composition of any one of Statements 13-15 (or a combination of two or more of the compositions) with electromagnetic radiation and/or heating the composition(s), wherein a plurality of thioether groups are formed by reaction (which may be a thermal reaction and/or a photochemical reaction) of two clickable groups (which may be the same or different (e.g., structurally different or the like) and/or may be on the same chain of a polyester or on different polyester chains) of the polyester with a dithiol (e.g., an alkyl dithiol or the like) or a multifunctional thiol.
Statement 22. A method according to any one of Statements 21, 36-15, further comprising forming a film or fiber of (or from) the composition (e.g., during irradiation or prior to irradiation).
Statement 23. A method according to Statement 21 or 22, wherein the method is an additive manufacturing method.
Statement 24. A method according to Statement 23, wherein in the additive manufacturing method is a 3-D printing method, UV-assisted electrospinning/electrowriting, or the like, or any combination thereof.
Statement 25. A method according to Statement 24, wherein the 3-D printing method is digital light processing (DLP).
Statement 26. An oligoester or polyester according to any one of Statements 1-4, comprising a molecular weight (M_{w} and/or Mₙ) of about 300 g/mol to about 15,000 g/mol, including all 0.1 g/mol molecular weight (M_{w}and/or Mₙ) values and ranges therebetween (e.g., from about 300 g/mol to about 10,000 g/mol); and/or comprising a polydispersity index of from about 1.05 to about 7.0, including all 0.1 polydispersity index values and ranges therebetween (e.g., from about 1.05 to about 2).
Statement 27. An oligoester or polyester according to any one of Statements 1-4, or 26, exhibiting a glass transition temperature (T_{g}) of from about −30° C. to about 60° C., including all 0.1° C. values and ranges therebetween (e.g., from about −30° C. to less than about 37° C.). Statement 28. A method of making an oligoester or a polyester, the method comprising: forming a first reaction mixture comprising (collectively referred to as “first mixture reagents”): one or more dicarboxylic acid(s) each comprising one or more clickable groups(s); and/or one or more diol(s) each comprising one or more clickable group(s); and/or one or more polyol(s) each comprising one or more clickable group(s); and optionally, one or more dicarboxylic acid(s); and optionally, one or more diol(s), one or more polyol(s), or the like, or any combination thereof, wherein an oligoester or polyester comprising a plurality of repeat units each comprising one or more of the clickable group(s) is formed; and/or forming a second reaction mixture comprising (collectively referred to as “second mixture reagents”): one or more cyclic anhydride(s) each comprising one or more clickable group(s); and/or one or more cyclic ether(s) each comprising one or more clickable group(s); and one or more oligoester(s) and/or polyester(s) each comprising one or more protic end group(s) and optionally a plurality of repeat units each comprising one or more clickable group(s), optionally wherein the oligoester(s) and/or polyester(s) is/are the formed oligoester(s) and/or polyester(s) of one or more of the first reaction mixture(s); and optionally, one or more cyclic anhydride(s); and optionally, one or more cyclic ether(s); and optionally, one or more ring opening copolymerization catalyst(s), wherein an oligoester or a polyester is formed comprising a plurality of repeat units each comprising one or more of the clickable group(s).
Statement 29. A method of making an oligoester or a polyester according to Statement 28, wherein: forming the first reaction mixture comprises: adding a first portion of the first mixture reagents to the first reaction mixture, wherein the first portion comprises at least some of or all of the first mixture reagents comprising the clickable group(s); holding the first reaction mixture until a desired degree of conversion is achieved; and optionally adding a second portion of the first mixture reagents to the first reaction mixture, wherein the second portion comprises at least some of or all of the first mixture reagents not comprising the clickable group(s); or forming the first reaction mixture comprises: adding a first portion of the first mixture reagents to the first reaction mixture, wherein the first portion comprises at least some of or all of the first mixture reagents not comprising the clickable group(s); holding the first reaction mixture until a desired degree of conversion is achieved; and optionally adding a second portion of the first mixture reagents to the first reaction mixture, wherein the second portion comprises at least some of or all of the first mixture reagents comprising the clickable group(s).
Statement 30. A method of making an oligoester or a polyester according to Statement 28 or 29, wherein the formed oligoester or polyester of the first reaction mixture and/or the oligoester(s) or polyester(s) each comprising the protic end group(s) of the second reaction mixture each comprise(s) at least about 0.5 mol % to about 100 mol % of repeat units comprising one or more of the clickable group(s), based on the total moles of repeat units.
Statement 31. A method of making an oligoester or a polyester according to any one of Statements 28-30, wherein the first mixture reagents comprise from about 0.5 mol % to about 100 mol % of the clickable group-functionalized dicarboxylic acid(s), diol(s), and/or polyol(s), based on the total molar amounts of the first mixture reagents; and/or wherein the second mixture reagents, excluding the oligoester(s) and/or polyester(s) each comprising the protic end group(s) and the ring-opening copolymerization catalyst(s), comprise from about 0.5 mol % to about 100 mol % of the clickable group-functionalized cyclic anhydride(s) and/or cyclic ether(s), based on the total amounts of the second mixture reagents, excluding the oligoester(s) and/or polyester(s) and the ring-opening copolymerization catalyst(s).

Statement 32. A method of making an oligoester or a polyester according to any one of Statements 28-31, wherein the second mixture reagents comprise: from about 0.1 mol % to about 5 mol % of the ring opening copolymerization catalyst(s), based on the total molar amounts of the second mixture reagents; and/or from about 40 wt. % to about 90 wt. % of the oligoester(s) or polyester(s), based on the total weight of the second mixture reagents.

Statement 33. A method of making an oligoester or a polyester according to any one of Statements 28-32, wherein: the dicarboxylic acid(s) is/are chosen from aliphatic dicarboxylic acid(s), aromatic dicarboxylic acid(s), polyether dicarboxylic acid(s), and the like, and any combination thereof; the dicarboxylic acid(s) comprising one or more clickable group(s) is/are chosen from clickable group-functionalized aliphatic dicarboxylic acid(s), clickable group-functionalized aromatic dicarboxylic acid(s), clickable group-functionalized polyether dicarboxylic acid(s), and the like, and any combination thereof; the diol(s) is/are chosen from aliphatic diol(s), aromatic diol(s), polyether diol(s), and the like, and any combination thereof; the diol(s) comprising one or more clickable group(s) is/are chosen from clickable group-functionalized aliphatic diol(s), clickable group-functionalized aromatic diol(s), clickable group-functionalized polyether diol(s), and the like, and any combination thereof, the polyol(s) is/are chosen from aliphatic polyol(s), aromatic polyol(s), polyether polyol(s), and the like, and any combination thereof; the polyol(s) comprising one or more clickable group(s) is/are chosen from clickable group-functionalized aliphatic polyol(s), clickable group-functionalized aromatic polyol(s), clickable group-functionalized polyether polyol(s), and the like, and any combination thereof; the cyclic anhydride(s) is/are chosen from aliphatic cyclic anhydride(s), aromatic cyclic anhydride(s), polyether cyclic anhydride(s), and the like, and any combination thereof; the cyclic anhydride(s) comprising one or more clickable group(s) is/are chosen from clickable group-functionalized aliphatic cyclic anhydride(s), clickable group-functionalized aromatic cyclic anhydride(s), clickable group-functionalized polyether cyclic anhydride(s), and the like, and any combination thereof; the cyclic ether(s) is/are chosen from aliphatic cyclic ether(s), aromatic cyclic ether(s), polyether cyclic ether(s), and the like, and any combination thereof, the cyclic ether(s) comprising one or more clickable group(s) is/are chosen from clickable group-functionalized aliphatic cyclic ether(s), clickable group-functionalized aromatic cyclic ether(s), clickable-group polyether cyclic ether(s), and the like, and any combination thereof; the ring opening copolymerization catalyst(s) is/are chosen from Lewis acid-Lewis base catalyst pair(s), covalently-tethered Lewis acid-Lewis base catalyst(s), and the like, and any combination thereof; or the like, or any combination thereof.
Statement 34. A method of making an oligoester or a polyester according to any one of Statements 28-33, wherein: the dicarboxylic acid(s) is/are chosen from succinic acid, diglycolic acid, glutaric acid, adipic acid, tartaric acid, pimelic acid, suberic acid, azelaic acid, sebacic acid, malic acid, ketoglutaric acid, phthalic acid, terephthalic acid, analog(s) and derivative(s) thereof, and the like, and any combination thereof, the dicarboxylic acid(s) comprising one or more clickable group(s) is/are chosen from clickable-group functionalized analog(s) and derivative(s) of succinic acid, diglycolic acid, glutaric acid, adipic acid, tartaric acid, pimelic acid, suberic acid, azelaic acid, sebacic acid, malic acid, ketoglutaric acid, phthalic acid, terephthalic acid, and the like, and any combination thereof, norbornene-endo-2,3-dicarboxylic acid, cis-4-cyclohexene-1,2-dicarboxylic acid, itaconic acid, maleic acid, fumaric acid, clickable group-functionalized analog(s) and derivative(s) thereof, and the like, and any combination thereof; the diol(s) is/are chosen from propanediol, propylene glycol, 1,4-butanediol, 1,6-hexanediol, 1,8-octanediol, 1,10-decanediol, catechol, hydroquinone, analog(s) and derivative(s) thereof, and the like, and any combination thereof; the diol(s) comprising one or more clickable group(s) is/are chosen from clickable-group functionalized analog(s) and derivative(s) of propanediol, propylene glycol, 1,4-butanediol, 1,6-hexanediol, 1,8-octanediol, 1,10-decanediol, catechol, hydroquinone, and the like, and any combination thereof; the polyol(s) is/are chosen from glycerol, serinol, polyether diol, analog(s) and derivative(s) thereof, and the like, and any combination thereof; the polyol(s) comprising one or more clickable group(s) is/are chosen from clickable-group functionalized analog(s) and derivative(s) of glycerol, serinol, polyether diol, and the like, and any combination thereof; the cyclic anhydride(s) is/are chosen from succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, analog(s) and derivative(s) thereof, and the like, and any combination thereof; the cyclic anhydride(s) comprising one or more clickable group(s) is/are chosen from clickable-group functionalized analog(s) and derivative(s) of succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, and the like, and any combination thereof, cis-5-norbornene-endo-2,3-dicarboxylic anhydride, cis-4-cyclohexene-1,2-dicarboxylic anhydride, maleic anhydride, itaconic anhydride, fumaric anhydride, clickable group-functionalized analog(s) and derivative(s) thereof, and the like, and any combination thereof; the cyclic ether(s) is/are chosen from propylene oxide, butylene oxide, epichlorohydrin, glycidyl ether, analog(s) and derivative(s) thereof, and the like, and any combination thereof; the cyclic ether(s) comprising one or more clickable group(s) is/are chosen from clickable group-functionalized analog(s) and derivative(s) of propylene oxide, butylene oxide, epichlorohydrin, glycidyl ether, and the like, and any combination thereof, allyl glycidyl ether, clickable group-functionalized analog(s) and derivative(s) thereof, and the like, and any combination thereof; the ring opening copolymerization catalyst(s) is/are chosen from boron-based Lewis acid-Lewis base catalyst pair(s); and the like, and any combination thereof.
Statement 35. A material according to any one of Statements 16-18, wherein the material is biocompatible and/or biodegradable.

Statement 36. A method of forming an object according to Statement 21, wherein the composition(s) comprise one or more solvent(s) each capable of crosslinking during the heating and/or the irradiating with electromagnetic radiation of the composition(s).

Statement 37. A method of forming an object according to Statement 21 or 36, wherein from about 10% to about 100% of the clickable groups are reacted to form the plurality of crosslinking thioether groups.

The steps of the methods described in the various examples disclosed herein are sufficient to carry out a method of the present disclosure. Thus, in various examples, a method consists essentially of a combination of the steps of the methods disclosed herein. In various other examples, a method consists of such steps.

The following examples are presented to illustrate the present disclosure. They are not intended to be limiting in any matter.

### EXAMPLE 1

This example provides a description of crosslinkable and crosslinked oligoester(s) and polyester(s) of the present disclosure, and methods of making and uses thereof.

To develop a more biocompatible photo-crosslinkable resin (e.g., for light-based 3D printing for biomedical applications), a polyester was designed that utilizes thiol-yne crosslinking chemistry with higher oxygen tolerance than MAA-based resins. An alkyne-functionalized elastomer derived from sebacic acid, 1,3-propanediol and alkyne-functionalized serinol was synthesized via melt condensation. The alkyne-functionalized polymer was crosslinked by dithiols at a lower density than multifunctional thiols to yield a softer material. A low power UV lamp (5 mW) triggered the crosslinking rapidly via thiol-yne click chemistry. The crosslinking behavior was studied by photorheology and NMR spectroscopy. The resultant elastomer possessed mechanical properties similar to those of human soft tissues, as well as exhibits partial degradation in basic solution in vitro and good cytocompatiblity in vitro.

Materials and Methods. General Experimental. All reagents were acquired commercially and used as received. Flash chromatography was performed on a Biotage Isolera using a Biotage SNAP Ultra silica gel column. TLC was performed on silica gel 60 F254 plates. NMR spectra were recorded on a Bruker 500 MHz instrument.

Synthesis of alkyne-functionalized serinol monomer. Equimolar amount of serinol (1 mmol) and methyl 5-hexynonate (1 mmol) were added into a round bottom flask. The mixture was stirred under nitrogen for 25 hr. The crude oil was recrystallized from ethyl acetate and then purified via flash chromatography (ethyl acetate/methanol) to yield a fluffy white solid (50% yield).

Synthesis of Poly (alkyne-serinol)-ran-Propanediol-co-Sebacate (PAPS). Sebacic acid (100 mol %) and 1,3-propanediol (100-x mol %) were added into a three-neck round bottom flask, which was then outfitted with a gas adapter and a condenser equipped with a receiving flask. The mixture formed a melt at 135° C. was stirred at 135° C. under nitrogen gas for 24 hours and then under vacuum for 24 hours. x =10 mol % or 20 mol % alkyne-serinol monomer was then added along with 30 mL of acetone and the reaction was refluxed so all the sublimed low molecular weight species were rinsed back into the reaction mixture. Acetone was distilled off and the melt was then stirred at 135° C. under nitrogen for 24 hours and eventually under vacuum for 24 hours. Upon cooling, the mixture solidified and was used without purification.

Resin Preparation and Photocrosslinking. 600 mg of PAPS and 12 mg of diphenyl (2,4,6-trimethylbenzoyl) phosphine oxide (TPO) were dissolved in 1 mL of 1:1 EtOH/EtOAc with gentle heating. Calculated amount of 2,2′-(Ethylenedioxy) diethanethiol (dithiol) was then added via a pipette. The solution was then spread onto a mold of desired shape and cured under 5 mW 365 nm UV from 3 cm away for 10 minutes. The resulted slab was washed briefly with ethanol and solvents were evaporated first in air then under vacuum for few days.

Material Characterization. Flash chromatography was performed on a Biotage Isolera using a Biotage SNAP Ultra silica gel column. TLC was performed on silica gel 60 F254 plates. NMR spectra were recorded on a Bruker 500 MHz instrument. NMR spectra were recorded on a Bruker AV III HD (1H, 500 MHz) spectrometer with a broad band Prodigy cryoprobe or Varian IVarian INOVA 400 (1H, 400 MHZ) spectrometer. CDCl₃ was used as NMR solvents unless noted otherwise. MALDI-TOF-MS analysis were performed on a Bruker AutoFlex Max MALDI-TOF Mass Spectrometer on reflectron mode. MALDI matrix was 2-[(2E)-3-(4-tert-Butylphenyl)-2-methylprop-2-enylidene] malononitrile (DCTB) and potassium trifluoroacetate (KTFA) was the ionizing agent. To prepare MALDI samples, 50 microliters of polymer solution (1 mg/mL in THF) was mixed with 100 microliters of KTFA solution (5 mg/mL in THF) and 400 microliters of DCTB solution (40 mg/mL in THF); this formula gave the best to signal to noise ratio. The sample solutions were then blotted to target plate with capillary tubes and allowed to air dry for 15 minutes prior to MALDI analysis. The resultant mass spectra were processed and analyzed with Bruker Autoflex. Gel permeation chromatography (GPC) was conducted using Malvern Panalytical OMNISEC GPC system (Malvern Instruments Ltd., UK) equipped with a refractive index detector and a column set of T6000M and T3000 with THE as the mobile phase (1 mL/min flowrate). The polymers were dissolved in HPLC grade THF at 5.0 mg/ml and filtered through a PTFE syringe filter. Number average molecular weights (Mₙ), weight average molecular weights (M_{w}), and PDI were determined according to polystyrene standards. Differential scanning calorimetry (DSC) was conducted on a TA Instruments Q1000 Modulated Differential Scanning calorimeter. Specifically, a heat/cool/heat cycle was conducted and Tg was measured on the final heating ramp. TGA was conducted with a TA Instruments Q500 Thermogravimetric Analyzer. Photorheology was conducted at room temperature on a TA Instruments DHR3 Rheometer equipped with a UV curing accessory. Geometry was 20 mm parallel plate, composed of a disposable aluminum upper plate and an acrylic lower plate. A 365 nm UV filter was used, and the power output was 30 mW. Tensile testing and cyclic testing were conducted on Instron 5943 equipped with 50 N loading cell and Bluehill Universal software. Tensile testing was conducted at room temperature; dog bone samples were cured in a custom mold and washed with 1:1 EtOH/EtOAc for two days, followed by drying in vacuum for 24 hours. Cyclic testing was conducted at 37° C., with a strain range of 0%-20% and a strain rate of 125 mm/min; untreated dog-bone shaped samples were cut out using a custom build die and incubated at 37° C. for one hour prior to cyclic testing.

Degradation Study. 20-30 mg of cured 20% PAPS (prepared using x =20 mol. % alkyne-serinol monomer) slabs of irregular shape (thickness 1.95-2.00 mm) were placed in 1.5 mL Eppendorf tubes, and each combined weight (PAPS sample+Eppendorf tube) was measured on an analytical balance. 1 mL of 60 mM NaOH solution was then added and the samples were incubated at room temperature for 4 hours, 1 day or 3 days, with gentle shaking on an orbital shaker. By the end of each time point, the samples were rinsed with water three times by pipetting up and down and lyophilized overnight. Mass remaining was calculated by subtracting the post-degradation dry weight from the pre-degradation dry weight.

Cytotoxicity Study. According to ISO 10993-2012 (E), PAPS strips were immersed in 70% ethanol for 24 hours under agitation then rinsed by sterile PBS 6 times before soaked in appropriate amount of endothelial cell growth medium. The PAPS extractions were obtained after soaking the PAPS strips in medium for 24 hours with agitation. The medium with no PAPS was served as control. The in vitro cytotoxicity assay was performed by adding extraction of PAPS to cultured human umbilical artery endothelial cells (HUAECs, 202-05N, Millipore Sigma) according to the manufacturer's instructions. HUAECs (passage 4) were sub-cultured using endothelial cell growth medium (EGM-2 BulletKit, CC-3156 &amp; CC-4147, Lonza). The cells were harvested using trypsin/EDTA after reaching confluence and resuspended in medium to prepare a cell suspension of 5×103 cells per 150 μL for cell seeding. The cells were allowed to attach for 3 hours then the medium was replaced by 150 μL of PAPS extractions or control medium. The cells were incubated at 37° C. with 5% carbon dioxide. A Vybrant® MTT Cell Proliferation Assay Kit (Invitrogen, CA) was used to measure the cell metabolic activity of the HUAECs after incubation of 1, 2 and 3 days. The absorbance was recorded using a SpectraMax M3 microplate reader. At day 3, phase-contrast images were also taken on a Zeiss Axiovert 200 microscope equipped with a Dage 240 digital camera. All experiments were performed in quadruplicate.

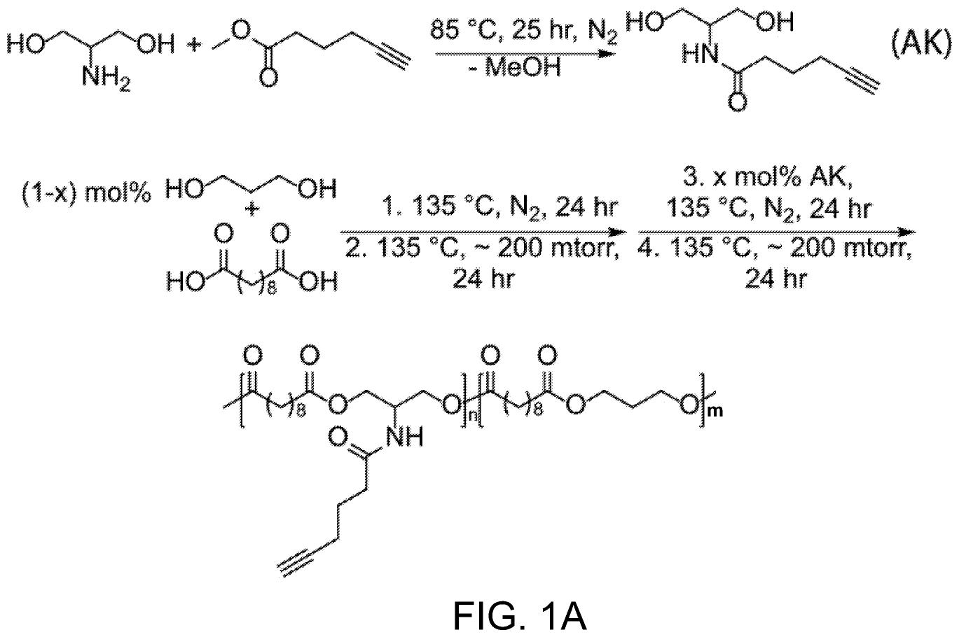

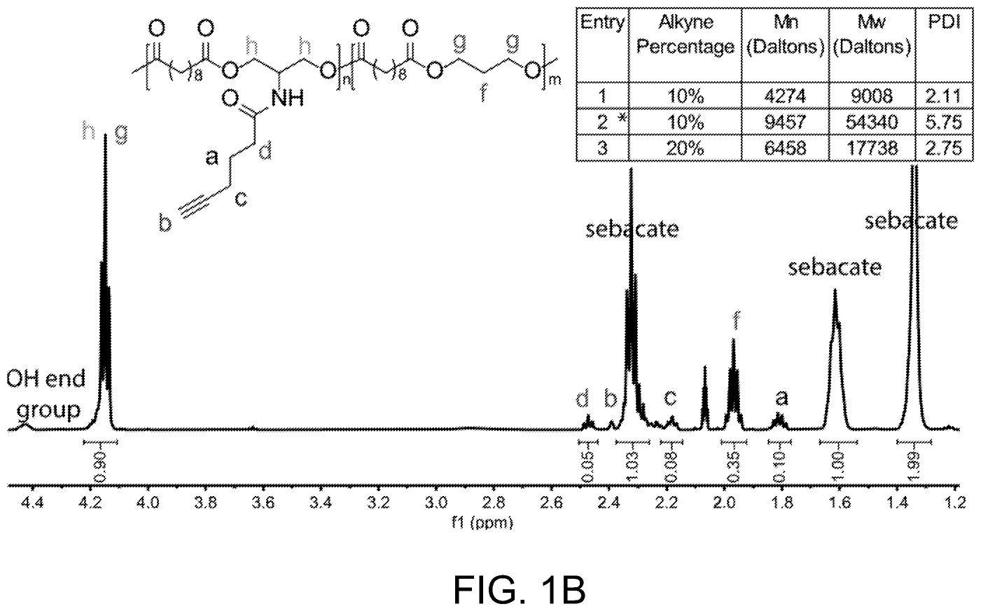

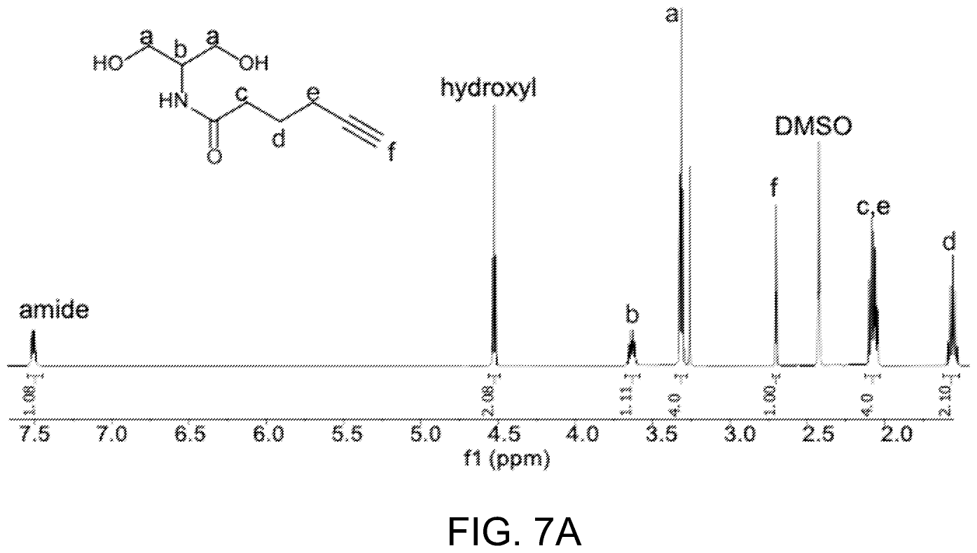

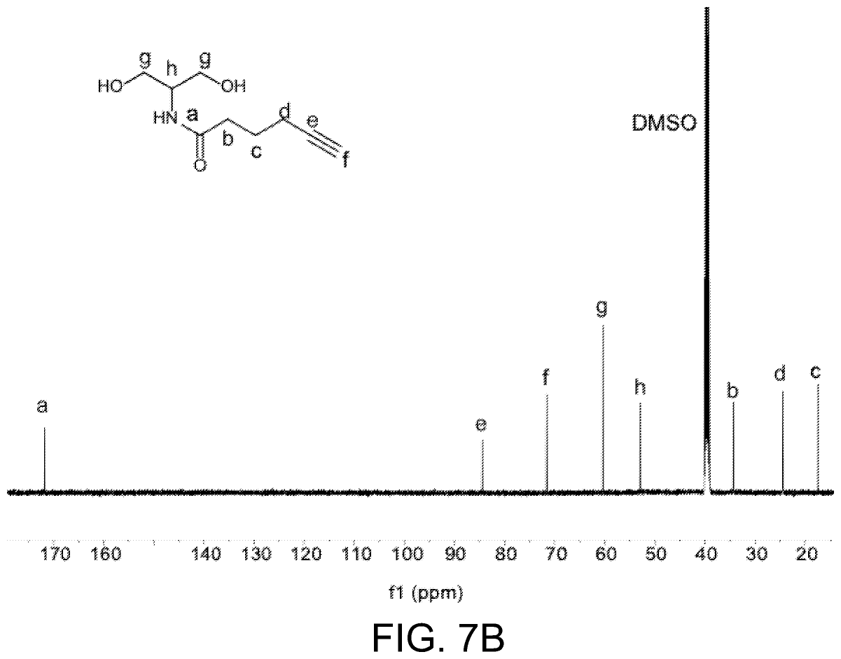

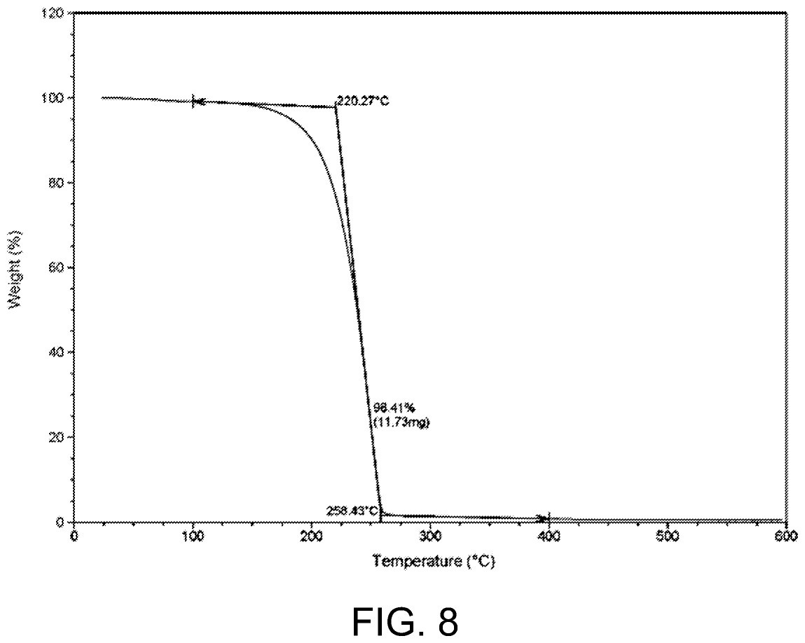

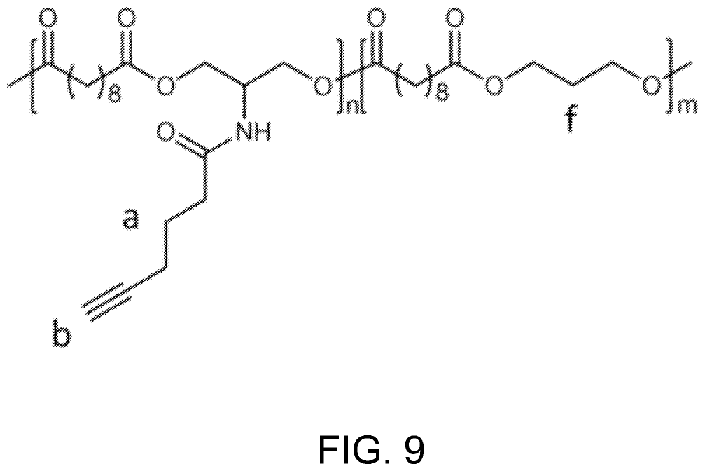

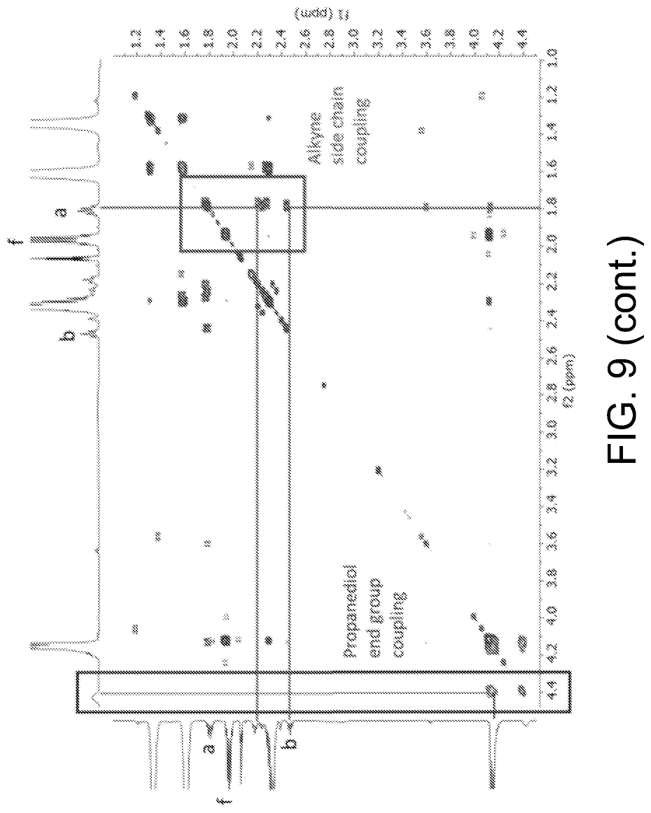

Results and discussion. Synthesis. To generate a soft elastomer, serinol was first reacted with methyl 5-hexynoate neat to generate an alkyne-functionalized serinol derivative (FIGS. 1A-1B, FIG. 7). Despite longer reaction time, melt polycondensation is simple to set up, and it avoids toxic catalysts and coupling agents (FIG. 1A). The alkyne serinol monomers showed minimal degradation at 135° C. according to thermogravimetric analysis (TGA) (FIG. 8). A series of PAPS with 10 mol % or 20 mol % of alkyne-serinol groups were produced (FIG. 1B). Polymer structure and quantitative integration of alkynes were confirmed by 1H-NMR (FIG. 1b) and 1H-1H COSY (FIG. 9). Extending the reaction time not only increased the molecular weight (FIG. 1B, entry 2), which was unnecessary for crosslinking, but also increased the extent of side reactions such as transesterification, as evidenced by the significantly higher PDI (FIG. 1B, entry 2).

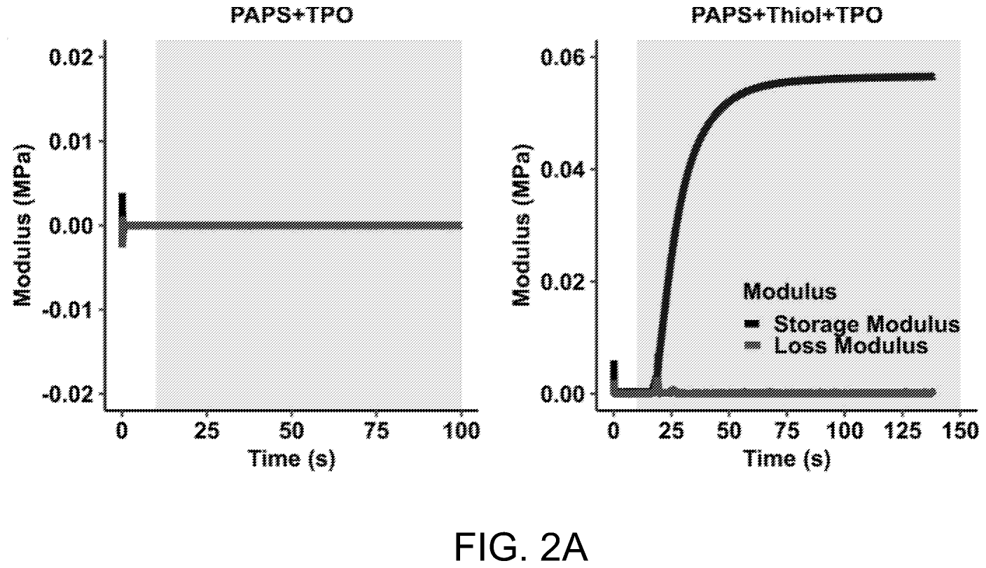

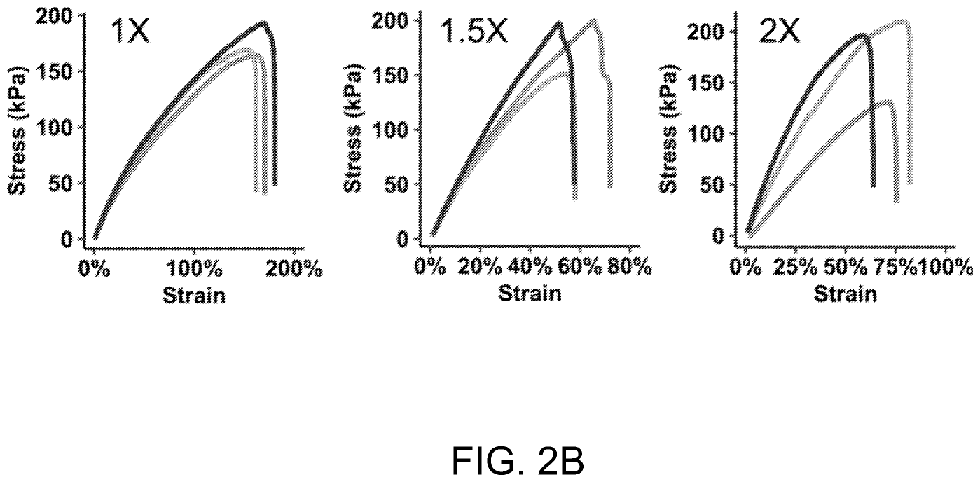

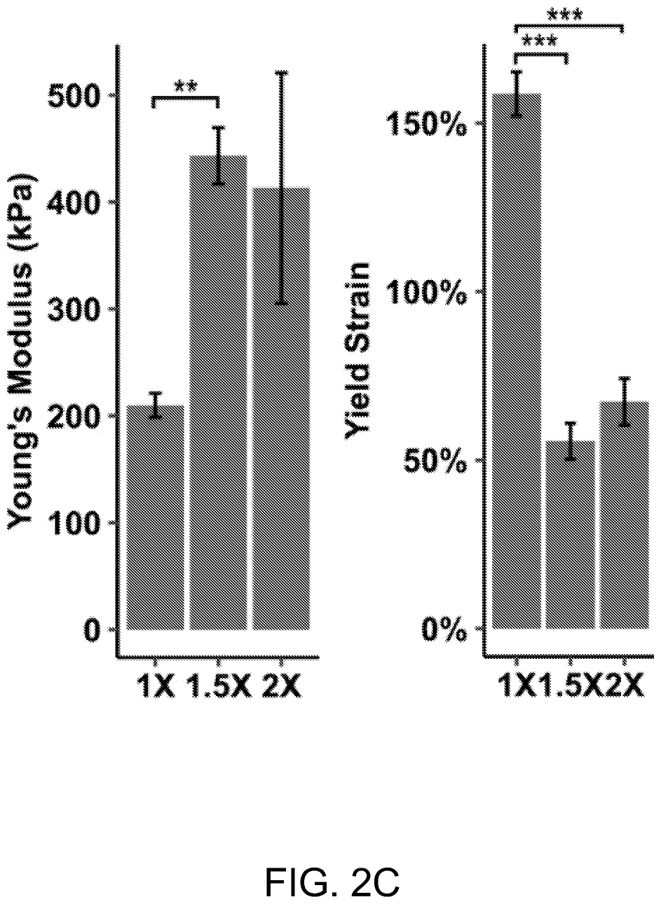

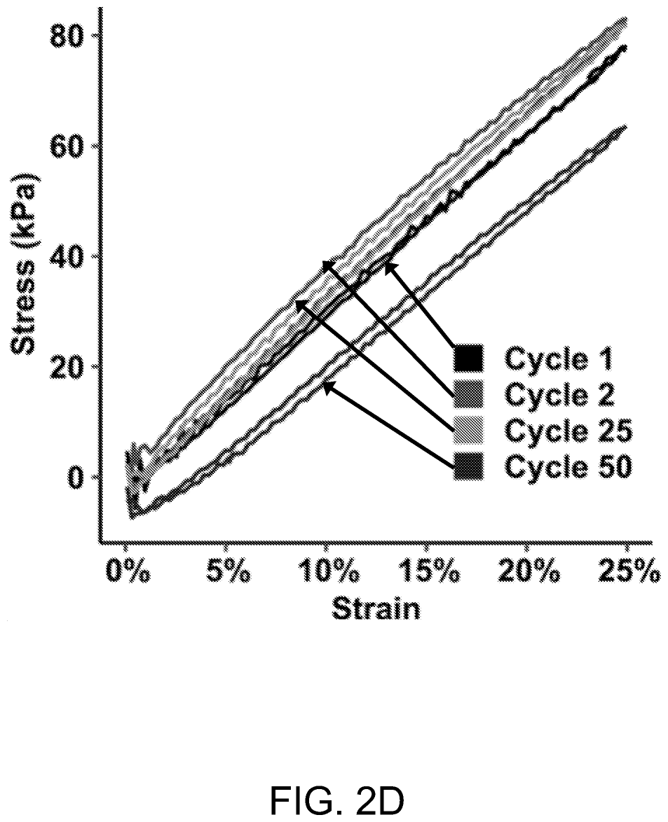

Material Properties. Compared to MAA-based crosslinking, thiol-yne crosslinking is less sensitive to oxygen, which allows more flexibility in material manufacturing, especially in 3D printing where materials are constantly exposed to atmospheric oxygen. PAPS-dithiol solutions showed fast crosslinking kinetics, as evidenced by the exponential increase of storage modulus of the reaction mixture (PAPS+Thiol+TPO) within seconds of UV exposure in photorheology study (FIGS. 2A-2D). In the absence of thiol crosslinkers, UV-generated radical species did not crosslink the mixture (FIG. 2A). Interestingly, prior to UV irradiation, PAPS-dithiol solutions' storage modulus was higher than loss modulus (FIG. 2A). It is possible that non-covalent interactions between PAPS and thiols transform the mixture into a Bingham fluid, which behaves like a plastic until a threshold shear stress is reached. Meanwhile, 10 mol % PAPS (Mₙ=4274 g/mol, PDI=2.11) failed to crosslink at the same condition, potentially due to a its lower molecular weight and lower percentage of alkyne groups.

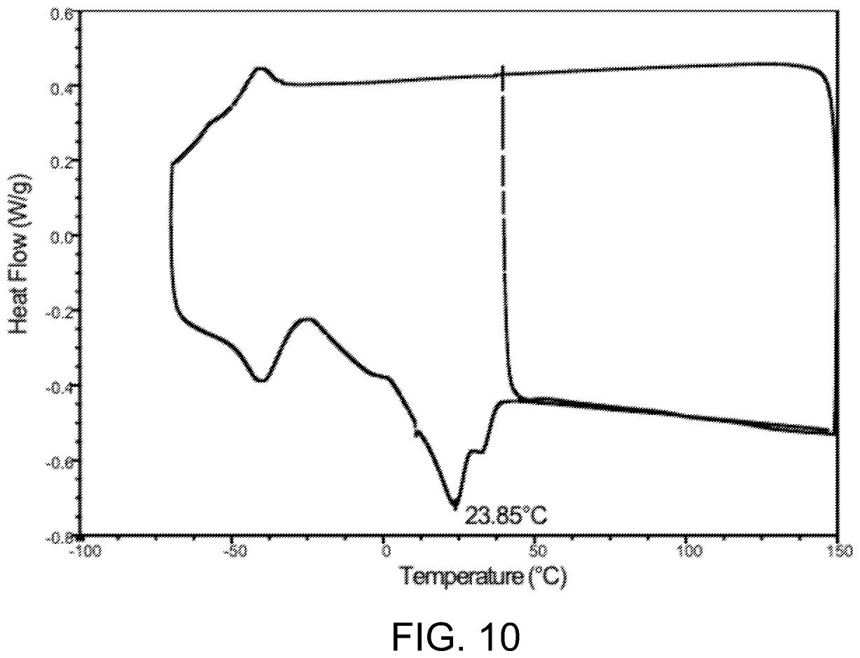

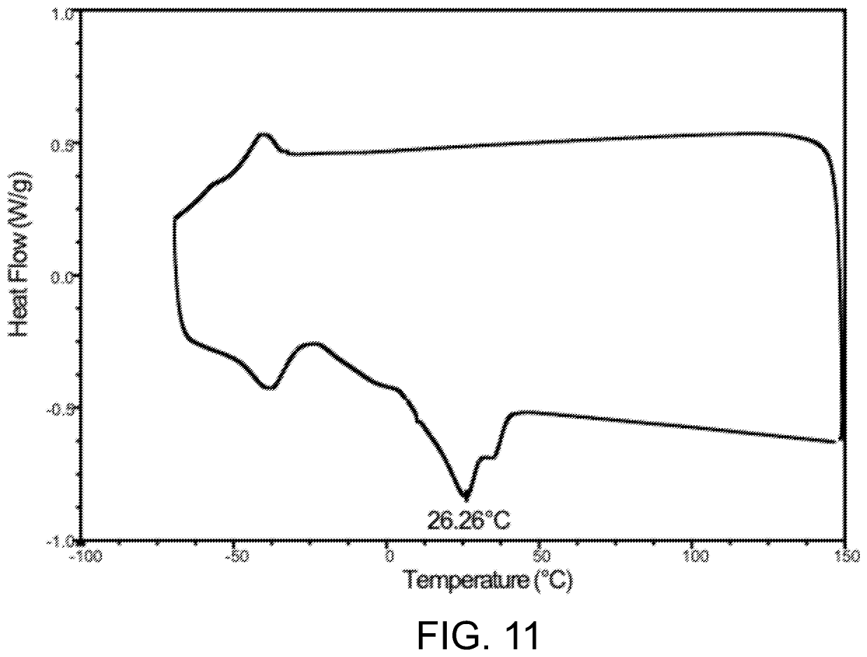

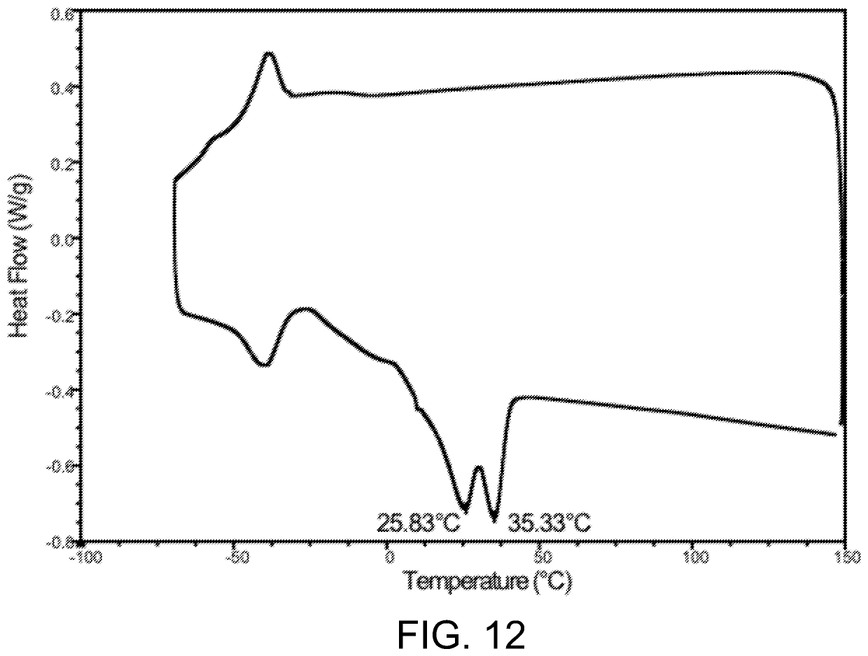

PAPS was crosslinked with different equivalents of dithiols; the crosslinked network displayed two distinctive T_{g}, both of which were slightly elevated at higher concentrations of dithiol crosslinkers (Table 1, FIGS. 10-12). The absence of Tm suggested the polymer was crosslinked into a thermoset, whose decreased chain mobility resulted in a higher T_{g}²·T_{g}¹ persisted across all four samples at roughly the same temperature. This was attributed to the sebacate-propanediol blocks in PAPS because they do not have any crosslinking point.

TABLE 1

| Thiol Eq | T_{c} (° C.) | T_{g}¹ (° C.) | T_{g}² (° C.) | Tₘ (° C.) | T_{d} (° C.) | E (kPa)^{c} |
|---|---|---|---|---|---|---|
| 0X^{a} | −11.7 | −41.5 | | 19.6, 37.6 | 271 | |
| 1X | | −41.5 | 4.83 | | 301 | 210 ± 7 |
| 1.5X | | −41.7 | 5.04 | | 300 | 480 ± 23 |
| 2X | | −44.2 | 5.71 | | 301 | 413 ± 67 |

^{a}Pure polymer without thiol addition;
^{b}Determined by thermogravimetric analysis at 5% mass loss;
^{c}Automatically determined by lnstron Bluehill Universal software from uniaxial elongation tensile testing.

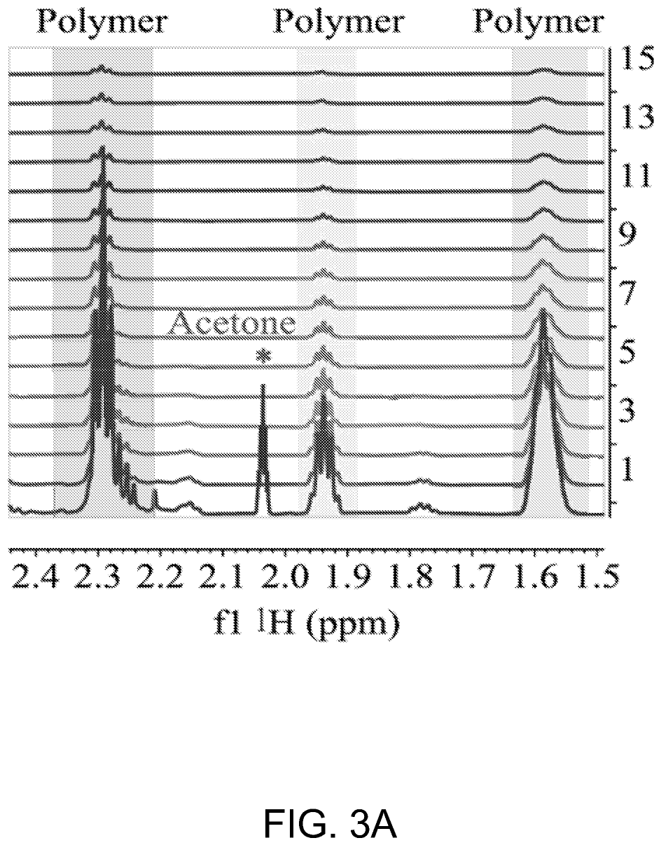

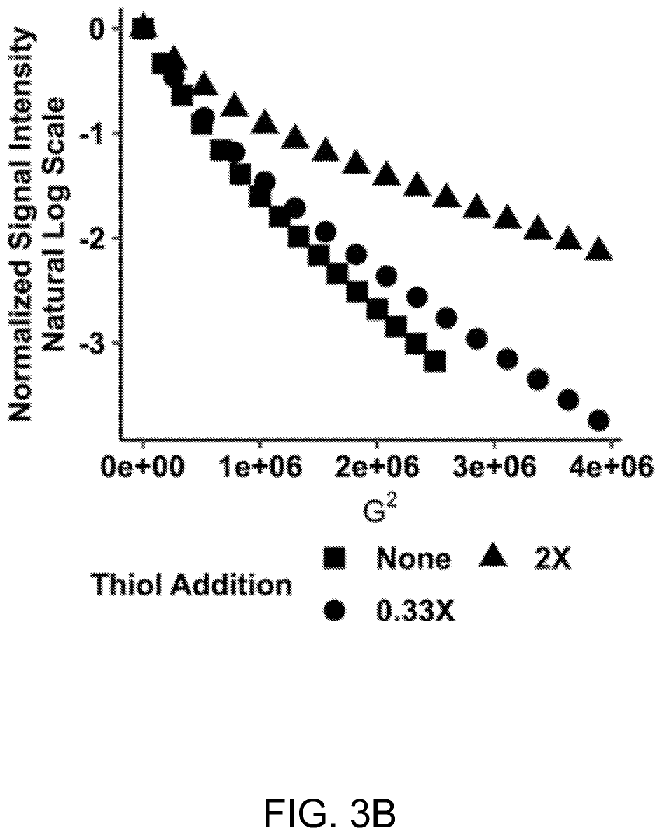

Tensile testing and cyclic testing suggested that cured 20 mol % PAPS was a soft elastomer and able to undergo cyclic loading with very small hysteresis (FIGS. 2B-2C). Increasing the crosslinker concentration from 1× to 1.5× increased Young's modulus of crosslinked PAPS from 210±7 kPa to 480±23 kPa. However, 2× crosslinker concentration did not further significantly increase the Young's modulus (413+67 kPa) (FIG. 2B). Higher crosslinker concentrations also noticeably decreased the ultimate strain (FIG. 2B). Furthermore, a diffusion NMR study of the reaction between 20 mol % PAPS and dithiol in solution revealed that diffusion coefficient of the resultant species inversely correlated to crosslinker concentration (FIGS. 3A-3B). Overall, a higher crosslinker concentration resulted in a higher crosslinking density.

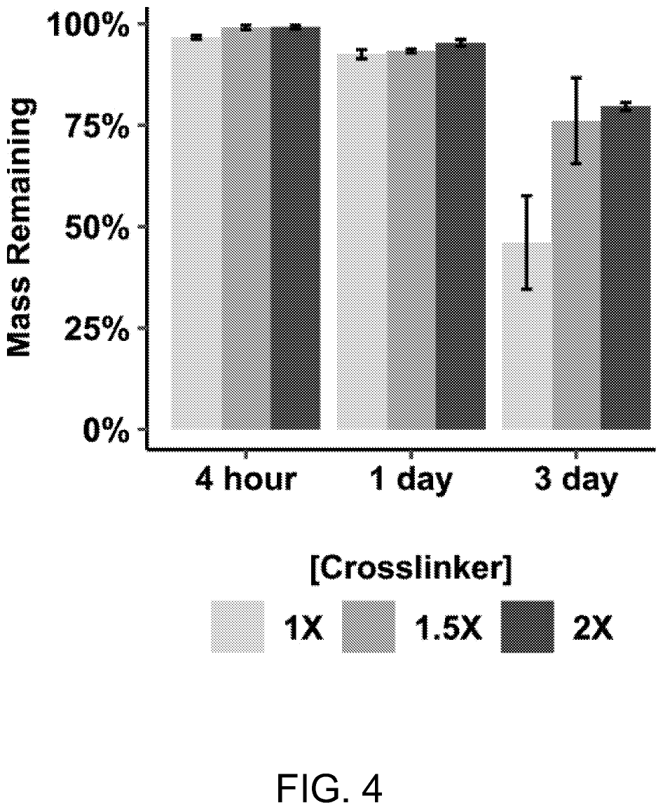

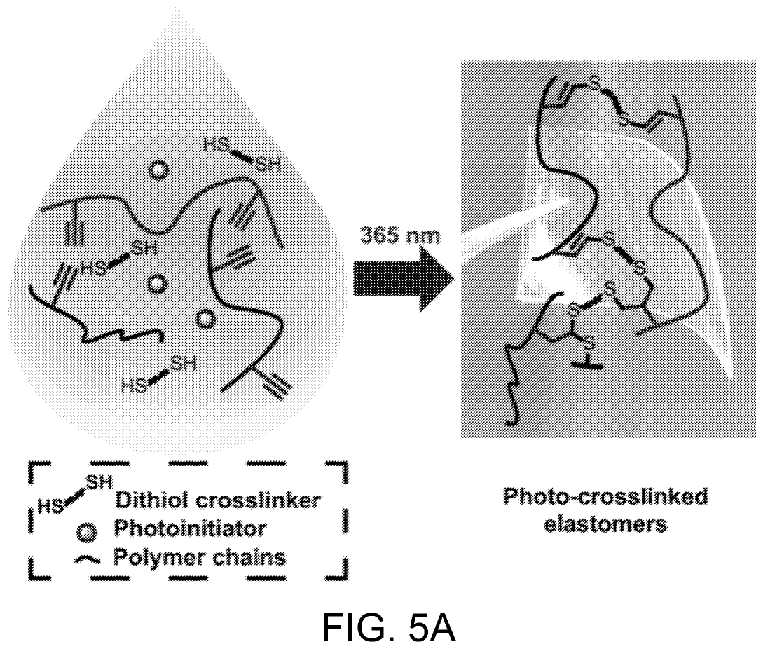

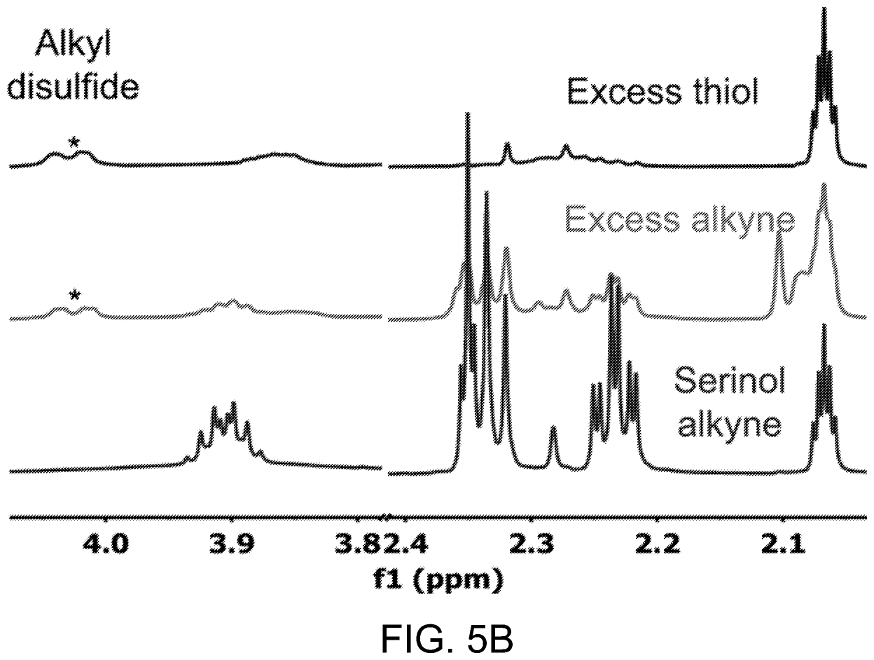

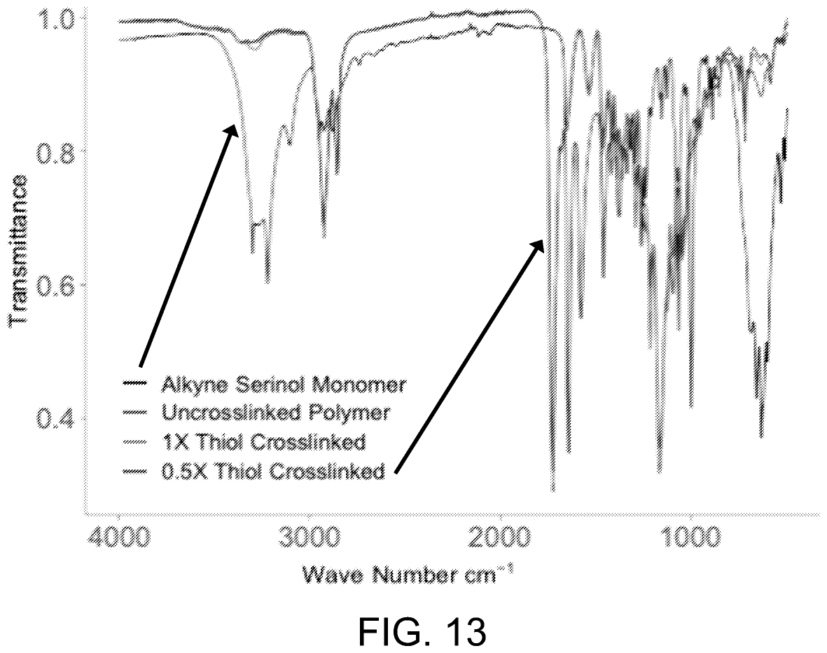

The degradation study showed that 1× PAPS degraded faster than 1.5× and 2× PAPS over a 3-day period (FIG. 4). As for the chemical nature of the crosslinking, literature suggests that one thiol adds to one alkyne first to generate vinyl sulfide, which subsequently reacts with another thiol to generate an alkyl disulfide. Therefore, two polymer chains can be crosslinked by allyl sulfides, alkyl disulfides, or a combination of both (FIG. 5A). NMR study of thiol-yne reaction between alkyne-serinol monomer and 2,2-(Ethylenedioxy) diethanethiol revealed the formation of alkyl disulfides (broad doublet, 4.01 ppm); vinyl sulfides did not form in a significant amount because new peaks were not observed to form at 4-6 ppm (FIG. 5B). Therefore, alkyl disulfides make up majority of the crosslinks, which agrees with a previous observation in the literature, where thiols preferentially add to vinyl sulfides than to alkynes. It was also attempted to investigate the chemical nature of crosslinking by FT-IR of crosslinked PAPS (FIG. 13). However, IR has low sensitivity to compositional changes so no significant change in bonding could be observed due to the low concentration of alkynes in the polymers.

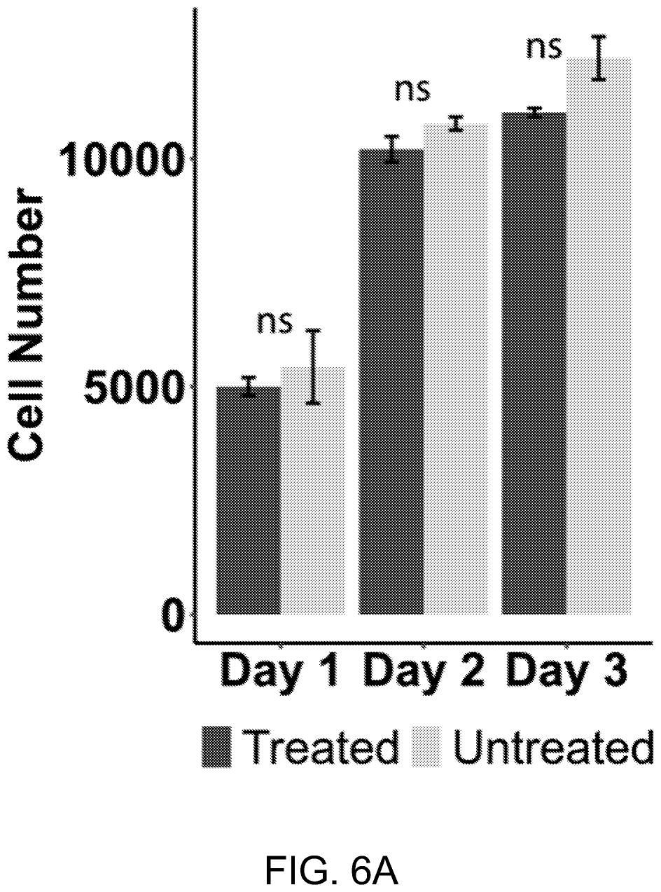

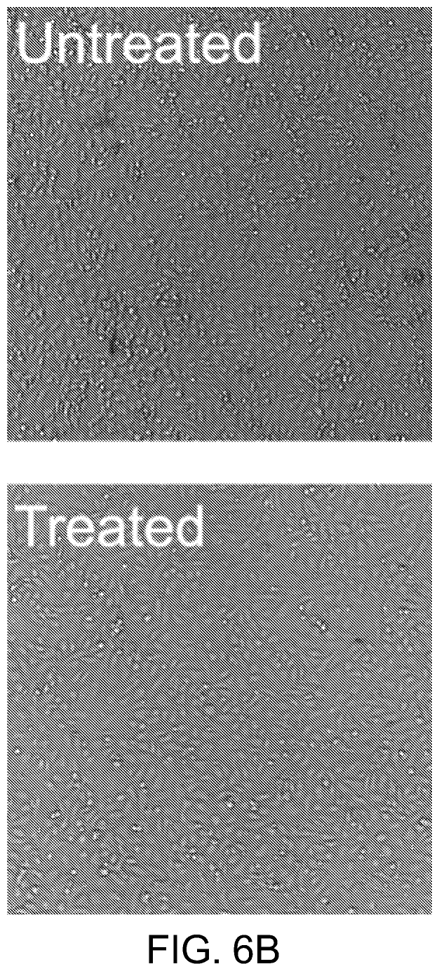

Lastly, the biocompatibility of extracts of crosslinked PAPS was examined using MTT assay. Human umbilical artery endothelial cells (HUAECs) were cultured in endothelial cell culture media containing extract of crosslinked 20 mol % PAPS. PAPS with the highest molar percentage of alkyne was chosen to evaluate if alkyne-functionalized serinol derivatives are toxic to human cells. HUAECs cultured in the polymer extract showed similar metabolic activity compared to those cultured in fresh cell media (FIG. 6A). According to the micrograph, HUAECs in the treated group did not undergo morphological change (FIG. 6B). Overall, the data suggested good cytocompatibility of PAPS.

Perspectives and Potential Applications. The fast crosslinking kinetic opens the possibility of using PAPS solution as a photo-polymerizable resin for DLP and other fabrication methods such as electrospinning. For DLP, alkyne-bearing photopolymerizable resins have shown good resolution and oxygen tolerance. Because of the step-growth mechanism, thiol-yne resins also demonstrate reduced shrinkage stress during crosslinking, which is typically important to the integrity of printed objects. Most of these precedents use multifunctional small molecule alkyne monomers, which necessitate high amount of thiol crosslinkers that are potentially cytotoxic and often foul smelling. In addition, the printed objects are stiff due to high crosslinking density, which precludes them from soft material applications. In contrast, a significantly lower concentration of thiols photo-crosslinked PAPS into a soft elastomer. As for electrospinning, the polymer must reach a threshold molecular weight to generate sufficient chain entanglement for fiber formation. Fiber morphology also depends on molecular weights: electrospun fibers of poly(vinyl alcohol) at 9,000-13,000 g/mol showed a bead-on-string structure, suggesting solvent jet instability; increasing the molecular weight to 31,000-50,000 g/mol yielded fibers without beads formation. High molecular weight additives, by acting as carriers, also promote the electrospinning of polymers with low molecular weight or low Tm, which are challenging to electrospin by themselves. For instance, PGS was co-electrospun with high molecular weight poly(vinyl alcohol), which were removed by water after PGS was cured into a thermoset, resulting in a thermoset PGS fiber. For PAPS, an in situ crosslinking during the fiber formation was deemed to offer sufficient chain entanglement. Previously, low molecular weight poly(propylene fumarate), with number average molecular weight (Mₙ) ranging from merely 400 g/mol to 2000 g/mol, successfully generated microfiber in this fashion.

Nevertheless, thiol-yne photocurable resins have their challenges. First, the resins can present synthetic challenges. MAA are commercially available as both anhydrides and acyl chlorides for easy modifications of materials with complex structures under mild conditions. In contrast, alkynylation often requires organolithium or Grignard reagents, transitional metal catalyzed crosscoupling reagents, and extremely hazardous reagents such as propargyl halide or propargyl alcohol that can perform nucleophilic substitution or esterification; these synthetic techniques are not amenable to generating biomedical materials where toxicity is a major concern. Although a transesterification-like reaction was used with a relatively benign alkyne substrate, its high cost might hinder downstream development and commercialization. Second, on the flip side of the rapid crosslinking kinetic is that thiol-yne resins are prone to spontaneous reactions, such as formation of radical species and base catalyzed nucleophilic addition of thiols to alkynes. Small molecule stabilizers inhibit the side reactions to some degrees, but they might reduce the biocompatibility. Compared to primary thiol crosslinkers, secondary thiol crosslinkers can significantly improve the shelf life due to the additional steric hindrance. In the present design, the concentration of thiols and alkynes was lowered by functionalizing the polymer with alkyne groups. It is expected that the reduced concentration of reactive groups, as well as the increased viscosity of resin mixture compared to small molecule resins, can limit the extent of side reactions. Third, melt polycondensation of PAPS is time consuming and incompatible with heat labile compounds, nor is it amenable to functional groups prone to thermocrosslinking. For instance, a fraction of 1,3-propanediol was replaced with glycerol to make a material that has elastomeric properties similar to those of PGS. However, the resulted polymers inevitably crosslinked during synthesis due to the presence of secondary OH groups (data not shown).

In conclusion, PAPS, an alkyne-functionalized biodegradable polyester, is easily synthesized via melt poly-condensation. PAPS resin shows facile crosslinking kinetic under UV suitable for applications such as electrospinning and DLP. Crosslinked PAPS is a degradable, soft elastomer and its mechanical properties approximate those of human soft tissues. The material is cytocompatible with endothelial cells.

### EXAMPLE 2

This example provides a description of crosslinkable and crosslinked oligoester(s) and polyester(s) of the present disclosure, and methods of making and uses thereof.

Although biomedical engineering commonly uses sebacate-derived polyesters (SPE) due to their accessibility, degradability, and biocompatibility, SPE are mostly generated by polycondensation with poor control over polymer architectures and properties. A metal free strategy avoids potential negative effects of metal-salen catalysts (toxicity, downstream side reactions, etc.) to increase copolyesters' cytocompatibility and applicability in additive manufacturing.

Lewis pair catalyzed ring opening copolymerization (ROCOP) and polycondensation—each with substrate scope unique to its own—each produces functional aliphatic polyesters that are inaccessible via the other method, but ROCOP falls shorts in term of scaled-up applications in material and engineering. An affordable metal-free Lewis catalyst pair and ROCOP's chain transfer activity was employed to chain extend poly(propylene sebacate)—synthesized via melt condensation, broadly distributed, and representative of many polyesters for biomedical applications—with ROCOP of cis-5-norbornene-endo-2,3-dicarboxylic anhydride (NB) and propylene oxide (PO), to produce ABA triblock copolyesters on a 30-gram scale with tunable molecular weights, narrow molecular weight distributions (Ð=1.24-1.54), and uniform end group functionalities. This enabled formulation of stable thiolene resins that were 3D printed into functional materials with good cytocompatibility, as well as optical transparency and mechanical properties approaching those of polydimethylsiloxane (PDMS), a polymer widely used for prototyping of microfluidic chips. We believe this polymerization strategy can expediate the discovery of new functional polyesters and therefore novel materials with superior properties.

In this work, the excellent properties of sebacate-derived polyesters are combined with the high degree of control of TEB-[PPN] Cl catalyzed ROCOP. A series of ABA triblock copolyesters, poly(NB-alt-PO)-PPS-poly(NB-alt-PO), were synthesized by PPS-initiated ROCOP of cis-5-norbornene-endo-2,3-dicarboxylic anhydride (NB) and propylene oxide (PO). ROCOP's living character working in synergy with reversible deactivation of growing anionic chains conferred by PPS acting as a chain transfer agent (CTA) produced polymers with low dispersity and defined OH chain ends from broadly distributed PPS with undefined chain ends. The PPS soft block decreased T_{g}s to below 37° C. and increased elasticity, while the NB-alt-PO hard block afforded high crosslinking density and increased mechanical strength. The metal-free strategy afforded a stable thiol-ene photoresin that was 3D-printed via digital light processing (DLP) into functional materials with good mechanical properties, cytocompatibility, and tood transparency. This work produced sebacate-derived polyesters possessing narrow MWD and well-defined microstructures from Lewis pair catalyzed ROCOP and successfully used these materials in additive manufacturing. It is envisioned that this metal-free strategy will extend to other polyesters traditionally generated by polycondensation to produce biocompatible functional materials with precisely controlled polymer architectures that are inaccessible by many biologically relevant diacid or diol monomers.

Materials, Methods, and General Considerations. All chemicals were purchased from commercial sources and used without purification unless noted otherwise. All polymerizations were set up in a nitrogen-filled glovebox, then taken outside to stir in a silicon oil bath, and finally quenched by adding a small amount of ethanol. Propylene oxide (PO) was stirred over calcium hydride for three day and then vacuum transferred to a Straus flask for long term storage in the glovebox. cis-5-Norbornene-endo-2,3-dicarboxylic anhydride was purified by vacuum sublimation at 70° C. Bis(triphenylphosphine) iminium chloride ([PPN] CI) was recrystallized by laying diethyl ether over a saturated solution of [PPN]Cl in dichloromethane (DCM).

NMR spectra were recorded on a Bruker AV III HD (1H, 500 MHZ) spectrometer with a broad band Prodigy cryoprobe or Varian IVarian INOVA 400 (1H, 400 MHz) spectrometer. CDC13 was used as NMR solvents unless noted otherwise. MALDI-TOF-MS analysis was performed on a Bruker AutoFlex Max MALDI-TOF Mass Spectrometer on reflectron mode. MALDI matrix was 2-[(2E)-3-(4-tert-Butylphenyl)-2-methylprop-2-enylidene] malononitrile (DCTB) and potassium trifluoroacetate (KTFA) was the ionizing agent. To prepare MALDI samples, 50 microliters of polymer solution (1 mg/mL in THF) was mixed with 100 microliters of KTFA solution (5 mg/mL in THF) and 400 microliters of DCTB solution (40 mg/mL in THF); this formula gave the best to signal to noise ratio. The sample solutions were then blotted to target plate with capillary tubes and allowed to air dry for 15 minutes prior to MALDI analysis. The resultant mass spectra were processed and analyzed with Bruker Autoflex. Gel permeation chromatography (GPC) was conducted using Malvern Panalytical OMNISEC GPC system (Malvern Instruments Ltd., Malvern, UK) via a refractive index detector and a column set of T6000 M and T3000 with THE as the mobile phase (1 mL/min flow rate). The polymers were dissolved in HPLC grade THF at 5.0 mg/mL and filtered through a PTFE syringe filter. Number average molecular weights (Mₙ), weight average molecular weights (M_{w}), and polydispersities (Ð)) were determined according to polystyrene standards. Differential scanning calorimetry (DSC) was conducted on a TA Instruments Q1000 Modulated Differential Scanning calorimeter. Specifically, a heat/cool/heat cycle was conducted and glass transition temperature (T_{g}) was measured on the final heating ramp. TGA was conducted with a TA Instruments Q500 Thermogravimetric Analyzer to determine glass transition temperatures (T_{g}), melting temperatures (Tₘ), and crystallization temperatures (T_{c}). Photorheology was conducted at room temperature on a TA Instruments DHR3 Rheometer equipped with a UV curing accessory; the geometry was 20 mm parallel plate, composed of a disposable aluminum upper plate and an acrylic lower plate. A 365 nm UV filter was used, and the power output was 30 mW. Tensile testing and cyclic testing were conducted at room temperature on Instron 5943 equipped with 50 N loading cell and Bluehill Universal software.

Cytotoxicity study was conducted according to ISO 10993-2012 (E). Cured polymer samples were immersed in 70% ethanol for 24 hour (h) under agitation and then rinsed by sterile PBS six times before being soaked in an appropriate amount of endothelial cell growth medium. The PAPS extractions were obtained after soaking the PAPS strips in medium for 24 h with agitation. The medium with no PAPS served as control. The in vitro cytotoxicity assay was performed by adding extraction of PAPS to cultured human umbilical artery endothelial cells (HUAECs, 202-05N, Millipore Sigma) according to the manufacturer's instructions. HUAECs (passage 4) were subcultured using endothelial cell growth medium (EGM-2 BulletKit, CC-3156 CC-4147, Lonza). The cells were harvested using trypsin/EDTA after reaching confluence and resuspended in medium to prepare a cell suspension of 10,000cells per 150 μL for cell seeding. The cells were allowed to attach for 3 h, then the medium was replaced by 150 μL of PAPS extractions or control medium. The cells were incubated at 37° C. with 5% carbon dioxide. A Vybrant MTT Cell Proliferation Assay Kit (Invitrogen, Carlsbad, CA) was used to measure the cell metabolic activity of the HUAECs after an incubation of one and two days. The absorbance was recorded using a SpectraMax M3 microplate reader. All experiments were performed in quadruplicate.

3D Printing was conducted on an Asiga Max X27 UV printer. To make the resins, crude polymerization mixtures were mixed with reactive diluents (limonene), followed by removal of in vacuum. Thiol crosslinkers, reactive diluents, butylated hydroxytoluene, and diphenyl (2,4,6-trimethylbenzoyl) phosphine oxide were then added so that thiol and ene were equivalent.

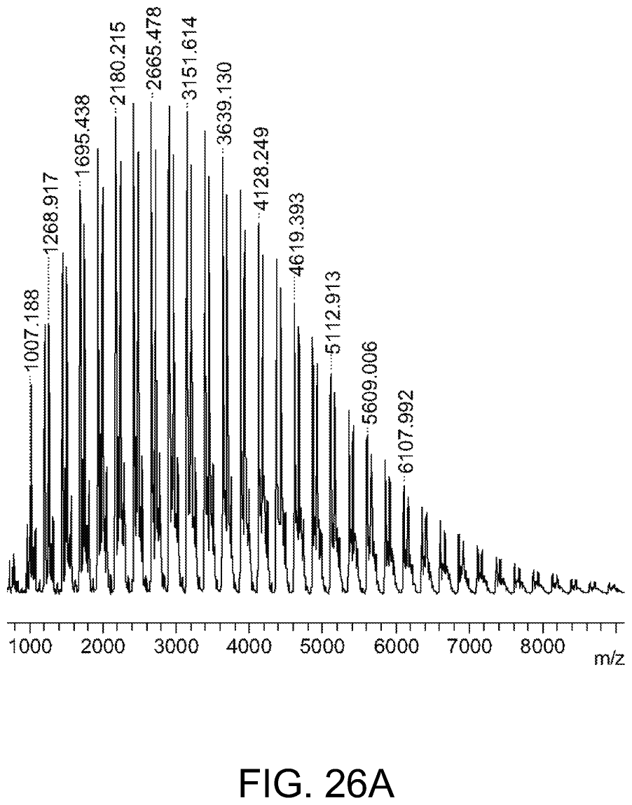

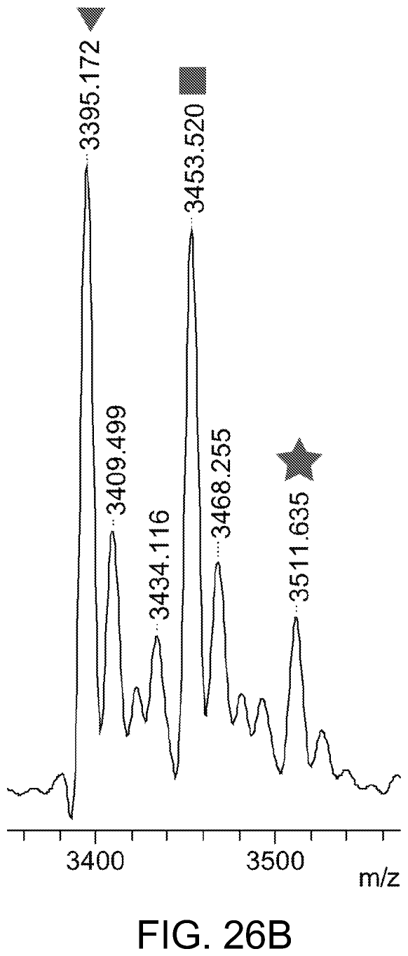

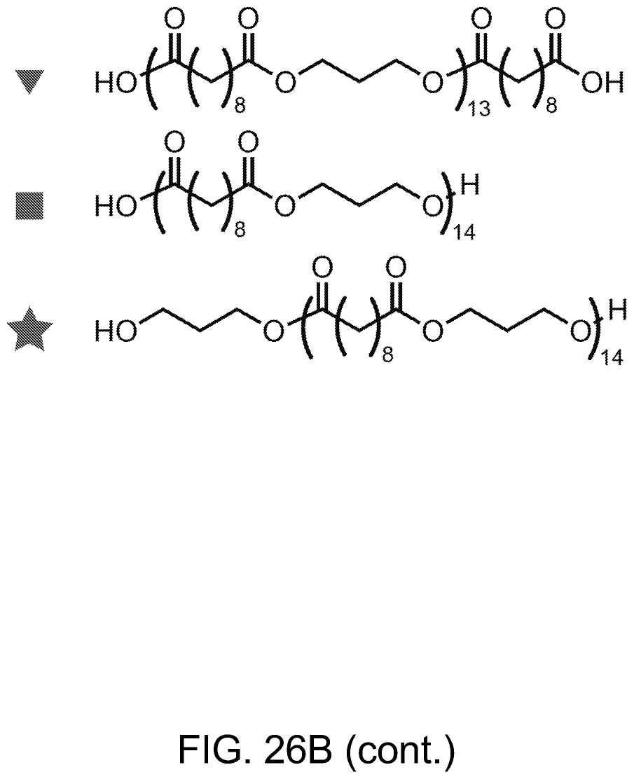

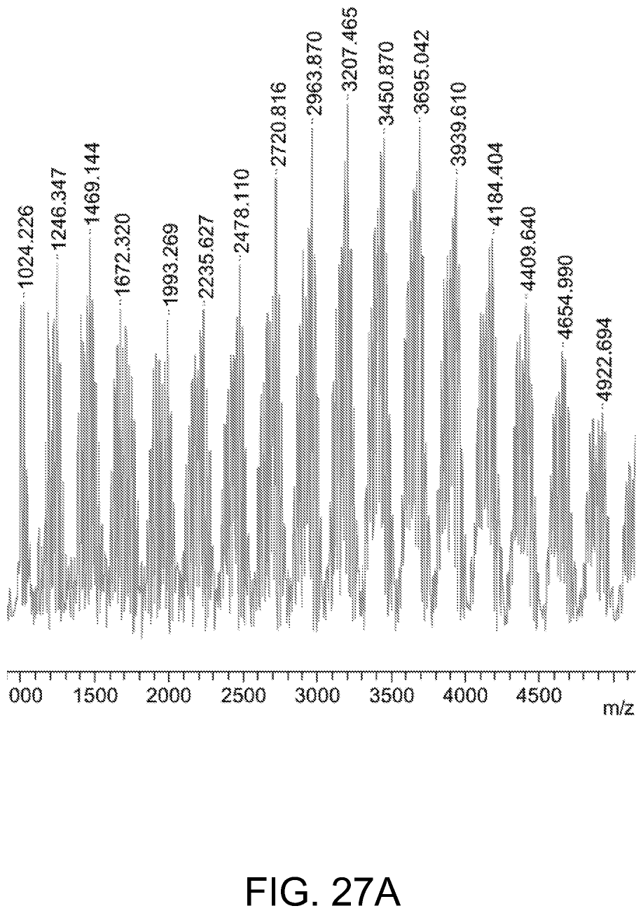

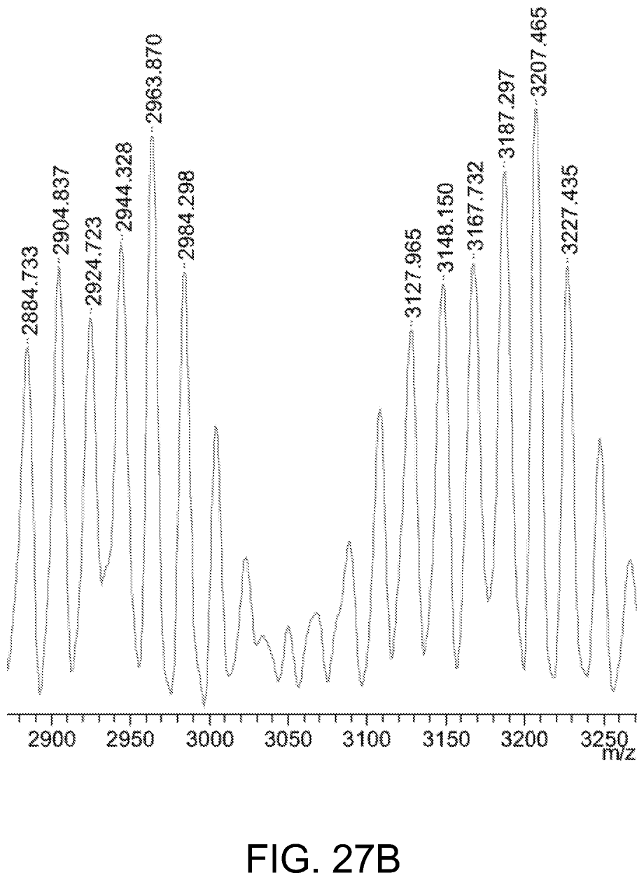

Because MALDI showed PPS contained polymers with different end groups (FIGS. 26A-26B) and that NBPO_{PPSx} contained a distribution of peaks separated by 20 m/z in each cluster (FIGS. 27A-27B), it was hypothesized that each mass peak can arise from copolymer chains with either COOH or OH end groups and the analysis was further complicated by the possible combinations of different NBPO and PPS chain length that could yield identical mass values. For analysis, the mass of PPS block was first back-calculated via equation 1:

$${M}_{PPS} = {M}_{Observed} - {M}_{K +} - 222 \text{.23} n - ( end group correction ) . \qquad [ l ]$$

All possible combinations of chain ends and chain lengths of blocks were tabulated in Table 2 (m/z=2417.312) and Table 3 (m/z=2437.509); the header represents identities of end groups of

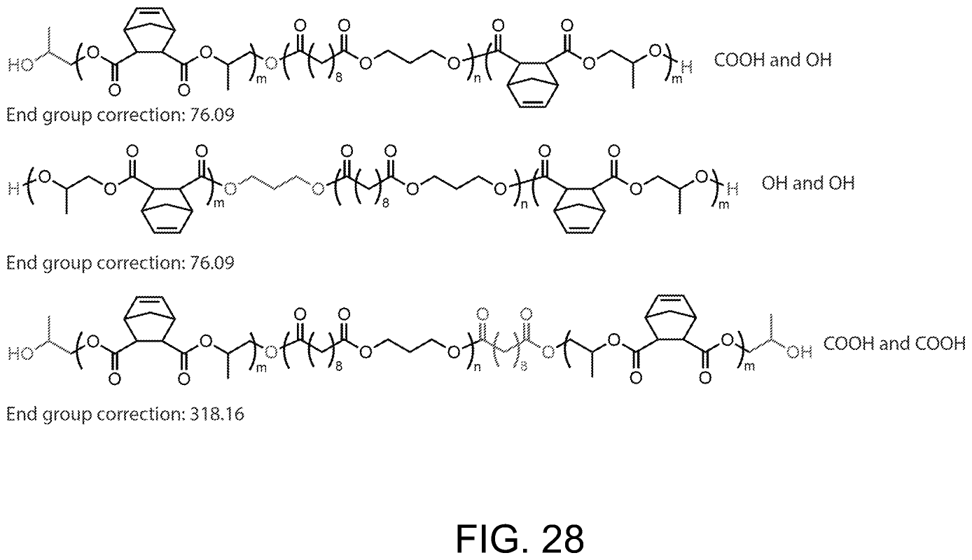

PPS. All block copolyester chains were assumed to be terminated with 2-propanol because PO was in excess. End group corrections are summarized in FIG. 28. Because the number of PPS repeating units have to be integers, calculated values were selected that were within 0.5% of the closest integer as the probable number of PPS repeating units (in bold). The corresponding number of NBPO repeating units can be found on the same row.

TABLE 2

| | | Calculated Mass | | | Calculated Number | | |
|---|---|---|---|---|---|---|---|
| | | of PPS Block | | | of PPS Repeating Units | | |
| # NBPO | | OH | OH | COOH | OH | OH | COOH |
| Repeating | | and | and | and | and | and | and |
| Units | Mass | COOH | OH | COOH | COOH | OH | COOH |
| 1 | 222.23 | 2078.892 | 2079.892 | 1837.822 | 8.587 | 8.591 | 7.591 |
| 2 | 444.46 | 1856.662 | 1857.662 | 1615.592 | 7.669 | 7.673 | 6.674 |
| 3 | 666.69 | 1634.432 | 1635.432 | 1393.362 | 6.751 | 6.755 | 5.756 |
| 4 | 888.92 | 1412.202 | 1413.202 | 1171.132 | 5.833 | 5.838 | 4.838 |
| 5 | 1111.15 | 1189.972 | 1190.972 | 948.902 | 4.915 | 4.920 | 3.920 |
| 6 | 1333.38 | 967.742 | 968.742 | 726.672 | 3.997 | 4.002 | 3.002 |
| 7 | 1555.61 | 745.512 | 746.512 | 504.442 | 3.080 | 3.084 | 2.084 |
| 8 | 1777.84 | 523.282 | 524.282 | 282.212 | 2.162 | 2.166 | 1.166 |

TABLE 3

| | | Calculated Mass | | | Calculated Number | | |
|---|---|---|---|---|---|---|---|
| | | of PPS Block | | | of PPS Repeating Units | | |
| # NBPO | | OH | OH | COOH | OH | OH | COOH |
| Repeating | | and | and | and | and | and | and |
| Units | Mass | COOH | OH | COOH | COOH | OH | COOH |
| 1 | 222.23 | 2100.099 | 2100.089 | 1858.019 | 8.675 | 8.675 | 7.675 |
| 2 | 444.46 | 1877.869 | 1877.859 | 1635.789 | 7.757 | 7.757 | 6.757 |
| 3 | 666.69 | 1655.639 | 1655.629 | 1413.559 | 6.839 | 6.839 | 5.839 |
| 4 | 888.92 | 1433.409 | 1433.399 | 1191.329 | 5.921 | 5.921 | 4.921 |
| 5 | 1111.15 | 1211.179 | 1211.169 | 969.099 | 5.003 | 5.003 | 4.003 |
| 6 | 1333.38 | 988.949 | 988.939 | 746.869 | 4.085 | 4.085 | 3.085 |
| 7 | 1555.61 | 766.719 | 766.709 | 524.639 | 3.167 | 3.167 | 2.167 |
| 8 | 1777.84 | 544.489 | 544.479 | 302.409 | 2.249 | 2.249 | 1.249 |

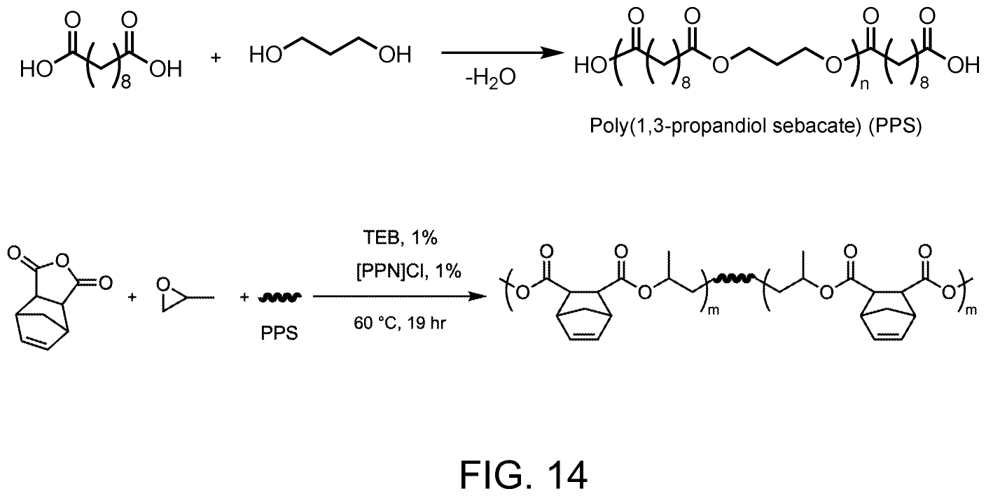

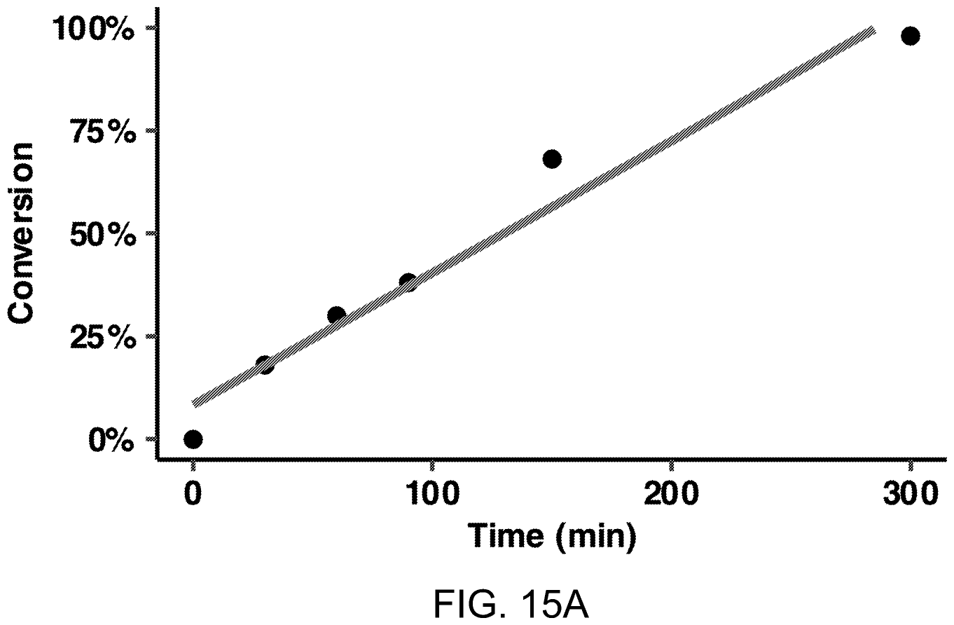

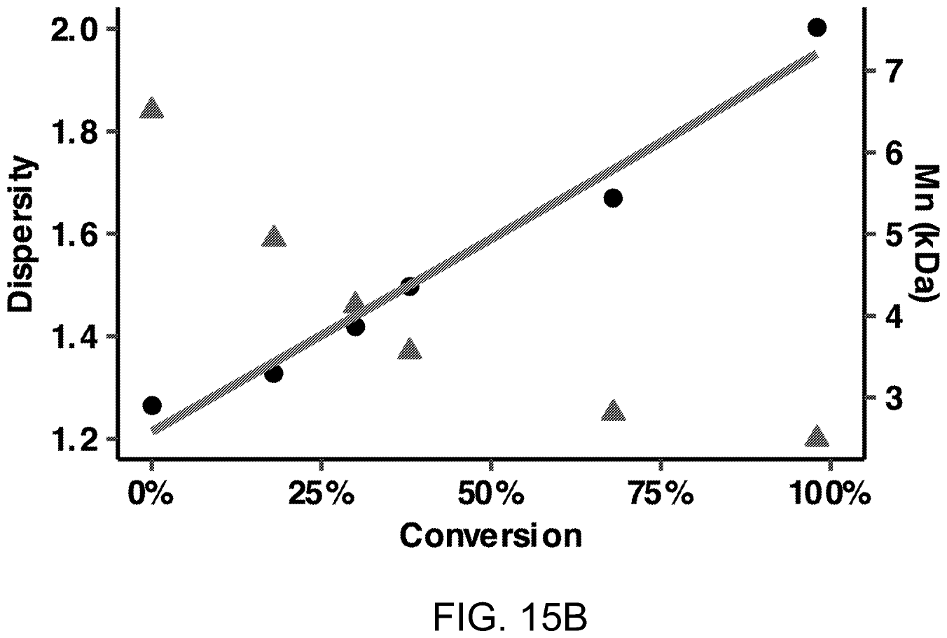

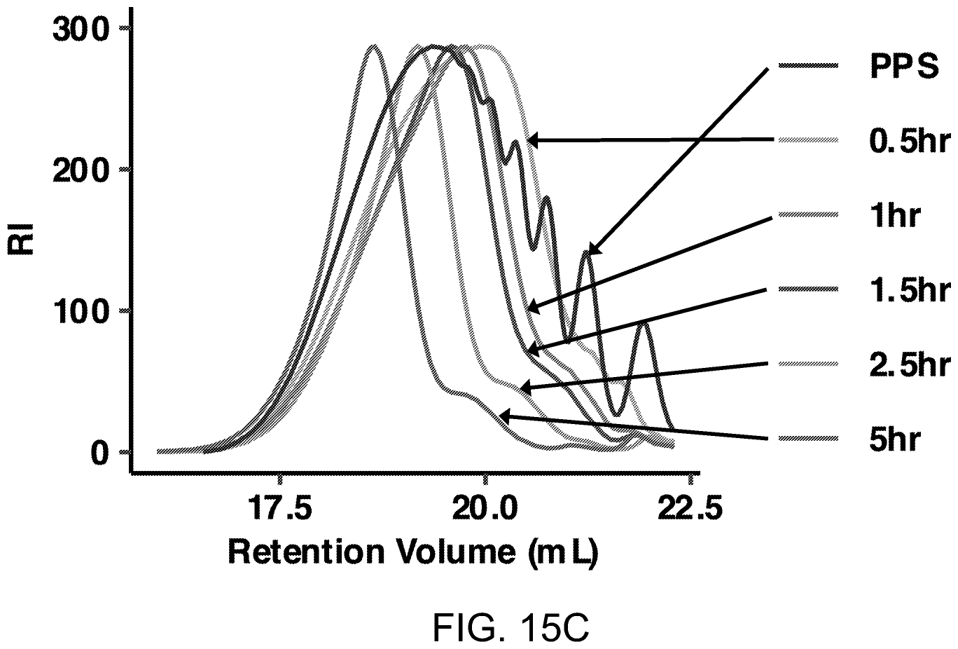

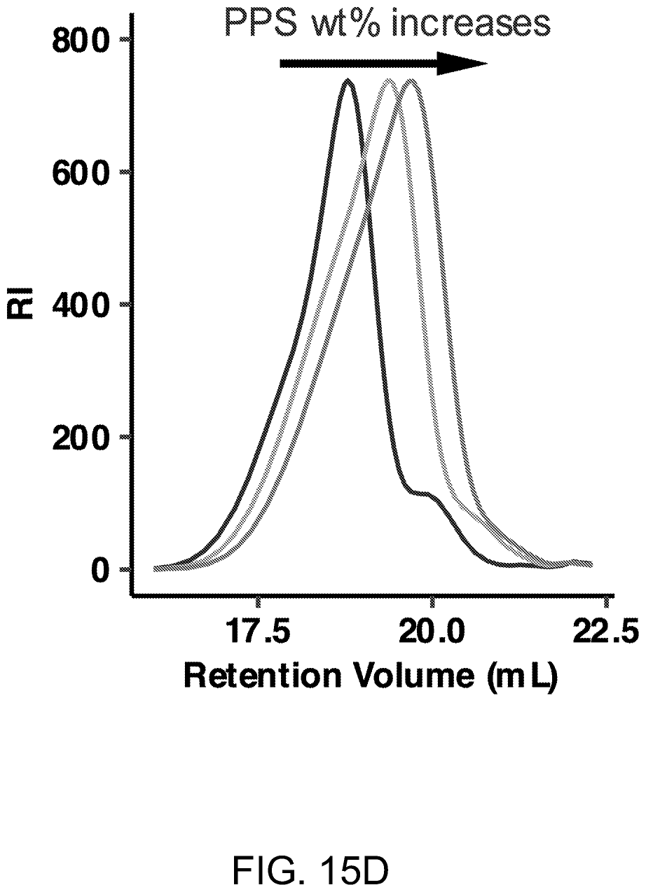

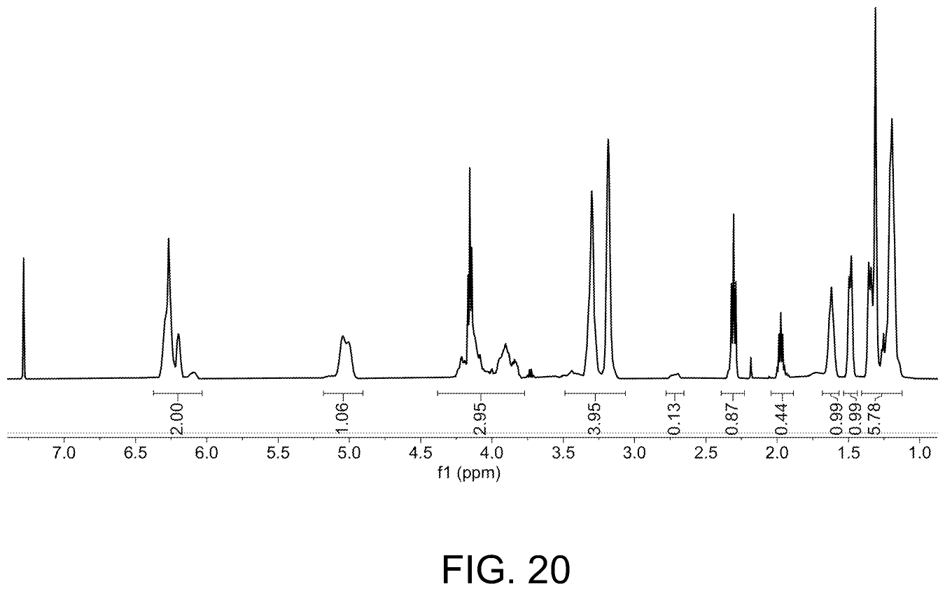

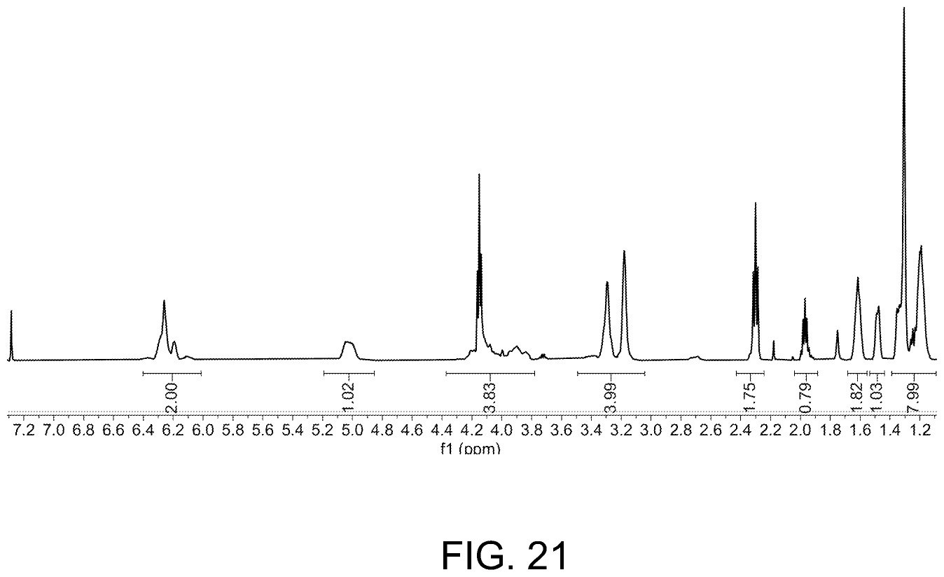

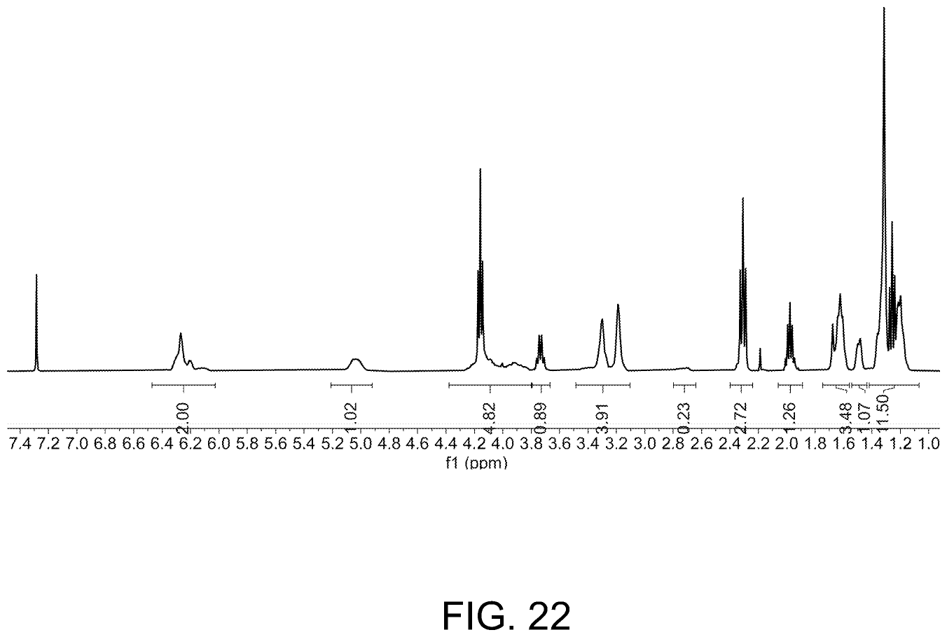

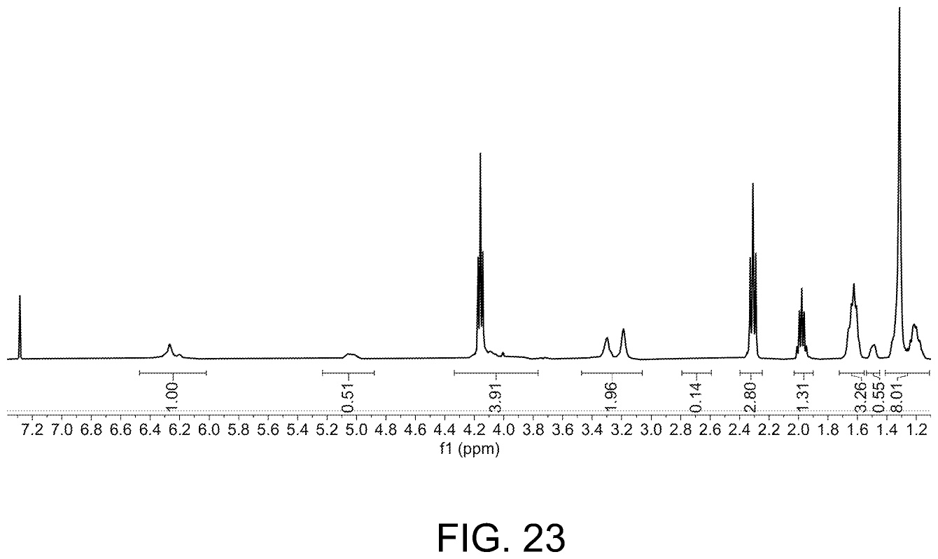

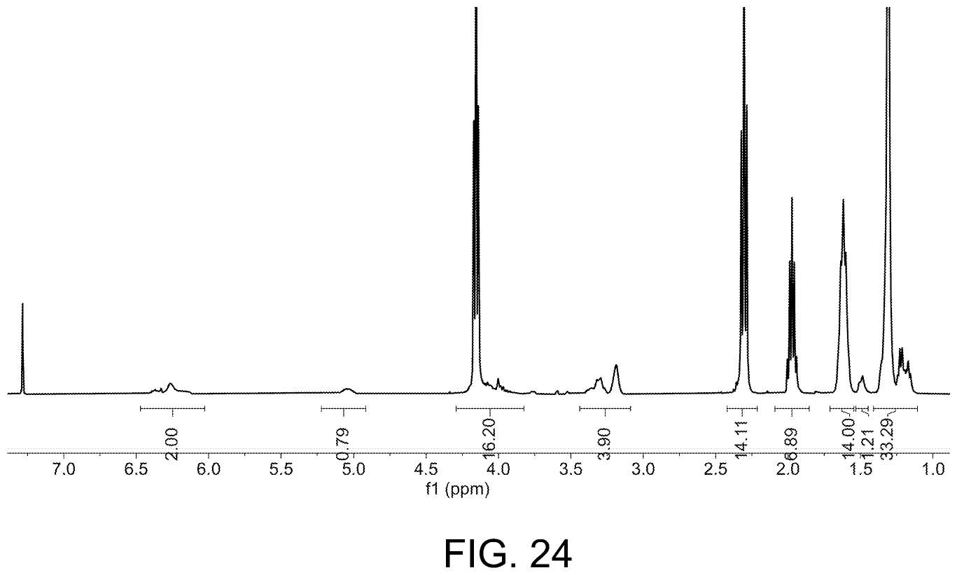

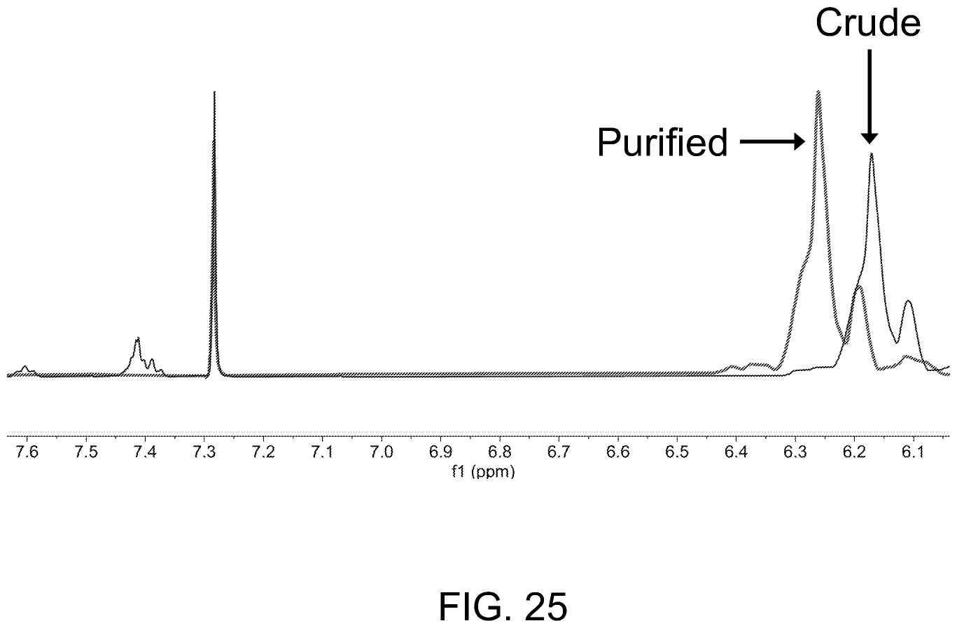

Results and discussion. PPS Synthesis and Characterization. PPS macroinitiator was synthesized by melt condensation of 1.05 eq of sebacic acid and 1 eq of 1,3-propanediol (FIG. 14). GPC analysis showed that PPS was partially composed of a series of low molecular weights oligomers (FIGS. 15A-15C), typical of aliphatic polyesters generated by this method. Although 1.05 equivalents of sebacic acid were used, a minor amount of α-OH-ω-OH—PPS along with similarly high abundance of α-OH-ω-COOH—PPS and α-COOH-ω-COOH—PPS appeared on MALDI-TOF, testifying on melt condensation's lack of control (FIG. 20). Because previous research showed that COOH and OH initiated ROCOP in similar manners, PPS was represented as having COOH end groups for simplicity (FIG. 1).

Synthesis of poly(NB-alt-PO)-PPS-poly(NB-alt-PO). Catalyst Choice. In a first trial, a bifunctional aminocyclopropenium aluminum catalyst AlCl was used, while in the second trial the TEB-[PPN]Cl binary system was used. Unlike the TEB-[PPN]Cl binary system, where the Lewis acid and Lewis base are distinctive molecules, AlCI contains covalently tethered Lewis acid and Lewis base that maintain catalyst activity in diluted polymerization medium to prevent inhibition by protic CTAs. AlCl was initially deemed suitable as a catalyst because it was desired to incorporate high weight percentages of PPS in the block copolymer to increase its renewable content. While AlCl produced NBPO_{PPS10} (Mn=8.9 kDa, Ð=1.14) and NBPO_{PPS18} (Mn=5.4 kDa, Ð=1.22), the residual catalyst was impervious to purification by repeated precipitation or ion exchange columns and triggered thiol-ene crosslinking in ten minutes without UV exposure, rendering it unusable for DLP applications. Further, the brightly colored AlCI stained the polymers such that they would not have the desirable properties for biological imaging which requires transparent, colorless materials. To produce colorless materials that would not undergo uncontrolled crosslinking, the TEB-[PPN]Cl binary catalyst system was used.

Influence of PPS on ROCOP Kinetics. PPS acted as a chain transfer agent (CTA). Small scale screening revealed that high concentrations of PPS inhibited polymerization, as shown by NBPO_{PPS61} not reaching 100% conversion within 19 hours; this observation agreed with previous reports in which protic species greatly retarded the rate of ROCOP. Time-anhydride conversion plot of NBPO_{PPS50}, however, showed an induction period in the first 2.5 hours, after which the reaction accelerated and reached 94% anhydride conversion at 3.5 hr. An induction period was observed for other ROCOP as well. Meanwhile, Mₙ decreased slightly in the first 3.5 hour of polymerization and steadily increased linearly for NBPO_{PPS37}, although molecular weight distributions consistently decreased throughout the polymerization. This was attributed to differential polymerization rates among PPS species of different molecular weights: the initial faster polymerization rates of low-molecular weight PPS likely shifted the most abundant species to poly(NB-alt-PO)-PPS-poly(NB-alt-PO) with a lower Mₙ than the original broadly distributed PPS macroinitiators.

Weighing PPNCl crystals directly to the reaction mixture caused significant polyether formation and low anhydride conversion at high PPS concentrations (NBPO_{PPS50}), NBPO_{PPS61}). Previous works showed that TEB-PPNCl catalyst pair homopolymerized PO at certain TEB/PPNCl ratios-weighing out PPNCl was likely less accurate than measuring out stock solutions and this inaccuracy resulted in homopolymerization of PO. However, TEB-[PPN]Cl binary catalyst produced a NBPO_{PPS18} with a molecular weight and dispersity superior to that produced by the AlCl bifunctional catalyst.

TABLE 4

| | PPS | | Mn | | Ether | T_{g} | Tₘ/T_{c} |
|---|---|---|---|---|---|---|---|
| Entry | wt. %^{a} | [NB]:[PO]:[PPS]:[TEB]:[PPNCl] | (kDa) | Ð | wt. % | ° C. | ° C. |
| NBPO_{PPS18} | 18% | 100:600:1.6:1:1 | 7.2 | 1.24 | 0% | 21.2 | NA |
| NBPO_{PPS30} | 30% | 100:600:3.2:1:1 | 5.4 | 1.30 | 0% | −13.5 | NA |
| NBPO_{PPS37} | 37% | 100:600:4.5:1:1 | 5.0 | 1.40 | 0% | −35.2 | 38.6/NA |
| NBPO_{PPS50} | 50% | 100:600:7.6:1:1 | 4.0 | 1.44 | 0% | −42.8 | 43.7/−1.93 |
| NBPO_{PPS61}^{b} | 61% | 100:600:12:1:1 | 3.2 | 1.54 | 0% | −22.8 | 48.6/17.4 |

^{a}PPS wt. % relative to ring opened NB and PO.
^{b}NBPO_{PPS61} reached 88% conversion-all other entries reached full conversion.

PPS Mediated ROCOP is an immortal polymerization. Results revealed a dependence of Mₙ and dispersity on equivalents of PPS consistent with the immortal nature of the polymerization. Mₙ negatively correlated to equivalents of PPS (Table 1), confirming PPS underwent efficient chain transfer to afford poly(NB-alt-PO)-PPS-poly(NB-alt-PO). NMR and GPC analysis of aliquots taken throughout the synthesis of NBPO_{PPS18} show that anhydride conversion increased linearly with Mₙ and time (FIGS. 15A-15B), validating linear and uniform chain extension from PPS and consistent with previous reports of TEB-[PPN]Cl catalyzed ROCOP with or without small-molecule CTAs. The conversion-Mₙ best-fit curve intercepted the y axis at 2323 g/mol, approximating the Mₙ of PPS and suggesting the absence of epoxide homopolymerization (FIG. 15A). Similar to other reported protic CTAs used in ROCOP catalyzed by binary catalyst systems, high PPS loadings decreased polymerization rates: NBPO_{PPS18} reached complete conversion in 5 hours while NBPO_{PPS50} only took 3.5 hours, and NBPO_{PPS61} did not reach full conversion after 19 hours of polymerization. It is proposed that high PPS loadings inhibited catalyst activity due to increased reaction viscosity, dilution of the active catalytic species, and/or competition with binding of the growing anionic chain to the active catalytic species. The high dispersity of PPS (Ð=1.82), however, made it difficult to calculate its exact molar concentration to study the exact inhibition mechanism via Lineweaver Burk plots as previous reported.

Dispersities of poly(NB-alt-PO)-PPS-poly(NB-alt-PO). Dispersities of the produced copolyesters were lower than that of PPS and decreased as equivalents of PPS increased (Table 1, FIG. 15D). To understand this trend, the progression of dispersities was tracked during polymerization of NBPO_{PPS18} and it was observed that polymer dispersity decreased and molecular weight increased as the polymerization proceeded (FIGS. 15B-15C). In ROCOP conducted with small molecules CTAs, dispersity is generally invariant with degree of polymerization and a low dispersity is maintained due to rapid equilibration between anionic chain ends and protic species. Further, the few examples of ROCOP conducted with macroCTA's utilize commercially available polymers with narrow dispersity. It was thus surmised that this downward trend of dispersities stemmed from a diffusion-controlled chain transfer mechanism. It is proposed that PPS with lower-molecular weight chain extend more rapidly, reaching molecular weights approximating those of higher-molecular weight PPS that have not yet chain extended or have only chain extended to a minor degree. This mechanism preferentially decreases the abundance of low molecular weight species and therefore lowers polymer dispersity as well. Indeed, progression of molecular weight with time for NBPO_{PPS18} (FIG. 15B) shows that low molecular weight PPS oligomers are consumed in 30 minutes, whereas high molecular weight chains remained relatively invariant.

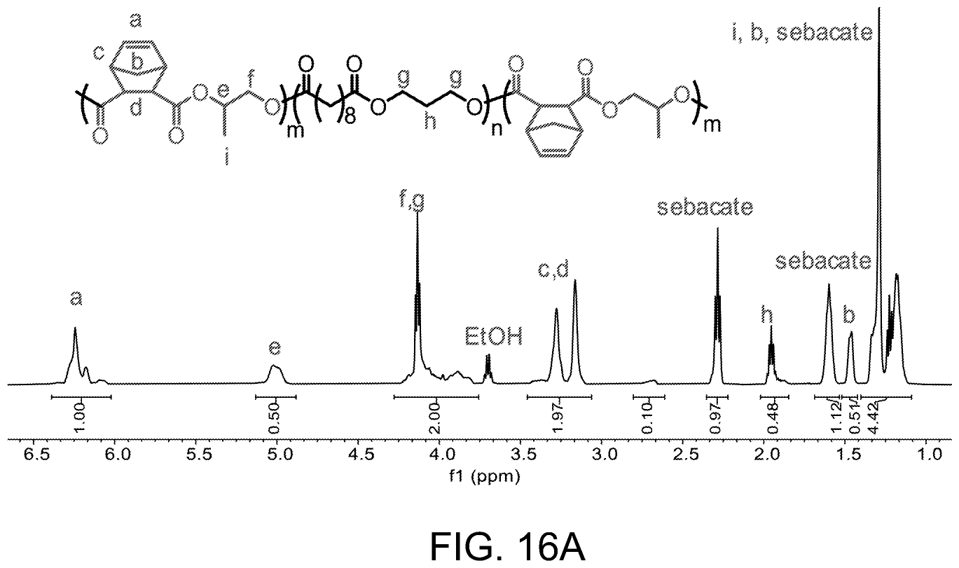

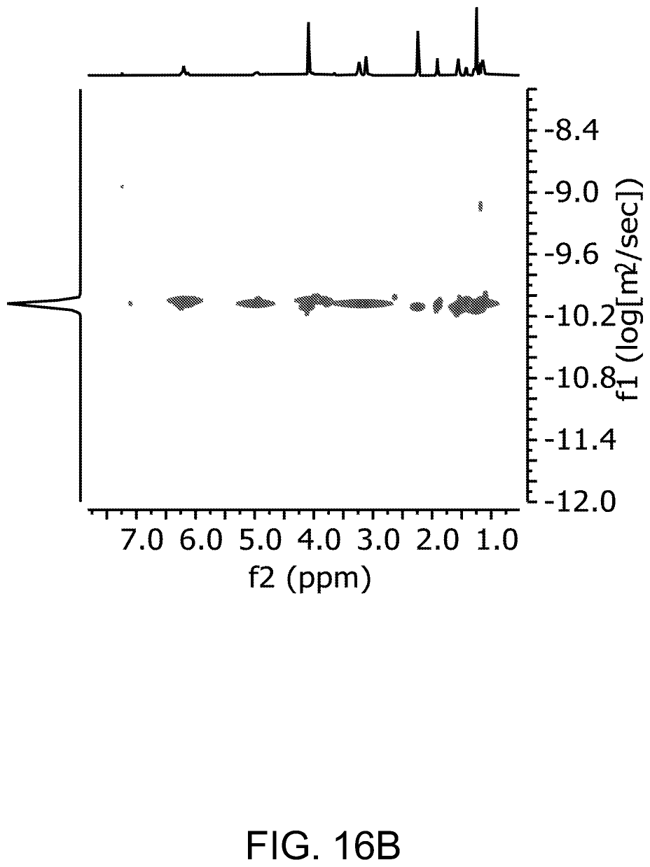

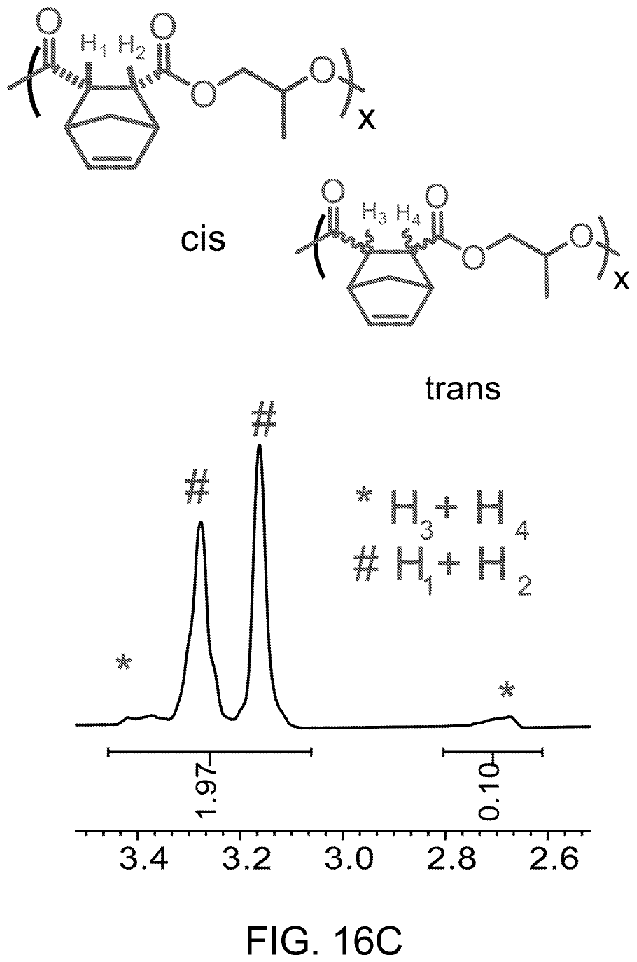

NMR and MALDI-TOF Characterization of NBPO_{PPS50}. Diffusion NMR showed one diffusion coefficient for all proton signals, further confirming that PPS chained extended to produce poly(NB-alt-PO)-PPS-poly(NB-alt-PO) (FIG. 16B). The polymerization favored polyester formation in the presence of excess PO. Absence of proton signals in 3.5-3.7 ppm and integration of methylene protons at 4.0 ppm suggested absence of polyether formation in all entries when [PPN] CI was added as a stock solution (Table 4, FIG. 16A, 20-24). Notably, NBPO_{PPS18} underwent prolonged incubation in excess PO for 14 hours after reaching full conversion with insignificant changes in molecular weight and dispersity. However, weighing [PPN]Cl crystals directly to the reaction mixture caused noticeable polyether formation and low anhydride conversion at high PPS concentrations (NBPO_{PPS50}, NBPO_{PPS61}), likely due to higher likelihood of inexact ratios of TEB relative to [PPN]Cl enabling TEB-mediated homopolymerization. Stereochemistry analysis with ¹H-NMR showed 10% of ring-opened NB adopted a trans conformation, and varying concentrations of PPS had no effect on the stereoselectivity (FIG. 16C).

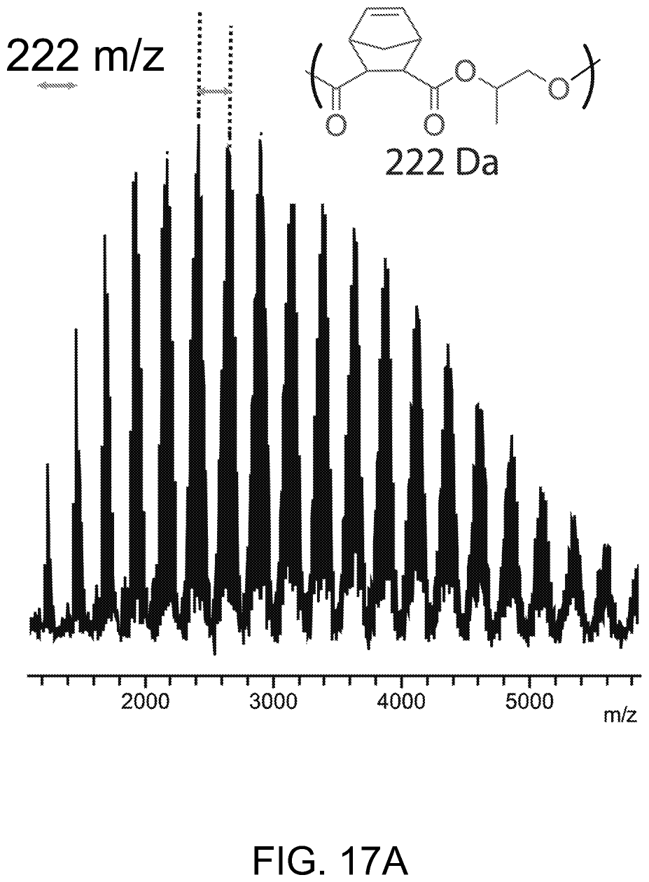

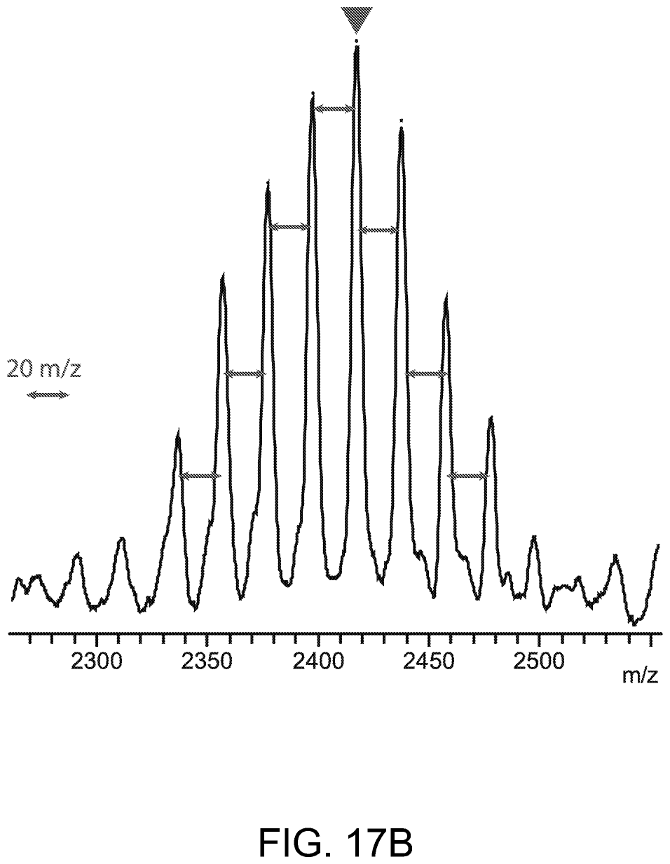

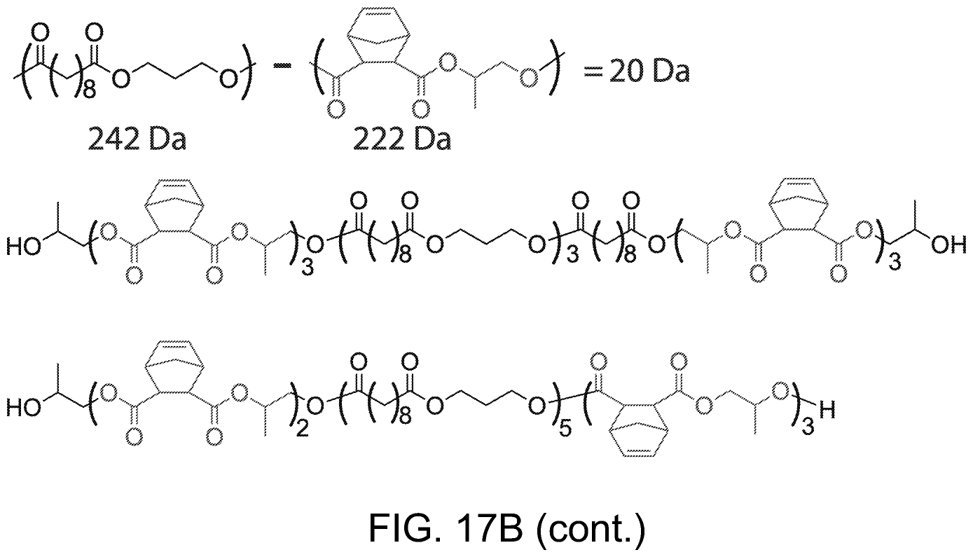

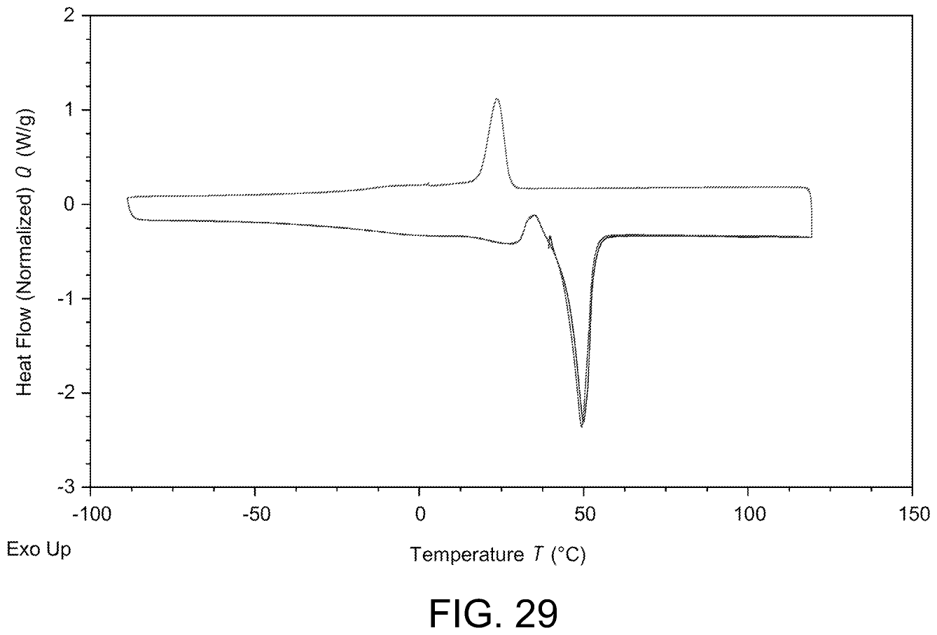

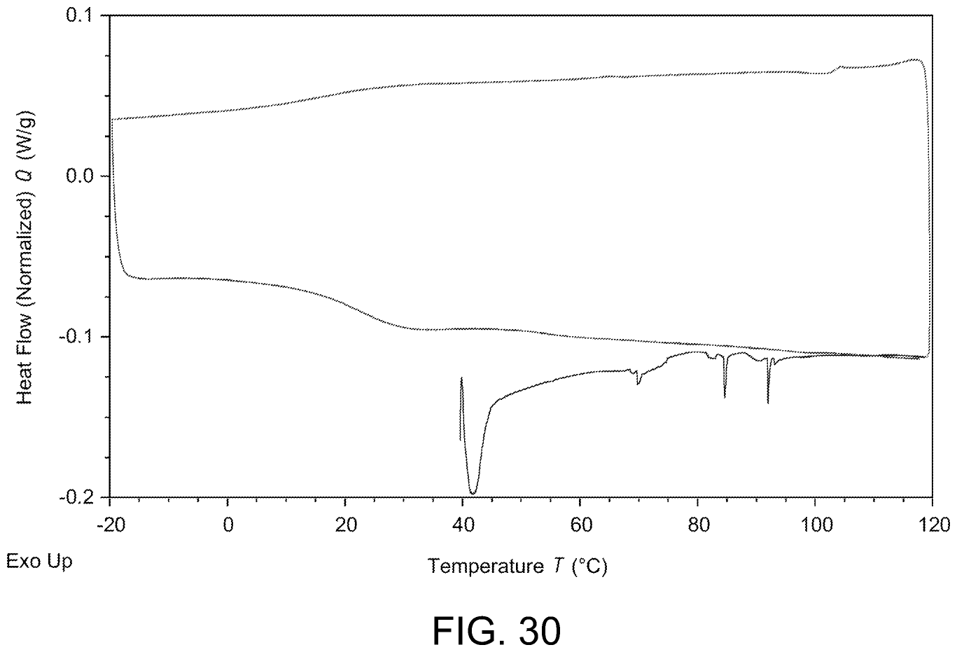

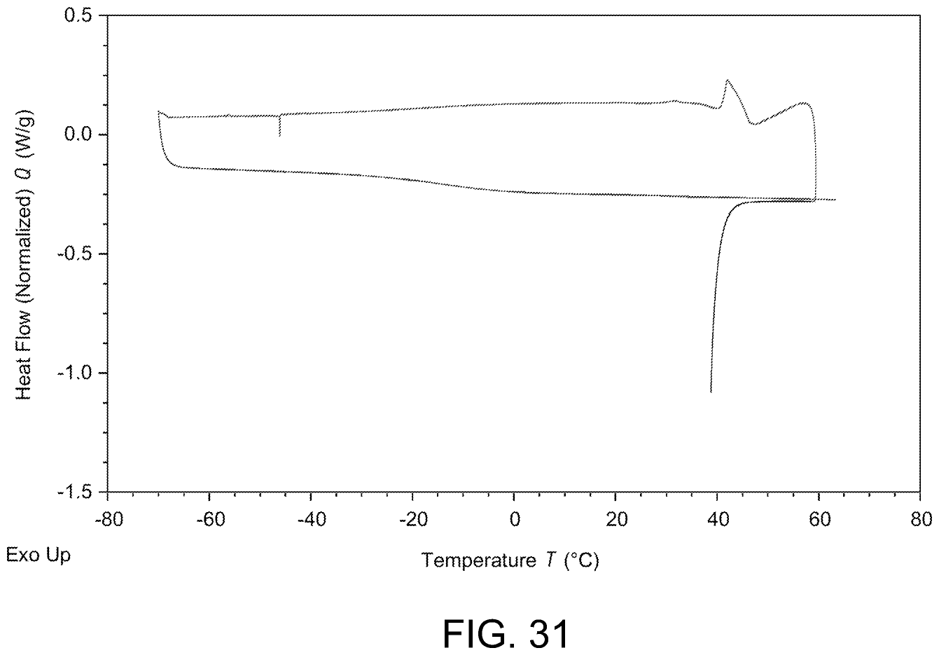

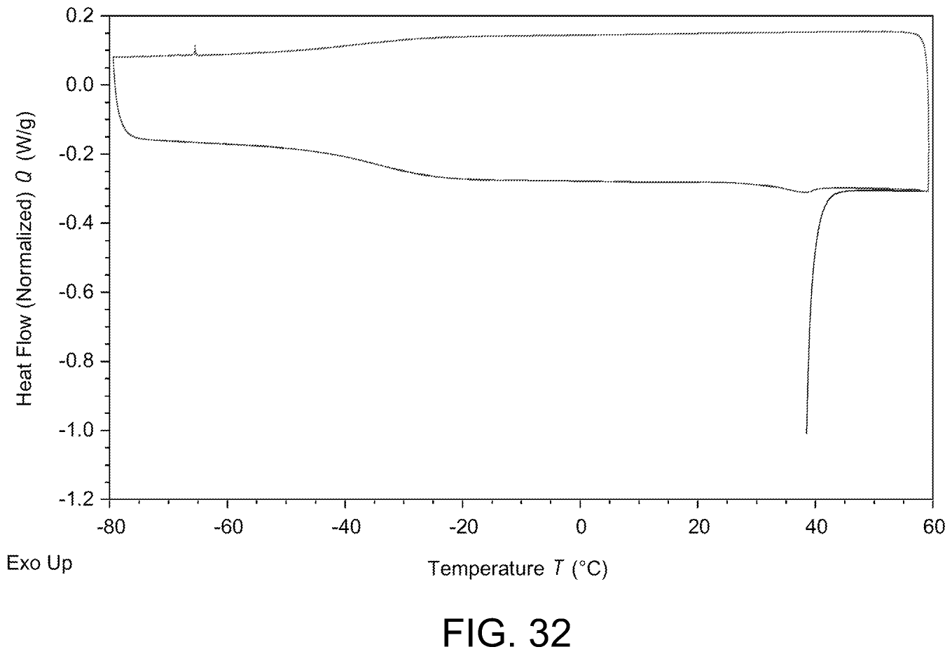

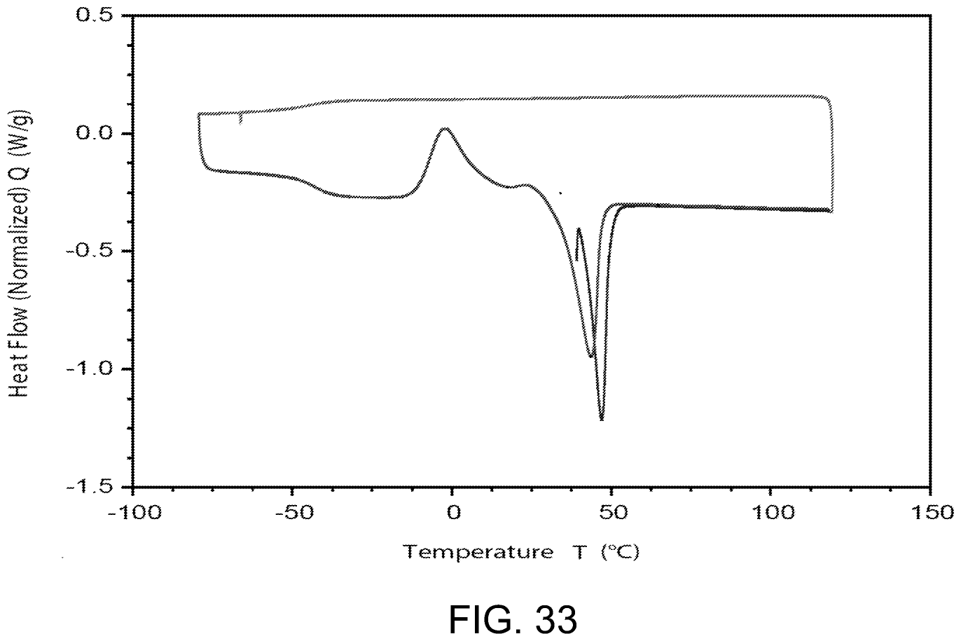

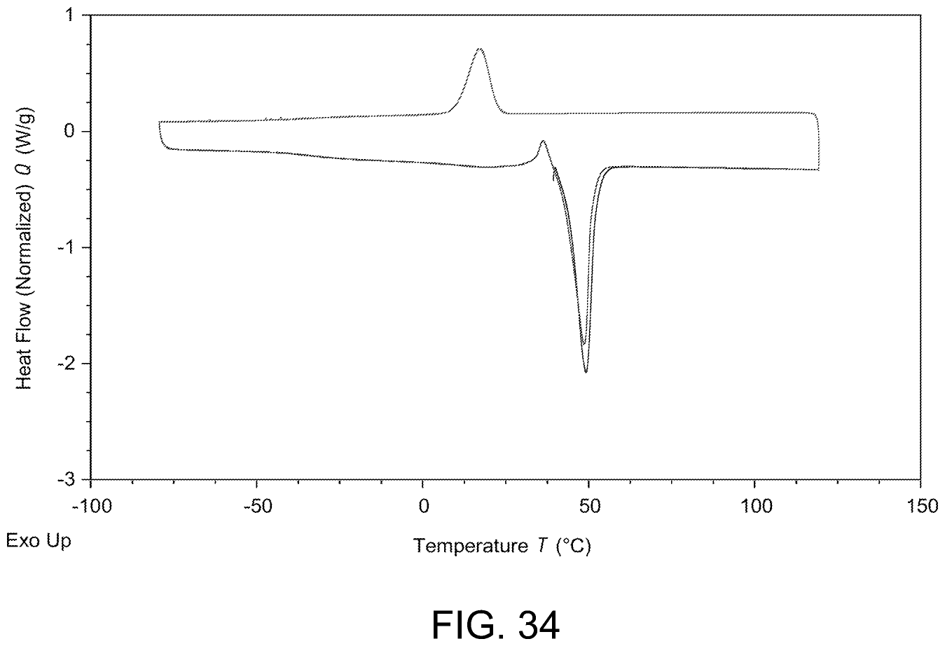

MALDI-TOF confirmed poly(NB-alt-PO)-PPS-poly(NB-alt-PO) samples were ABA-type block copolyesters with uniform propanol chain ends. Clusters of peaks equally separated by 222 m/z were observed, which matched the mass of one (NB—PO) repeating unit (FIGS. 17A, 27A-27B). Each cluster represented a degree of polymerization that contained a distribution of different amounts of NB—PO and sebacate-propanediol units. Distributions within each cluster resembled a Gaussian distribution, suggesting a statistical distribution of different amounts of sebacate-propanediol units and NB—PO units. Because PPS with three types of chain ends appeared on MALDI-TOF of PPS macroCTA (FIG. 26A-26B) and PO was in excess during polymerization, 2417 m/z was attributed to three possible species: [α-OH-ω-COOH—(PPS)₄]-block-(NBPO)₆, [α-OH-ω-OH—(PPS)₄]-block-poly(NB-co-PO)₆, and [α-COOH-ω-COOH-(PPS)₄]-block-poly(NB-co-PO)₆, but [α-OH-ω-OH-(PPS)₄]-block-poly(NB-co-PO), was least likely because α-OH-ω-OH-(PPS)₄ was a minor species (FIG. 17B, Table 2). The molecular weight difference between a PPS unit and a NBPO unit explained the observed 20 m/z increments within each cluster (FIG. 17B), which was further proved by our analysis of 2438 m/z peak (Table 3) that revealed poly(NB-co-PO) block with DP=5 and PPS block with DP=4 (for PPS with α-OH-ω-OH end groups) or 5 (for PPS with [α-COOH-ω-COOH and α-OH-ω-COOH end groups). Polyether segment and Cl— initiated chains were not observed. Overall, PPS was an efficient macroCTA in TEB-[PPN]Cl catalyzed ROCOP and generated well defined ABA block copolyester with tailorable molecular weights and low dispersities from broadly distributed macroCTA. It is envisioned that the reaction strategy developed herein can be applied to many other biomedically relevant polyesters synthesized from polycondensation, and the wide substrate scope of Lewis pair catalyzed ROCOP will impart them with diverse functionalities that are difficult to achieve via polycondensation. Thermal and Mechanical Properties of NBPO_{PPSx}. Thermal properties of PPS macroCTA and NBPO_{PPSx} were analyzed using DSC (FIGS. 29-34). Octamethylene segment in PPS soft block conferred more flexibility and lowered T_{g}s of poly(NB-alt-PO)-PPS-poly(NB-alt-PO); previously reported copolyester comprising of PO and tricyclic anhydride have high T_{g}s over 100° C. and no Tₘ, presumably because of rigidity of norbornene backbone and reactivity of double bonds at high temperatures. The demands for 3D-printed soft biomaterials, however, often require polymers with low T_{g}s lower than human's physiological temperature. T_{g}s of all poly(NB-alt-PO)-PPS-poly(NB-alt-PO) were lower than 37° C. in all cases and negatively correlated to equivalents of PPS (leftover monomers likely made NBPO_{PPS61} an outlier) (Table 4). At higher equivalents of PPS (NBPO_{PPS37}, NBPO_{PPS50}), and NBPO_{PPS61}), poly(NB-alt-PO)-PPS-poly(NB-alt-PO) adopted more PPS characters by displaying distinctive Tₘs and T_{g}s (PPS: Tₘ=52° C., T_{c}=28° C.): Tm increased from ˜40° C. (NBPO_{PPS37}) to ˜47° C. (NBPO_{PPS61}), and T_{c} increased from −1.93° C. (NBPO_{PPS50}) to 17.4° C. (NBPO_{PPS61}) (Table 4). With increasing equivalents of PPS, enthalpy of melting increased from 0.310 W/g (NBPO_{PPS37}) to 1.834 W/g (NBPO_{PPS61}).

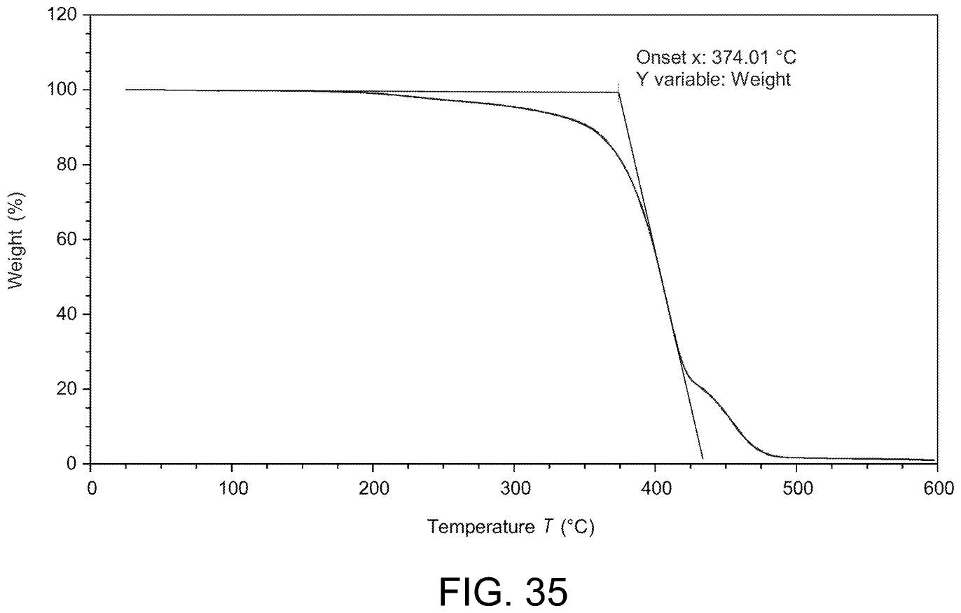

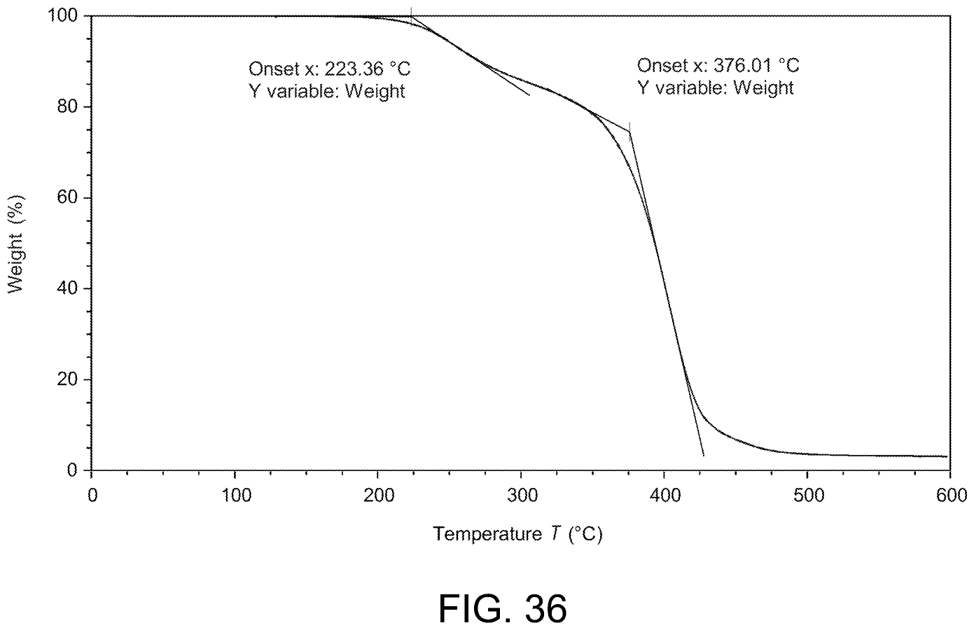

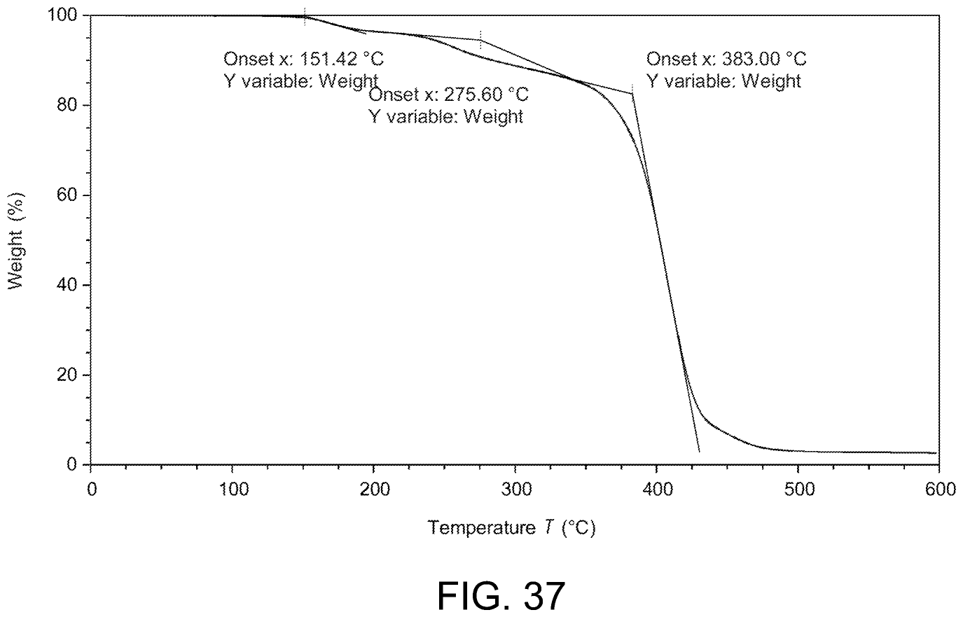

Thermal stability of PPSmacroCTA and NBPO_{PPSx} was analyzed using TGA (FIGS. 35-37). Due to the reactivity of norbornene, increasing length of poly(NB-alt-PO) block rendered poly(NB-alt-PO)-PPS-poly(NB-alt-PO) less stable at high temperatures. NBPO_{PPS50} showed two-step degradation with the first onset at 223° C. and the second onset at 376° C. (FIG. 36); PPS macroCTA had a single onset at 377° C. (FIG. S16), and the first onset of NBPO_{PPS50} was attributed to poly(NB-alt-PO) block. As for NBPO_{PPS61}, not only were similar stepwise degradations observed, but a minor transition at 151° C. was also identified, attributed this to leftover NB monomers in the mixture (FIG. 37). The weight percentage of each block also could not be identified from TGA data alone as the first degradation was not completed when the second degradation took place.

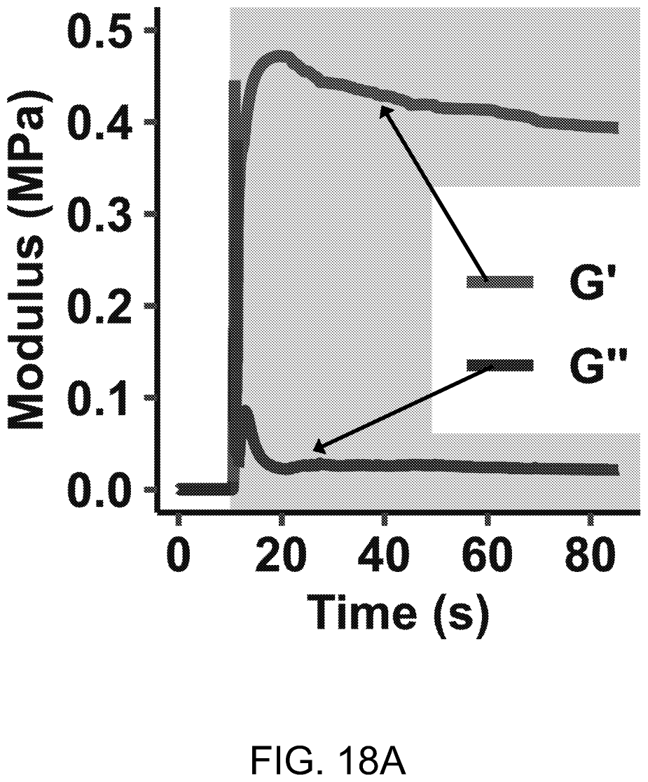

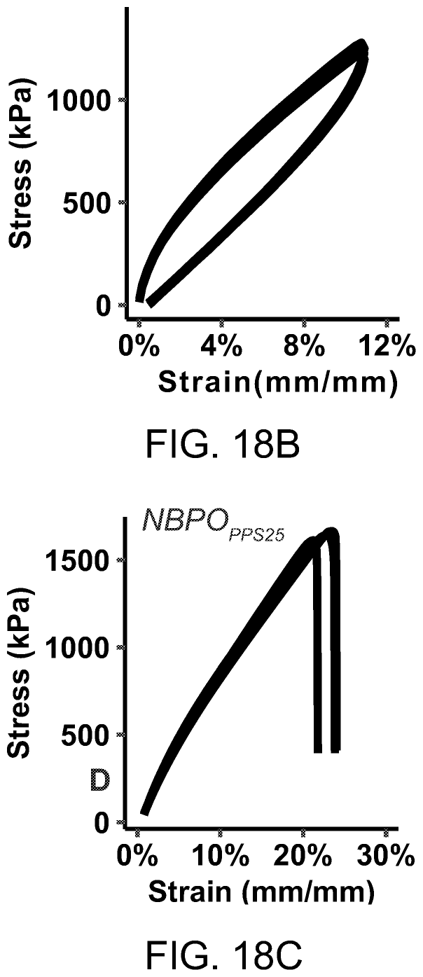

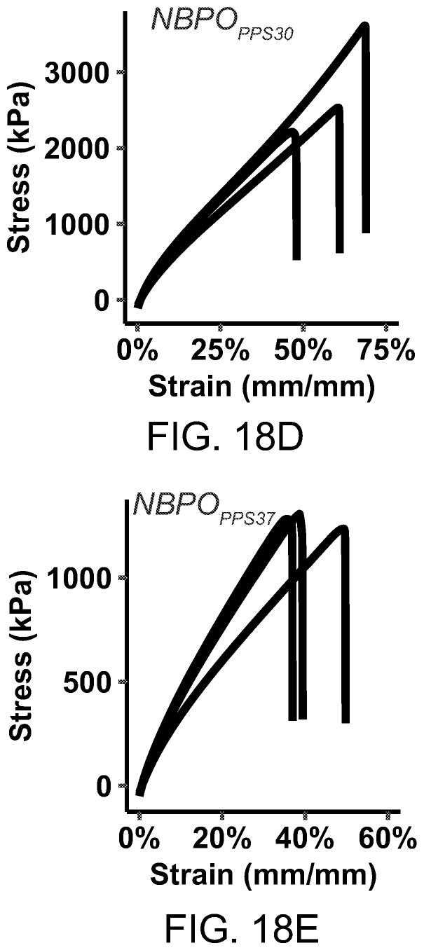

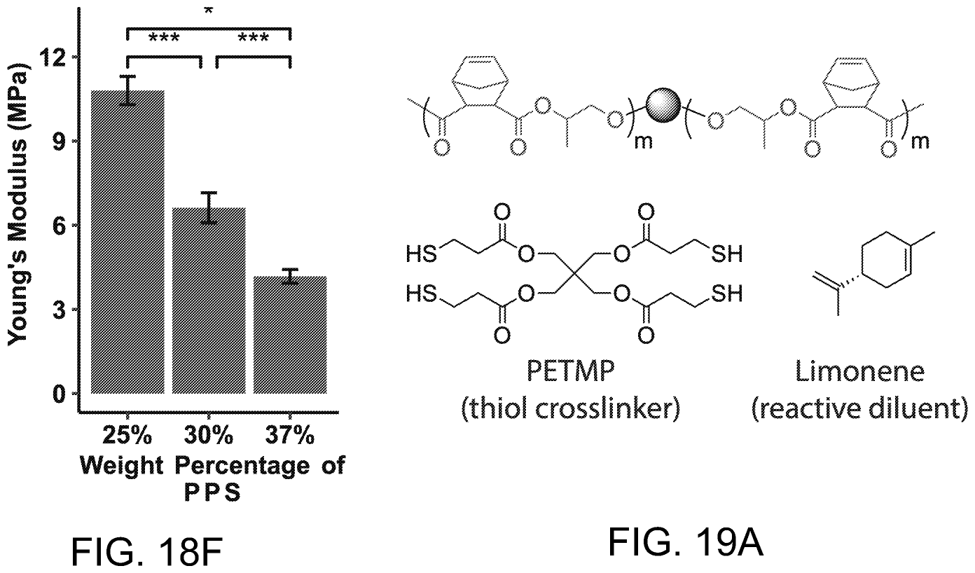

Mechanical Testing of Cured Polymer. Norbornene-functionalized polymers have been explored in additive manufacturing because of their facile thiol-ene crosslinking. Pentaerythritol tetrakis (3-mercaptopropionate) (PETMP) was chosen as the crosslinker due to its good biocompatibility in denture applications, low vapor pressure, and efficient generation of highly crosslinked thiol-ene networks. The storage modulus (G′) and loss modulus (G″) of a mixture of poly(NB-alt-PO)-PPS-poly(NB-alt-PO) and PETMP instantaneously increased upon exposure to UV (FIG. 18A), indicating that crosslinked rapidly occurred with diphenyl (2,4,6-trimethylbenzoyl) phosphine oxide (TPO) as the photoinitiator. In contrast, poly(NB-alt-PO)-PPS-poly(NB-alt-PO) synthesized from the bifunctional AlCl catalyst crosslinked with PETMP in a few minutes without exposure to UV. Metal contaminants are known to reduce the shelf life of thiol-ene photoresins, so the residual bifunctional AlCl catalyst likely has caused premature crosslinking. Filtering the polymer solution through a silica plug or ion exchange resin did not remove the reactive contaminants. In contrast, residual TEB was not removed from the current mixtures because the active catalytic species were converted to borate salts upon quenching by EtOH. TEB-PPNCl is therefore more suitable for generating photopolymers because it does not cause spontaneous crosslinking.

Poly (NB-alt-PO)-PPS-poly(NB-alt-PO) cured with PETMP were elastomeric and underwent cyclic loading and unloading (0-12% strain range) for fifty times without breakage (FIG. 18B); cycle 1, 25, and 50 furthermore exhibited nearly identical elastic behavior without noticeable residual strain (FIG. 18B). Increasing the amount of PPS in the final block copolyester decreased the crosslinking density and therefore the Young's modulus (FIG. 18F), and increased the ultimate strain (FIGS. 18C-18E) from ⊖ₘₐₓ=22±0.3% for NBPO_{PPS25} to ϵₘₐₓ=58±4% for NBPO_{PPS30}. In conclusion, this polymerization strategy enabled tuning mechanical properties by varying block lengths. This level of control is sometimes hard to achieve with polycondensation as step growth is less controllable than chain growth; meanwhile, Lewis pair catalyzed ROCOP alone can hardly access soft materials because they are most compatible with bicyclic/tricyclic aliphatic anhydrides which often results in very rigid chains. The toughness and elasticity of the crosslinked materials encouraged pursuit of resins made of poly(NB-alt-PO)-PPS-poly(NB-alt-PO) and PETMP as ideal candidates for 3D printing of soft materials.

DLP 3D-Printing of NBPO_{PPS31} and NBPO_{PPS37}. The printability of NBPO_{PPS31} and NBPO_{PPS37} was investigated because they reached full conversion consistently over 19 hours of polymerization and contained larger amount of PPS (renewable content) than NBPO_{PPS18}. Their relatively high molecular weights required proper diluents to decrease the resin's viscosity to a printable value (purified NBPO_{PPS31} and NBPO_{PPS37} were solids at room temperature and did not display Tm during DSC scans so they could not be printed directly by DLP). In a first trial, purified NBPO_{PPS31} and PETMP were dissolved in propylene carbonate to lower their viscosity. Purified NBPO_{PPS31}, however, displayed inadequate solubility and resulted in an inhomogeneous mixture, therefore caused UV scattering during printing and resulting in extremely poor xy resolutions. Moreover, all attempts at removing propylene carbonate caused severe shrinkage stress and cracked the printed objects. Replacing propylene carbonate with volatile solvents like ethyl acetate and ethanol had similar results.

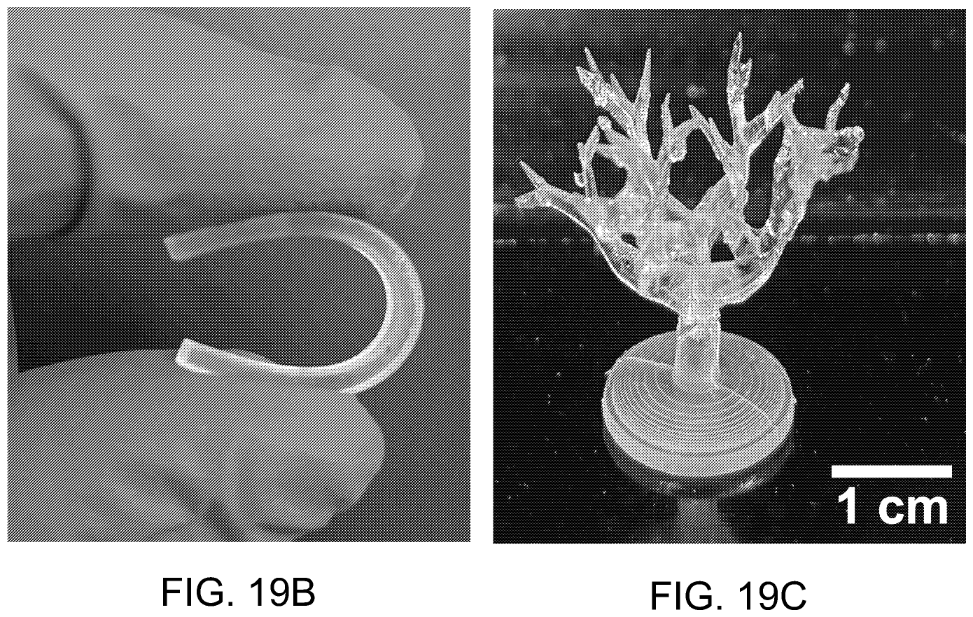

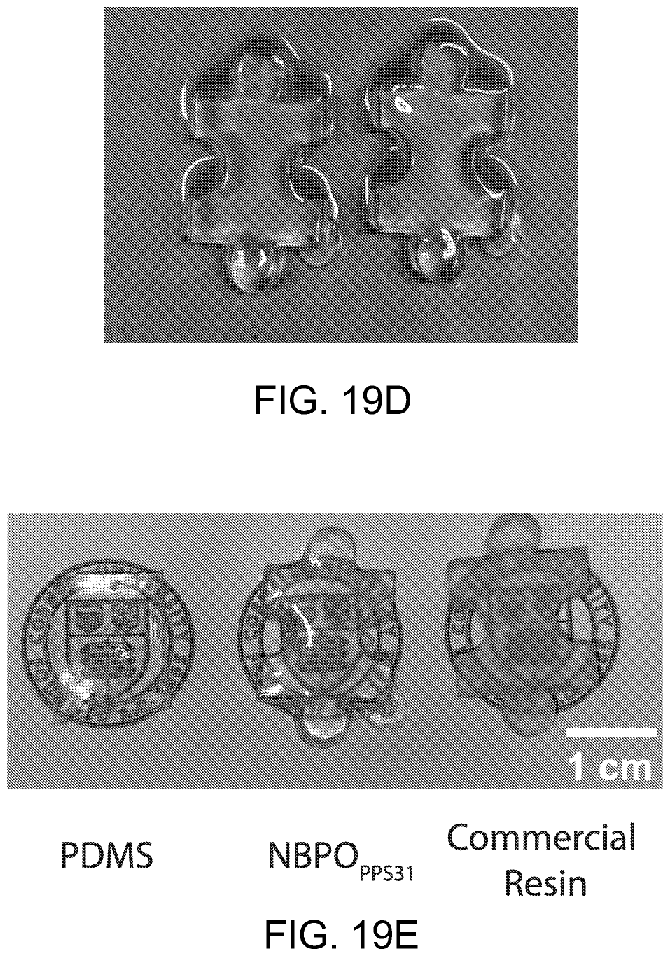

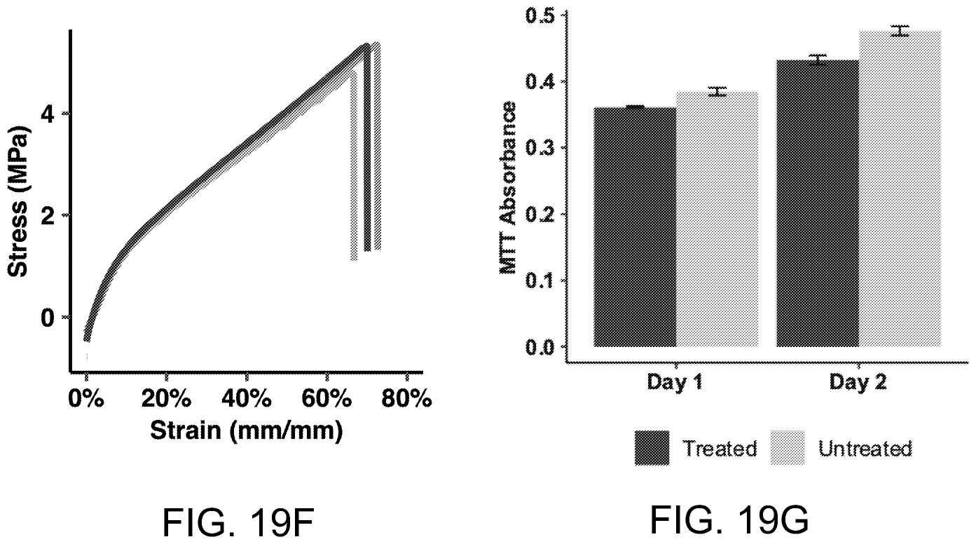

In a second trial, propylene carbonate was replaced with limonene, which is a reactive diluent because it furnishes two double bonds that can crosslink with PETMP (FIG. 19A). While reactive diluents such as diethyl fumarate and 1,3,5-triallyl-1,3,5-triazine-2,4,6 (1H,3H,5H)-trione are widely used in DLP, limonene is renewably resourced (naturally occurring in citrus fruits) and relatively safe for human consumption. Moreover, limonene's pleasant scent masked the foul-smelling PETMP effectively. Further, DLP resins derived from limonene and PETMP have been previously reported to display good printability and cytocompatibility. In the present study, limonene and PETMP (along with BHT as the stabilizer and TPO as the photoinitiator) were directly added to a crude reaction mixture of NBPO_{PPPS31}, then PO was removed in vacuuo to acquire a homogenous mixture with the appropriate viscosity.

The resultant resin was printable at 5-second exposure per 100 micron layer and stable over extended storage in dark in room temperature. A five second exposure per 100 micron layer consistently produced prints with high resolutions, whereas underexposure or overexposure caused prints to detach from the build platform or decreased xy resolutions. However, when NBPO_{PPS37} was printed with the same parameters, all prints cracked promptly upon contact with organic solvents washing. It was hypothesized that because NBPO_{PPS37} had lower mechanical strength and lower achievable crosslinking density than NBPO_{PPS31}, the resultant swelling and subsequent shrinkage stress during air drying caused crosslinked materials to crack and delaminate.

Objects of various structural complexity were printed according to our optimized parameters, demonstrating the versatility of this method (FIGS. 19B-19D). In particular, the tree structure (FIG. 19C) demonstrated that the cured resins had enough mechanical strength to form unsupported hierarchical structures with overhangs and smooth curvatures (e.g., to withstand the detachment force applied by the printing stage as it departed away from bottom of the vat). The printed material showed good transparency and clarity similar to cured polydimethylsiloxane (FIG. 19E), the staple polymer used to manufacture microfluidics and other biomedical implant. The resultant materials were much softer (E=17.9+0.4 MPa) than reported transparent resin used to print microfluidic devices and were able to recover from mechanical stress; tensile mechanical testing showed that DLP-printed dogbones reached its elastic limits at roughly 10% strain and displayed an ultimate strength of 5.21±0.4 MPa at 67±2% strain (FIG. 19F). Lastly, thiol-ene cured poly(NB-alt-PO)-PPS-poly(NB-alt-PO) showed good cytocompatibility in vitro-although HUVEC cells treated with polymer extracts showed slightly decreased MTT signal, average proliferation rates vastly exceeded the 70% standard for cytocompatibility set by ISO 10993-2012(E) (FIG. 19G). When limonene was replaced with diethyl fumarate, which is a reactive diluent, the resultant NBPO_{PPS31} resin was printable at 2-second exposure per 100 micron layer and printed dogbones had a lower Young's modulus (E=3.49±0.23 MPa) and a similar ultimate strain (ϵₘₐₓ=73±5%).

In conclusion, metal-free Lewis pair catalyzed ROCOP was combined with melt polycondensation to produce sebacate-derived copolyesters with defined architectures (e.g., ABA triblock copolyesters) and narrow molecular weights distributions (Ð=1.24 to 1.54) on a 30-gram scale, which is unprecedented in the field of Lewis pair catalyzed ROCOP. This work ushers in a new route of synthesizing biomedical polymers with precisely controlled architectures. Further, Lewis pair catalyzed ROCOP's compatibility with many commercially available cyclic anhydrides and epoxides impart new functionalities and properties to existing polyesters for biomedical applications without the need to synthesize new monomers or develop proper conditions for polycondensation.

Also shown is the applicability of Lewis pair catalyzed ROCOP-previously underappreciated outside the realm of kinetic studies in producing polyester-based photopolymers for 3D printing. Lewis pair catalysts are cheap, commercially available, and more compatible with downstream applications than organometallic catalysts. The straightforward synthesis allows for more polyesters with advanced structures produced at a large scale for rapid prototyping. The metal-free strategy enables the formulation of stable thiol-ene resin that can be 3D-printed into functional materials with complex structures like those of vascular trees and properties comparable to that of PDMS. It is envisioned that this resin can be used to prototype microfluidic devices-especially organs-on-a-chip device with complex vascular networks-via additive manufacturing technique such as DLP with much higher efficiency than etching of PDMS for microfluidics systems.

Although the present disclosure has been described with respect to one or more particular example(s), it will be understood that other examples of the present disclosure may be made without departing from the scope of the present disclosure.

1. An oligoester or polyester comprising:
dicarboxylic acid repeat units; and
diol repeat units, polyol repeat units, or any combination thereof,
wherein at least about 0.5 mol % to about 100 mol % of the dicarboxylic acid repeat units, the diol repeat units, if present, and/or the polyol repeat units, if present, independently comprise one or more clickable group(s), based on the total moles of the dicarboxylic acid repeat units, the diol repeat units, if present, and the polyol repeat units, if present.

2. The oligoester or polyester of claim 1, wherein the oligoester or polyester comprises the following structure: 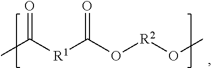
wherein R¹ and R² are each, independently at each occurrence, an aliphatic group, an aromatic group, a polyether group, or a polyol group, and wherein R¹ and R² each, independently at each occurrence, optionally comprises one or more clickable group(s).

3. The oligoester or polyester of claim 2, wherein about 0.5 mol % to about 100 mol % of the R¹ groups, the R² groups, or the R¹ groups and the R² groups, comprise the clickable group(s).

4. The oligoester or polyester of claim 1, wherein one or more or all of the clickable group(s) is/are independently covalently bound via a linking group to one of the dicarboxylic acid repeat units comprising the clickable group(s), one of the diol repeat units comprising the clickable group(s), or one of the polyol repeat units comprising the clickable group(s), and wherein the linking group(s) each, independently at each occurrence, comprise one or more functional group(s) chosen from alkyl group(s), amide group(s), ester group(s), ether group(s), ketone group(s), and any combination thereof.

5. The oligoester or polyester of claim 1, comprising a molecular weight (M_{w} and/or Mₙ) of about 400 g/mol to about 50,000 g/mol; and/or comprising a polydispersity index of from about 1.05 to about 7.0.

6. The oligoester or polyester of claim 1, exhibiting a glass transition temperature (T_{g}) of from about −30° C. to about 60° C.

7. A method of making an oligoester or a polyester, the method comprising:
forming a first reaction mixture comprising:
one or more dicarboxylic acid(s) each comprising one or more clickable groups(s); one or more diol(s) each comprising one or more clickable group(s); one or more polyol(s) each comprising one or more clickable group(s); one or more dicarboxylic acid(s); one or more diol(s), one or more polyol(s), or any combination thereof (collectively referred to as “first mixture reagents”),
wherein an oligoester or polyester, optionally, comprising a plurality of repeat units each comprising one or more of the clickable group(s), is formed; and/or
forming a second reaction mixture comprising:
one or more cyclic anhydride(s) each, optionally, comprising one or more clickable group(s); one or more cyclic ether(s) each, optionally, comprising one or more clickable group(s); and one or more oligoester(s) and/or polyester(s) each comprising one or more protic end group(s) and, optionally, a plurality of repeat units each comprising one or more clickable group(s), optionally, wherein the oligoester(s) and/or polyester(s) is/are the formed oligoester(s) and/or polyester(s) of one or more of the first reaction mixture(s); optionally, one or more cyclic anhydride(s); optionally, one or more cyclic ether(s), or any combination thereof; and
optionally, one or more ring opening copolymerization catalyst(s) (collectively referred to as “second mixture reagents”),
wherein an oligoester or a polyester comprising a plurality of repeat units each comprising one or more of the clickable group(s) is formed.

8. The method of claim 7, wherein the first mixture components do not comprise clickable group(s) and one or more or all of the second mixture components each comprise clickable groups.

9. The method of claim 7, wherein:
forming the first reaction mixture comprises:
adding a first portion of the first mixture reagents, wherein the first portion comprises at least some of or all of the first mixture reagents comprising the clickable group(s);
holding the first reaction mixture until a desired degree of conversion is achieved; and
optionally adding a second portion of the first mixture reagents, wherein the second portion comprises at least some of or all of the first mixture reagents not comprising clickable group(s); or
forming the first reaction mixture comprises:
adding a first portion of the first mixture reagents to the first reaction mixture, wherein the first portion comprises at least some of or all of the first mixture reagents not comprising the clickable group(s);
holding the first reaction mixture until a desired degree of conversion is achieved; and
optionally, adding a second portion of the first mixture reagents to the first reaction mixture, wherein the second portion comprises at least some of or all of the first mixture reagents comprising the clickable group(s).

10. The method of claim 7, wherein the formed oligoester or polyester of the first reaction mixture and/or the oligoester(s) or polyester(s) each comprising the protic end group(s) of the second reaction mixture each comprise(s) at least about 0.5 mol % to about 100 mol % of repeat units comprising one or more of the clickable group(s), based on the total moles of repeat units.

11. The method of claim 7, wherein the first mixture reagents comprise from about 0.5 mol % to about 100 mol % of the clickable group-functionalized dicarboxylic acid(s), diol(s), and/or polyol(s), based on the total molar amounts of the first mixture reagents; and/or
wherein the second mixture reagents, excluding the oligoester(s) and/or polyester(s) each comprising the protic end group(s) and the ring-opening copolymerization catalyst(s), comprise from about 0.5 mol % to about 100 mol % of the clickable group-functionalized cyclic anhydride(s) and/or cyclic ether(s), based on the total amounts of the second mixture reagents, excluding the oligoester(s) and/or polyester(s) and the ring-opening copolymerization catalyst(s).

12. The method of claim 7, wherein the second mixture reagents comprise:
from about 0.1 mol % to about 5 mol % of the ring opening copolymerization catalyst(s), based on the total molar amounts of the second mixture reagents; and/or
from about 40 wt. % to about 90 wt. % of the oligoester(s) or polyester(s), based on the total weight of the second mixture reagents.

13. The method of claim 7, wherein:
the dicarboxylic acid(s) is/are chosen from aliphatic dicarboxylic acid(s), aromatic dicarboxylic acid(s), polyether dicarboxylic acid(s), and any combination thereof;
the dicarboxylic acid(s) comprising one or more clickable group(s) is/are chosen from clickable group-functionalized aliphatic dicarboxylic acid(s), clickable group-functionalized aromatic dicarboxylic acid(s), clickable group-functionalized polyether dicarboxylic acid(s), and any combination thereof;
the diol(s) is/are chosen from aliphatic diol(s), aromatic diol(s), polyether diol(s), and any combination thereof;
the diol(s) comprising one or more clickable group(s) is/are chosen from clickable group-functionalized aliphatic diol(s), clickable group-functionalized aromatic diol(s), clickable group-functionalized polyether diol(s), and any combination thereof, the polyol(s) is/are chosen from aliphatic polyol(s), aromatic polyol(s), polyether polyol(s), and any combination thereof;
the polyol(s) comprising one or more clickable group(s) is/are chosen from clickable group-functionalized aliphatic polyol(s), clickable group-functionalized aromatic polyol(s), clickable group-functionalized polyether polyol(s), and any combination thereof;
the cyclic anhydride(s) is/are chosen from aliphatic cyclic anhydride(s), aromatic cyclic anhydride(s), polyether cyclic anhydride(s), and any combination thereof;
the cyclic anhydride(s) comprising one or more clickable group(s) is/are chosen from clickable group-functionalized aliphatic cyclic anhydride(s), clickable group-functionalized aromatic cyclic anhydride(s), clickable group-functionalized polyether cyclic anhydride(s), and any combination thereof;
the cyclic ether(s) is/are chosen from aliphatic cyclic ether(s), aromatic cyclic ether(s), polyether cyclic ether(s), and any combination thereof,
the cyclic ether(s) comprising one or more clickable group(s) is/are chosen from clickable group-functionalized aliphatic cyclic ether(s), clickable group-functionalized aromatic cyclic ether(s), clickable-group polyether cyclic ether(s), and any combination thereof;
the ring opening copolymerization catalyst(s) is/are chosen from Lewis acid-Lewis base catalyst pair(s), covalently-tethered Lewis acid-Lewis base catalyst(s), and any combination thereof; or
any combination thereof.

14. The method of claim 11, wherein:
the dicarboxylic acid(s) is/are chosen from succinic acid, diglycolic acid, glutaric acid, adipic acid, tartaric acid, sebacic acid, pimelic acid, suberic acid, azelaic acid, malic acid, ketoglutaric acid, phthalic acid, terephthalic acid, analog(s) and derivative(s) thereof, and any combination thereof,
the dicarboxylic acid(s) comprising one or more clickable group(s) is/are chosen from clickable-group functionalized analog(s) and derivative(s) of succinic acid, diglycolic acid, glutaric acid, pimelic acid, suberic acid, azelaic acid, adipic acid, tartaric acid, pimelic acid, suberic acid, azelaic acid, sebacic acid, malic acid, ketoglutaric acid, phthalic acid, terephthalic acid, and any combination thereof, norbornene-endo-2,3-dicarboxylic acid, cis-4-cyclohexene-1,2-dicarboxylic acid, itaconic acid, maleic acid, fumaric acid, clickable group-functionalized analog(s) and derivative(s) thereof, and any combination thereof;
the diol(s) is/are chosen from propanediol, propylene glycol, 1,4-butanediol, 1,6-hexanediol, 1,8-octanediol, 1,10-decanediol, catechol, hydroquinone, analog(s) and derivative(s) thereof, and any combination thereof;
the diol(s) comprising one or more clickable group(s) is/are chosen from clickable-group functionalized analog(s) and derivative(s) of propanediol, propylene glycol, 1,4-butanediol, 1,6-hexanediol, 1,8-octanediol, 1,10-decanediol, catechol, hydroquinone, analog(s) and derivative(s) thereof, and any combination thereof;
the polyol(s) is/are chosen from glycerol, serinol, polyether diol, pentaerythritol, oligovinyl alcohol, polyvinyl alcohol, xylitol, analog(s) and derivative(s) thereof, and any combination thereof;
the polyol(s) comprising one or more clickable group(s) is/are chosen from clickable-group functionalized analog(s) and derivative(s) of glycerol, serinol, polyether diol, analog(s) and derivative(s) thereof, and any combination thereof;
the cyclic anhydride(s) is/are chosen from succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, analog(s) and derivative(s) thereof, and any combination thereof;
the cyclic anhydride(s) comprising one or more clickable group(s) is/are chosen from clickable-group functionalized analog(s) and derivative(s) of succinic anhydride, diglycolic anhydride, glutaric anhydride, adipic anhydride, tartaric anhydride, azelaoyl anhydride, sebacic anhydride, malic anhydride, ketoglutaric anhydride, phthalic anhydride, and any combination thereof, cis-5-norbornene-endo-2,3-dicarboxylic anhydride, cis-4-cyclohexene-1,2-dicarboxylic anhydride, maleic anhydride, itaconic anhydride, fumaric anhydride, clickable group-functionalized analog(s) and derivative(s) thereof, and any combination thereof;
the cyclic ether(s) is/are chosen from propylene oxide, butylene oxide, epichlorohydrin, glycidyl ether, analog(s) and derivative(s) thereof, and any combination thereof;
the cyclic ether(s) comprising one or more clickable group(s) is/are chosen from clickable group-functionalized analog(s) and derivative(s) of propylene oxide, butylene oxide, epichlorohydrin, glycidyl ether, and any combination thereof, allyl glycidyl ether, clickable group-functionalized analog(s) and derivative(s) thereof, and any combination thereof;
the ring opening copolymerization catalyst(s) is/are boron-based Lewis acid-Lewis base catalyst pair(s); or
any combination thereof.

15. A composition comprising one or more oligoester(s) and/or one or more polyester(s) of claim 1 and one or more crosslinker(s), one or more multifunctional crosslinker(s), or any combination thereof.

16. The composition of claim 15, wherein the oligoester(s) and/or the polyester(s) is/are present in the composition at from about 40 wt. % to about 80 wt. %, based on the total weight of the oligoester(s), if present, the polyester(s), if present, the crosslinkers(s), if present, and the multifunctional crosslinkers(s), if present.

17. The composition of claim 15, wherein the crosslinker(s) is/are chosen from dithiols and/or multifunctional crosslinker(s) is/are chosen from multifunctional thiols.

18. The composition of claim 17, wherein in the composition further comprises one or more radical initiator(s).

19. The composition of claim 18, wherein the radical initiator(s) is/are present in the composition at from about 0.1 wt. % to about 2 wt. %, based on the total weight of the oligoester(s), if present, the polyester(s), if present, the crosslinker(s), if present, and the multifunctional crosslinker(s), if present.

20. The composition of claim 15, wherein in the composition further comprises one or more solvent(s) and/or one or more additive(s).

21. A material comprising one or more composition(s) of claim 14, wherein the composition(s) is/are crosslinked, wherein the crosslinked composition(s) comprise(s) one or more crosslinked oligoester(s) and/or polyester(s), and wherein the crosslinked oligoester(s) and/or polyester(s) comprise(s) a plurality of crosslinking groups.

22. The material of claim 21, wherein the crosslinking groups of the crosslinked composition(s) replace from about 10% to about 100% of the clickable groups of corresponding non-crosslinked composition(s).

23. The material of claim 21, wherein the material exhibits:
a Young's modulus of about 0.01 MPa to about 200 MPa.

24. The material of claim 20, wherein the material is biocompatible and/or biodegradable.

25. An article of manufacture comprising one or more material(s) of claim 20, wherein the material(s) is/are elastomer(s).

26. The article of manufacture of claim 25, wherein the article of manufacture is chosen from a device, a scaffold, a tissue graft, and a skin patch.

27. The article of manufacture of claim 26, wherein the device is chosen from a microfluidic device, a lab on a chip, and a drug delivery device.

28. A method of forming an object comprising heating and/or irradiating with electromagnetic radiation one or more composition(s) of claim 15, wherein a plurality of crosslinking groups are formed, and wherein each crosslinking group is formed by a reaction of two of the clickable groups with a crosslinker or a multifunctional crosslinker.

29. The method of claim 28, wherein the composition(s) comprise one or more solvent(s) each capable of crosslinking during the heating and/or the irradiating with electromagnetic radiation of the composition(s).

30. The method of claim 87, wherein from about 10% to about 100% of the clickable groups are reacted to form the plurality of crosslinking groups.

31. The method of claim 30, further comprising forming a film or fiber from the composition(s).

32. The method of claim 31, wherein the film or the fiber is formed prior to and/or during the irradiating with electromagnetic radiation of the composition(s).

33. The method of claim 30, wherein the method is an additive manufacturing method.

34. The method of claim 33, wherein the additive manufacturing method is a 3-D printing method, UV-assisted electrospinning, UV-assisted electrowriting, or any combination thereof.

35. The method of claim 34, wherein the 3-D printing method is digital light processing (DLP).
